(19) United States
(12) Patent Application Publication
(10) Pub. No.: US 2013/0110682 A1
(43) Pub. Date: May 2, 2013

(54) SYSTEM AND METHOD FOR PROVIDING CONTENT ASSOCIATED WITH A PRODUCT OR SERVICE

(71) Applicant: Apple Inc., Cupertino, CA (US)

(72) Inventors: Michael Rosenblatt, Campbell, CA (US); Gloria Lin, San Ramon, CA (US)

(73) Assignee: Apple Inc., Cupertino, CA (US)

(21) Appl. No.: 13/660,990

(22) Filed: Oct. 25, 2012

Related U.S. Application Data
(62) Division of application No. 12/319,271, filed on Jan. 5, 2009.

(51) Int. Cl. G06Q 30/06; H04B 5/00

(52) U.S. Cl. CPC G06Q 30/0641; H04B 5/0031
USPC 705/27.1

(57) ABSTRACT

Systems, methods, and devices for providing and managing benefits associated with a product or service are provided. For example, a device for managing benefits associated with a product or service may include a processor configured to run a product benefit management application, a memory device operably coupled to the processor, an electronic display operably coupled to the processor, and an input interface. The input interface may be a near field communication interface configured to receive data associated with at least one benefit associated with the product or service from a radio frequency identification tag associated with the product or service. The electronic product benefit management application may be configured to enable a user of the electronic device to use the at least one benefit.

### CROSS-REFERENCE TO RELATED APPLICATIONS

This application is a division of U.S. patent application Ser. No. 12/319,271, filed on Jan. 5, 2009, which is incorporated by reference in its entirety, for all purposes, herein.

### BACKGROUND

1. Technical Field

The present disclosure relates generally to benefits associated with products or services and, more particularly, to obtaining, storing, and accessing benefits associated with such products or services using an electronic device.

2. Description of the Related Art

This section is intended to introduce the reader to various aspects of art that may be related to various aspects of the present disclosure, which are described or claimed below. This discussion is believed to be helpful in providing the reader with background information to facilitate a better understanding of the various aspects of the present disclosure. Accordingly, it should be understood that these statements are to be read in this light, and not as admissions of prior art.

Products or services may include various associated benefits. By way of example, a given product or service may include a coupon for a future purchase of the same product or service. A person purchasing or contemplating a purchase of such a product or service may also have one or more electronic devices. However, benefits associated with the product or service may be lost or misplaced, may not easily be transferred between distant individuals, and/or may not offer additional functionality to a user of one or more electronic devices.

### SUMMARY

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may be set forth below.

By way of example, a device for managing benefits associated with a product or service may include a processor configured to run a product benefit management application, a memory device operably coupled to the processor, an electronic display operably coupled to the processor, and a near field communication input/output interface. The near field communication input/output interface may be configured to receive data associated with at least one benefit associated with the product or service from a radio frequency identification tag associated with the product or service. The electronic product benefit management application may be configured to enable a user of the electronic device to use the at least one benefit.

### BRIEF DESCRIPTION OF THE DRAWINGS

Advantages of the invention may become apparent upon reading the following detailed description and upon reference to the drawings in which:

FIG. 1 is a block diagram illustrating an electronic device 10 configured to process benefits associated with products or services;

FIG. 2 is a schematic of a handheld device representing an embodiment of the electronic device of FIG. 1;

FIG. 3 is a schematic of a computer representing an embodiment of the electronic device of FIG. 1;

FIG. 4 is a schematic of a standalone media player representing an embodiment of the electronic device of FIG. 1;

FIG. 5 is a schematic of a kiosk representing an embodiment of the electronic device of FIG. 1;

FIG. 6 is a schematic of an unmanned kiosk representing an embodiment of the electronic device of FIG. 1;

FIGS. 7A-B are schematics representing benefits that may be associated with products or services;

FIG. 8 is a schematic of a radio frequency identification (RFID) tag configured to enable the electronic device of FIG. 1 to obtain benefits associated with a product or service;

FIG. 9 is a schematic of a matrix barcode tag configured to enable the electronic device of FIG. 1 to obtain benefits associated with a product or service;

FIG. 10 is a schematic of a product manual that may include the RFID tag or FIG. 8 or the matrix barcode tag of FIG. 9;

FIG. 11 is a schematic of a product that may include the RFID tag or

FIG. 8 or the matrix barcode tag of FIG. 9;

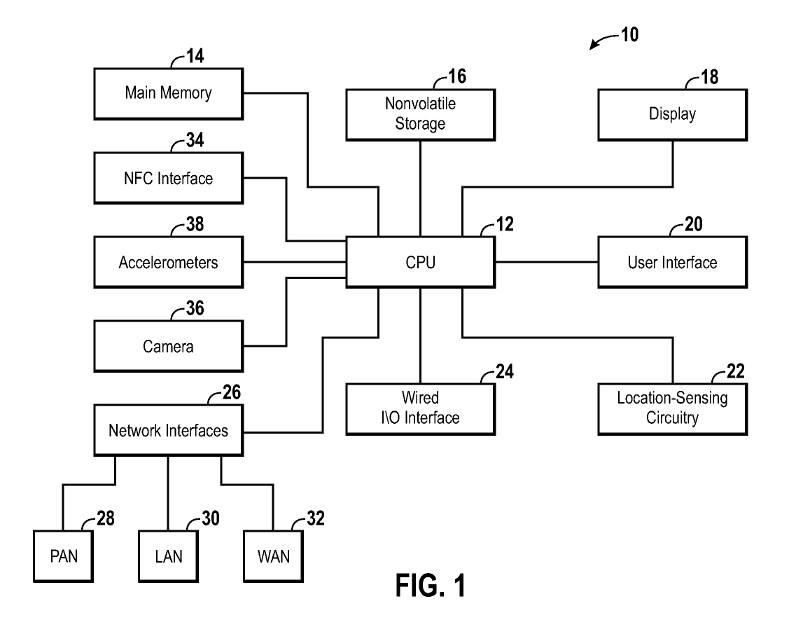

FIGS. 12A-F are schematics of screens that may be displayed on the electronic device of FIG. 1 for obtaining benefits associated with a product or service;

FIG. 13 is a schematic of a product-scanning operation for obtaining benefits associated with a product or service;

FIG. 14 is a block diagram representing communication that may take place during the product-scanning operation of FIG. 13;

FIGS. 15A-D are schematics of screens that may be displayed on the electronic device of FIG. 1 during an product benefit authentication procedure;

FIGS. 16A-C are schematics of screens that may be displayed for an alternative manner of obtaining benefits associated with a product or service;

FIG. 17 is a block diagram illustrating communication that may take place during product-scanning operations of FIGS. 15-16;

FIG. 18 is a schematic of a screen that may be displayed on the electronic device of FIG. 1 when a benefit associated with a product or service is obtained;

FIGS. 19A-B are schematics of screens that may be displayed on the electronic device of FIG. 1 when a benefit associated with a product or service is received in an e-mail message;

FIGS. 20A-D are schematics of screens that may be displayed on the electronic device of FIG. 1 during an e-mail-scanning operation to obtain benefits associated with a product or service received in an e-mail message;

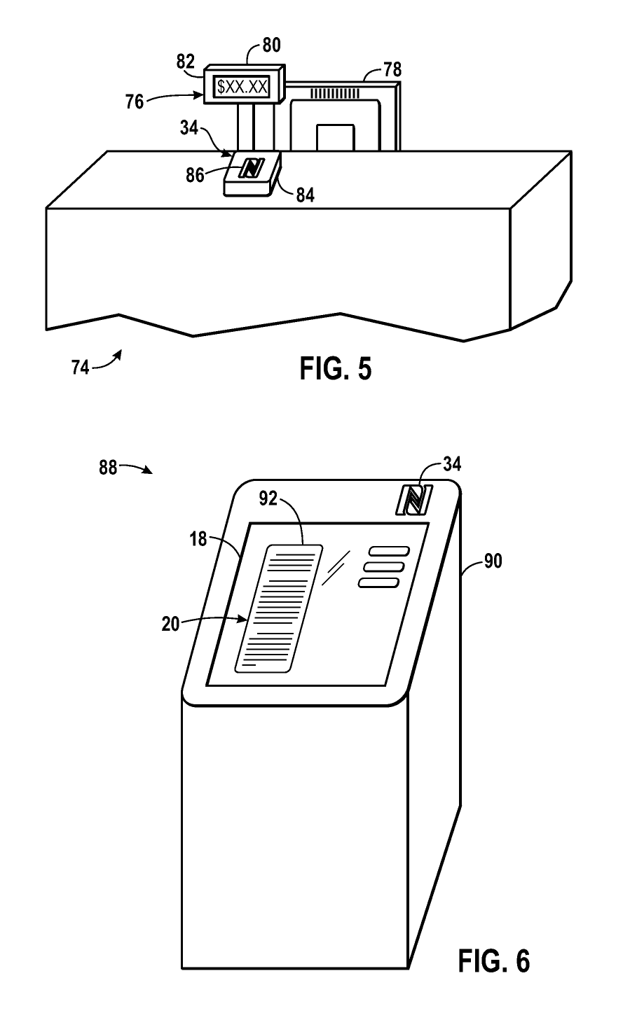

FIGS. 21A-C are schematics of screens that may be displayed on the electronic device of FIG. 1 for obtaining benefits associated with a product or service from the kiosks of FIGS. 5 and 6;

FIG. 22 is a schematic illustrating a kiosk-scanning operation for obtaining benefits associated with a product or service from one of the kiosks of FIGS. 5-6;

FIG. 23 is a block diagram representing communication that may take place during the kiosk-scanning operation of FIG. 22;

FIG. 24 is a block diagram representing communication channels that may be established between two of the electronic devices of FIG. 1;

FIGS. 25A-B are block diagrams representing communication that may take place during the kiosk-scanning operation of FIG. 22;

FIG. 26 is a schematic of a screen that may be displayed on the electronic device of FIG. 1 when an authenticated benefit is received;

FIG. 27 is a schematic of an alternative kiosk-scanning operation for obtaining benefits associated with a product or service from one of the kiosks of FIGS. 5-6;

FIG. 28 is a block diagram describing communication that may take place during the kiosk-scanning operation of FIG. 27;

FIGS. 29A-B are schematics of screens that may be displayed on the electronic device of FIG. 1 during the kiosk-scanning operation of FIG. 27;

FIG. 30A-C are schematics of screens that may be displayed on the electronic device of FIG. 1 for obtaining benefits associated with a product or service from one of the kiosks of FIGS. 5-6 by scanning an image with the camera;

FIG. 31 is a schematic of a screen that may be displayed on the kiosk of FIG. 6 for use in an alternative manner of obtaining benefits associated with a product or service;

FIG. 32 is a schematic of a screen that may be displayed on the electronic device of FIG. 1 when a benefit associated with a product or service is obtained in the manner of FIGS. 30-31;

FIGS. 33A-G are schematics of screens that may be displayed on the electronic device of FIG. 1 for obtaining benefits associated with a product or service wirelessly from one of the kiosks of FIGS. 5-6;

FIGS. 34A-B are schematics of screens that may be displayed on the electronic device of FIG. 1 for obtaining benefits from an online vendor;

FIGS. 35A-C are schematics of screens that may be displayed on the electronic device of FIG. 1 for receiving a benefit from another of the electronic devices of FIG. 1;

FIGS. 36A-B are schematics of screens that may be displayed on the electronic device of FIG. 1 for receiving a benefit from another of the electronic devices of FIG. 1;

FIGS. 37A-D are schematics of screens that may be displayed on the electronic device of FIG. 1 for receiving a benefit from another of the electronic devices of FIG. 1;

FIGS. 38A-J are schematics of screens that may be displayed on the electronic device of FIG. 1 for viewing and accessing benefits associated with a product or service on the electronic device of FIG. 1;

FIGS. 39A-B are schematics of screens that may be displayed on the electronic device of FIG. 1 representing benefits associated with a product or service;

FIGS. 40A-C are schematics of screens that may be displayed on the electronic device of FIG. 1 for transferring a benefit to another electronic device;

FIGS. 41A-B are schematics of screens that may be displayed on the electronic device of FIG. 1 for transferring a benefit associated with a product or service to another electronic device;

FIGS. 42A-D are schematics of screens that may be displayed on the electronic device of FIG. 1 for transferring a benefit associated with a product or service to another electronic device;

FIG. 43 is a schematic of a product-scanning operation for obtaining a benefit associated with a product or service;

FIG. 44 is a block diagram describing communication that may take place during the product-scanning operation of FIG. 43;

FIG. 45 is a schematic of an alternative product-scanning operation for obtaining a benefit associated with a product or service;

FIG. 46 is a flowchart describing a technique for obtaining a benefit associated with a product or service;

FIG. 47 is a benefit diagram illustrating benefits that may be associated with a generic product or product manual;

FIG. 48 is a schematic of a magazine configured to provide associated benefits;

FIG. 49 is an insert of the magazine of FIG. 48 configured to provide associated benefits;

FIG. 50 is a benefit diagram illustrating benefits that may be associated with a magazine, magazine insert, or mailer;

FIG. 51 is a schematic of a textbook configured to provide associated benefits;

FIG. 52 is a schematic of a page of the textbook of FIG. 51 configured to provide associated benefits;

FIG. 53 is a benefit diagram illustrating benefits that may be associated with a textbook;

FIG. 54 is a benefit diagram illustrating benefits that may be associated with a novel or non-fiction book;

FIG. 55 is a schematic of movie packaging configured to provide associated benefits;

FIG. 56 is a benefit diagram illustrating benefits that may be associated with music or movie packaging;

FIG. 57 is a benefit diagram illustrating benefits that may be associated with software or video game packaging;

FIG. 58 is a schematic of grocery product packaging configured to provide associated benefits;

FIG. 59 is a benefit diagram illustrating benefits that may be associated with grocery product packaging;

FIG. 60 is a schematic of a restaurant menu configured to provide associated benefits;

FIG. 61 is a benefit diagram illustrating benefits that may be associated with a restaurant menu or store exterior;

FIGS. 62A-F are schematics of screens that may be displayed when the benefits of FIG. 61 are obtained;

FIG. 63 is a schematic of food product packaging configured to provide associated benefits;

FIG. 64 is a benefit diagram illustrating benefits that may be associated with food product packaging;

FIGS. 65A-E are schematics of screens that may be displayed when the benefits of FIG. 64 are obtained;

FIG. 66 is a schematic of a product-scanning operation;

FIG. 67 is a block diagram describing communication that may take place during the product-scanning operation of FIG. 66; and

FIG. 68 is a schematic of a screen that may be displayed when the handheld device is within range of a product or service.

### DETAILED DESCRIPTION OF SPECIFIC EMBODIMENTS

Many people use a personal electronic device each day, as portable phones and digital media players become commonplace. When products or services are purchased or used, people may maintain a personal electronic device nearby. Using the techniques, systems, and devices described in the disclosure below, a user may obtain, store, or use benefits that may be associated with a product or service using a personal electronic device.

One or more specific embodiments of the present invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

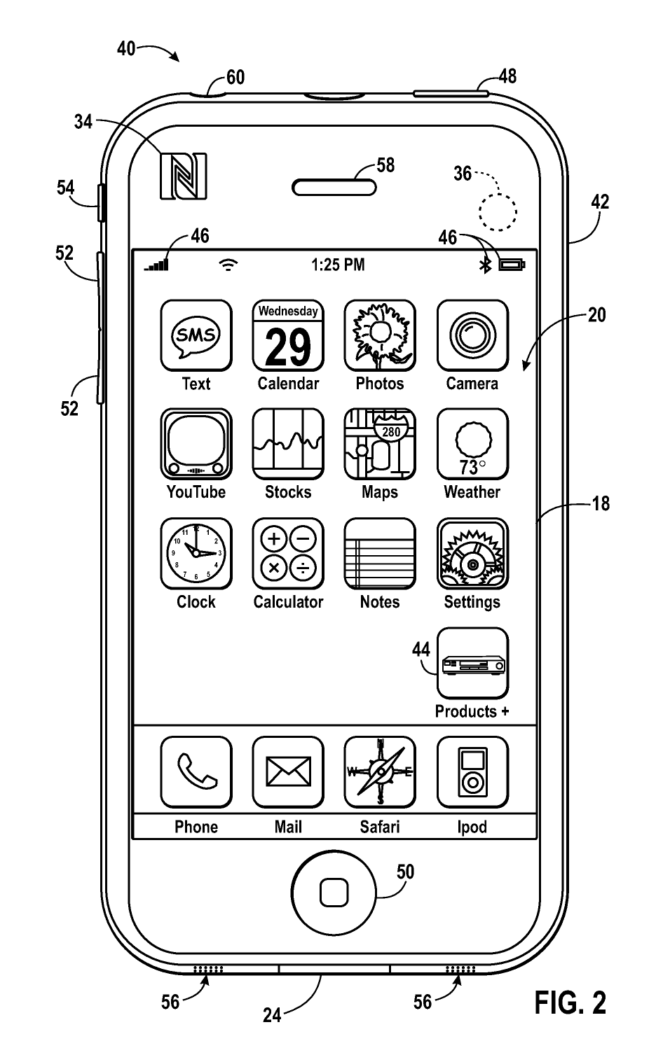

Turning first to FIG. 1, an electronic device 10 may be configured for obtaining, storing, or using benefits associated with a product or service. As discussed below with reference to FIGS. 2-7, the electronic device 10 may represent, among other things, a handheld device, a computer, or a media player adapted to obtain, store, or use benefits associated with a product or service using techniques described in greater detail below or a manned or unmanned kiosk to sell or distribute such benefits to another electronic device 10. As such, the electronic device 10 may represent, for example, an iPhone®, iPod®, iMac®, MacBook®, or AppleTV® available from Apple, Inc., or other devices by any manufacturer. It should be appreciated that embodiments of the electronic device 10 may include more or fewer elements than depicted in FIG. 1.

The electronic device 10 may include at least one central processing unit (CPU) 12. For example, the CPU 12 may represent one or more microprocessors, and the microprocessors may be “general purpose” microprocessors, a combination of general and special purpose microprocessors, or ASICS. Additionally or alternatively, the CPU 12 may include one or more reduced instruction set (RISC) processors, video processors, or related chip sets. The CPU 12 may provide processing capability to execute an operating system, run various applications, and/or provide processing for one or more of the techniques described herein. Applications that may run on the electronic device 10 may include, for example, software for managing and playing audiovisual content, software for managing a calendar, software for controlling telephone capabilities, and software for managing benefits associated with a product or service, as noted below.

A main memory 14 may be communicably coupled to the CPU 12, which may store data and executable code. The main memory 14 may represent volatile memory such as RAM, but may also include nonvolatile memory, such as read-only memory (ROM) or Flash memory. In buffering or caching data related to operations of the CPU 12, the main memory 14 may store data associated with applications running on the electronic device 10.

The electronic device 10 may also include nonvolatile storage 16. The nonvolatile storage 16 may represent any suitable nonvolatile storage medium, such as a hard disk drive or nonvolatile memory, such as Flash memory. Being well-suited to long-term storage, the nonvolatile storage 16 may store data files such as media (e.g., music and video files), software (e.g., for implementing functions on the electronic device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), as well as telephone information (e.g., telephone numbers). It should be appreciated that certain product data associated with a benefit may be saved in the nonvolatile storage 16, as discussed further below.

A display 18 may display images and data for the electronic device 10. It should be appreciated that only certain embodiments may include the display 18. The display 18 may be any suitable display, such as liquid crystal display (LCD), a light emitting diode (LED) based display, an organic light emitting diode (OLED) based display, a cathode ray tube (CRT) display, or an analog or digital television. In some embodiments, the display 18 may function as a touch screen through which a user may interact with the electronic device 10.

The electronic device 10 may further include a user interface 20. The user interface 20 may represent indicator lights and user input structures, but may also include a graphical user interface (GUI) on the display 18. In practice, the user interface 20 may operate via the CPU 12, using memory from the main memory 14 and long-term storage in the nonvolatile storage 16. In an embodiment lacking the display 18, indicator lights, sound devices, buttons, and other various input/output (I/O) devices may allow a user to interface with the electronic device 10. In an embodiment having a GUI, the user interface 20 may provide interaction with interface elements on the display 18 via certain user input structures, user input peripherals such as a keyboard or mouse, or a touch sensitive implementation of the display 18.

As should be appreciated, one or more applications may be open and accessible to a user via the user interface 20 and displayed on the display 18 of the electronic device 10. The applications may run on the CPU 12 in conjunction with the main memory 14, the nonvolatile storage 16, the display 18, and the user interface 20. As will be discussed in greater detail below, instructions stored in the main memory 14, the nonvolatile storage 16, or the CPU 12 of the electronic device 10 may obtain, store, and use electronic benefits associated with products or services. Rather than obtain and manage benefits associated with products or services manually, a user may employ the electronic device 10 to obtain and manage benefits electronically. As such, it should be appreciated that the instructions for carrying out such techniques may represent a standalone application, a function of the operating system of the electronic device 10, or a function of the hardware of the CPU 12, the main memory 14, the nonvolatile storage 16, or other hardware of the electronic device 10.

In certain embodiments, the electronic device 10 may include location sensing circuitry 22. The location sensing circuitry 22 may represent global positioning system (GPS) circuitry, but may also represent one or more algorithms and databases, stored in the nonvolatile storage 16 or main memory 14 and executed by the CPU 12, which may be used to infer location based on various observed factors. For example, the location sensing circuitry 22 may represent an algorithm and database used to approximate geographic location based on the detection of local 802.11x (Wi-Fi) networks or nearby cellular phone towers. As discussed below, the electronic device 10 may employ the location sensing circuitry 22 as a factor for carrying out certain benefit management techniques. By way of example, the location sensing circuitry 22 may be used by the electronic device 10 to determine a user's location when a benefit is accessed; the location may cause different information to be displayed on the electronic device 10.

With continued reference to FIG. 1, the electronic device 10 may also include a wired input/output (I/O) interface 24 for a wired interconnection between one electronic device 10 and another electronic device 10. The wired I/O interface 24 may represent, for example, a universal serial bus (USB) port or an IEEE 1394 or FireWire® port, but may also represent a proprietary connection. Additionally, the wired I/O interface 24 may permit a connection to user input peripheral devices, such as a keyboard or a mouse.

One or more network interfaces 26 may provide additional connectivity for the electronic device 10. The network interfaces 26 may represent, for example, one or more network interface cards (NIC) or a network controller. In certain embodiments, the network interface 26 may include a personal area network (PAN) interface 28. The PAN interface 28 may provide capabilities to network with, for example, a Bluetooth® network, an IEEE 802.15.4 (e.g., ZigBee) network, or an ultra wideband network (UWB). As should be appreciated, the networks accessed by the PAN interface 28 may, but do not necessarily, represent low power, low bandwidth, or close range wireless connections. The PAN interface 28 may permit one electronic device 10 to connect to another local electronic device 10 via an ad-hoc or peer-to-peer connection. However, the connection may be disrupted if the separation between the two electronic devices 10 exceeds the range of the PAN interface 28.

The network interface 26 may also include a local area network (LAN) interface 30. The LAN interface 30 may represent an interface to a wired Ethernet-based network, but may also represent an interface to a wireless LAN, such as an IEEE 802.11x wireless network. The range of the LAN interface 30 may generally exceed the range available via the PAN interface 28. Additionally, in many cases, a connection between two electronic devices 10 via the LAN interface 30 may involve communication through a network router or other intermediary device.

For some embodiments of the electronic device 10, the network interfaces 26 may include the capability to connect directly to a wide area network (WAN) via a WAN interface 32. The WAN interface 32 may permit a connection to a cellular data network, such as the Enhanced Data rates for GSM Evolution (EDGE) network or other 3G network. When connected via the WAN interface 32, the electronic device 10 may remain connected to the Internet and, in some embodiments, to another electronic device 10, despite changes in location that might otherwise disrupt connectivity via the PAN interface 28 or the LAN interface 30. As will be discussed below, the wired I/O interface 24 and the network interfaces 26 may represent high-bandwidth communication channels for transferring user data using the simplified data transfer techniques discussed herein.

Certain embodiments of the electronic device 10 may also include a near field communication (NFC) interface 34. The NFC interface 34 may allow for extremely close range communication at relatively low data rates (e.g., 464 kb/s), and may comply with such standards as ISO 18092 or ISO 21521, or it may allow for close range communication at relatively high data rates (560 Mbps), and may comply with the TransferJet® protocol. The NFC interface 34 may have a range of approximately 2 to 4 cm. The close range communication with the NFC interface 34 may take place via magnetic field induction, allowing the NFC interface 34 to communicate with other NFC interfaces 34 or to retrieve information from tags having radio frequency identification (RFID) circuitry. As discussed below, the NFC interface 34 may provide a manner of initiating or facilitating a transfer of user data from one electronic device 10 to another electronic device 10.

The electronic device 10 of FIG. 1 may also include a camera 36. With the camera 36, the electronic device 10 may obtain digital images or videos. In combination with optical character recognition (OCR) software, barcode-reading software, or matrix-code-reading software running on the electronic device 10, the camera 36 may be used to input data from printed materials having text or barcode information. Such data may include product data from a matrix barcode on a product, as described below.

In certain embodiments of the electronic device 10, one or more accelerometers 38 may sense the movement or orientation of the electronic device 10. The accelerometers 38 may provide input or feedback regarding the position of the electronic device 10 to certain applications running on the CPU 12. By way of example, the accelerometers 38 may include a 3-axis accelerometer from ST Microelectronics.

FIGS. 2-7 illustrate various specific embodiments of the electronic device 10 of FIG. 1. It should be appreciated that the specific embodiments of the electronic device 10 depicted in FIGS. 2-7 are representative only and should not be understood as exclusive. Turning first to FIG. 2, a handheld device 40 may represent an embodiment of the electronic device 10 of FIG. 1. By way of example, the handheld device 40 may be a portable phone or a portable media player, such as an iPhone® or an iPod® available from Apple Inc.

The handheld device 40 may have an enclosure 42 of plastic, metal, composite materials, or other suitable materials in any combination. The enclosure 42 may protect the interior components of the handheld device 40 from physical damage and electromagnetic interference (EMI). Additionally, the enclosure 42 may allow certain frequencies of electromagnetic radiation to pass through to wireless communication circuitry within the handheld device 40 to facilitate wireless communication.

The display 18 of the handheld device 40 may include the user interface 20 in the form of a GUI, which may have a number of individual icons representing applications that may be activated. In some embodiments of the handheld device 40, the display 18 may serve as a touch-sensitive input device and the icons may be selected by touch. In some embodiments, a product benefit management application icon 44 may be selectable by a user. Here, the product benefit management application is designated as “Products +” to indicate to a user that selection of the icon 44 will allow the user to store and use benefits associated with products or services and more.

When the product benefit management application icon 44 is selected, the product benefit management application may open, as described further below. The product benefit management application may enable a user to obtain, store, or use benefits associated with a product or service using the techniques described herein. The user interface 20 on the display 18 of the handheld device 40 may also include certain status indicator icons 46, which may indicate the status of various components of the handheld device 40. For example, the status indicator icons may include a cellular reception meter, an icon to indicate when the PAN interface 28 is active (e.g., when a Bluetooth network is in use), or a battery life meter.

The handheld device 40 may connect to another electronic device 10, such as a computer, through the wired I/O interface 24 located at the bottom of the device. For example, the wired I/O interface 24 may be a proprietary connection for interconnecting the handheld device 40 and another electronic device 10 via USB or FireWire®. Once connected, the devices may synchronize and/or transfer certain data, such as an electronic benefit data. The wired I/O interface 24 on the handheld device 40 may be understood to represent a communication channel to another electronic device 10 for communication of a benefit or other data in accordance with techniques discussed herein.

User input structures 48, 50, 52, and 54 may supplement or replace the touch-sensitive input capability of the display 18 for interaction with the user interface 20. By way of example, the user input structures 48, 50, 52, and 54 may include buttons, switches, a control pad, keys, knobs, a scroll wheel, or any other suitable input structures. The user input structures 48 and 50 may work in conjunction with the display 18 to control functions of the device. Particularly, the user input structure 48 may be a lock/unlock sliding button to lock or unlock the handheld device 40; the user input structure 50 may be a navigation button for navigating the user interface 20 to a default or home screen; the user input structures 52 may be a pair of buttons for navigating up or down a screen of the user interface 20 or for controlling volume; and the user input structure 54 may be an on/off button.

Certain embodiments of the handheld device 40 may include telephone functionality. As such, the handheld device 40 may include audio input structures 56 and an audio output structure 58. The audio input structures 56 may be one or more microphones for receiving voice data from a user, and the audio output structure 58 may be a speaker for outputting audio data, such as data received by the handheld device 40 over a cellular network. In certain embodiments, an audio port 60 may facilitate peripheral audio input and output devices, such as headsets, speakers, or microphones for use with the handheld device 40. It should be appreciated that telephone functionality associated with the handheld device 40 may also include emitting a ringtone through the audio output structure 58, causing the handheld device 40 to vibrate, or changing images on the display to indicate an incoming phone call.

As noted above, some embodiments of the electronic device 10 may include the NFC interface 34. The handheld device 40 depicted in FIG. 2 may include the NFC interface 34 in any suitable location within the enclosure 42. Because the NFC interface 34 may permit communication at a very short range, the location of the NFC interface 34 in the handheld device 40 may be indicated on exterior of the enclosure 42, as illustrated in FIG. 2. The NFC interface 34 may enable the handheld device 40 to engage in near field communication (NFC) with RFID tags or other NFC enabled electronic devices 10. For example, the NFC interface 34 may provide a manner of receiving electronic data from an RFID tag, as described further below.

The handheld device 40 of FIG. 2 may additionally include the camera 36, which may be located, for example, on the back of the handheld device 40. As discussed further below, the camera 36 may be used to obtain a digital image of a matrix barcode tag. The handheld device 40 may thereafter employ optical character recognition (OCR) software, barcode-reading software, or matrix-code-reading software to extract information from the image, as described further below.

It should also be appreciated that the handheld device 40 may include the location sensing circuitry 22 or the accelerometers 38. Certain applications running on the handheld device 40 may obtain information relating to the position, orientation, or movement of the handheld device from the location sensing circuitry 22 or the accelerometers 38. The position, orientation, or movement information may enable applications to display personalized data or to display data in an innovative manner in response to user movement.

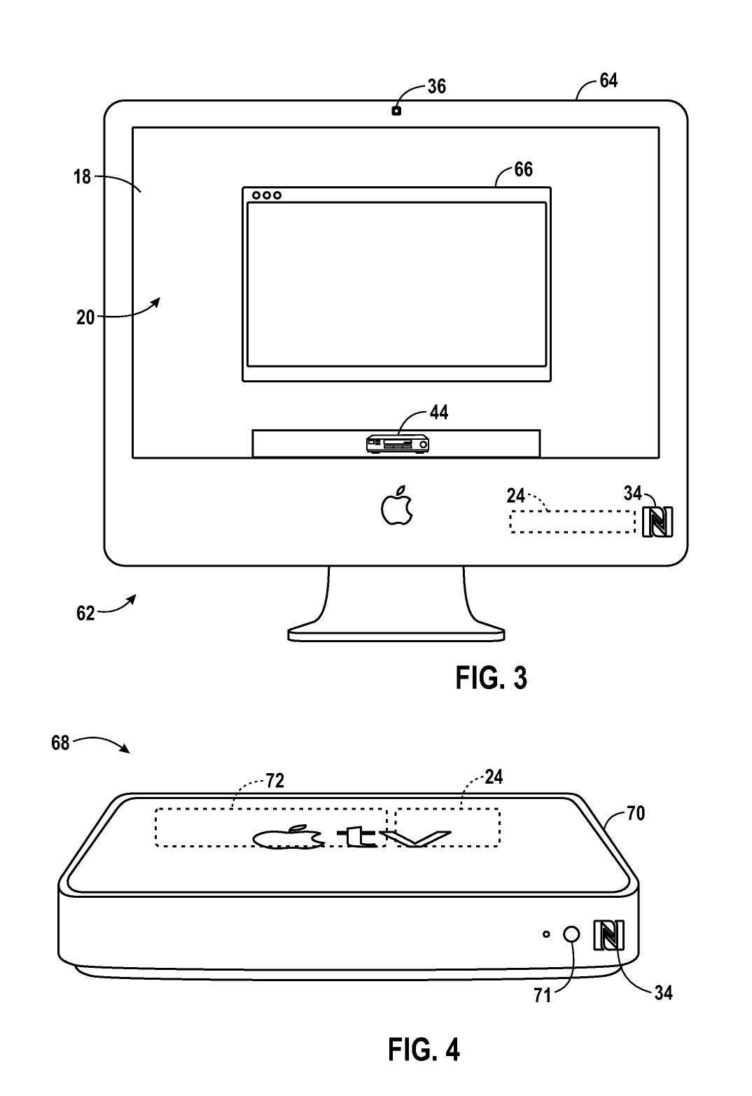

Turning to FIG. 3, a computer 62 may represent another embodiment of the electronic device 10 of FIG. 1. The computer 62 may be any computer, such as a desktop computer, a server, or a notebook computer, but may also be a standalone media player or video gaming machine. By way of example, the computer 62 may be an iMac®, a MacBook®, or an AppleTV® by Apple Inc. It should be noted that the computer 62 may also represent a personal computer (PC) by another manufacturer. An enclosure 64 may protect internal components of the computer 62. Such internal components may include, for example, the CPU 12, the main memory 14, the nonvolatile storage 16, certain network interfaces 26, and/or the NFC interface 34.

The location of the NFC interface 34 may be noted by a label on the exterior of the enclosure 64. The NFC interface 34 may permit near field communication between the computer 62 and other NFC enabled electronic devices 10, such as the handheld device 40. As should be appreciated, the NFC interface 34 may also enable the computer 62 to receive data from an RFID tag associated with a product or service, as described further below.

The display 18 of the computer 62 may display the user interface 20 in the form of a GUI. The user interface 20 of the computer 62 may depict any user data associated with applications 66 running on the computer 62. Additionally, the user interface 20 may include a variety of icons related to applications installed on the computer 62. One such icon may be the product benefit management application icon 44. When the product benefit management application icon 44 is selected, the product benefit management application may open. The product benefit management application may enable a user to obtain, store, or use benefits associated with a product or service using the techniques described herein.

A user of the computer 62 may interact with the user interface 20 with various peripheral input devices, such as a keyboard or mouse, which may connect to the computer 62 via the wired I/O interface 24. The wired I/O interface 24 may also provide a high bandwidth communication channel for interconnecting other electronic devices 10, such as the handheld device 40, to the computer 62.

The computer 62 may also include the camera 36. As discussed further below, the camera 36 may obtain, among other things, a digital image of a matrix barcode tag associated with a product or service. With the digital image, the handheld device 40 may employ optical character recognition (OCR) software, barcode-reading software, or matrix-code-reading software to extract information from the image.

FIG. 4 depicts a standalone media player 68 representing another embodiment of the electronic device 10 of FIG. 1 that may be configured to operate using the techniques described herein. By way of example, the standalone media player 68 may be an AppleTV® device by Apple, Inc. However, the standalone media player 68 may also represent a media player or video game console by another manufacturer.

Within an enclosure 70 of the standalone media player 68 may reside various components of the electronic device 10. For example, the enclosure 70 may house the nonvolatile storage 16 for storing media files and media playback software and the CPU 12 for processing the media files. Wireless network interfaces 26, such as the PAN interface 28 and LAN interface 30, may also be located within the enclosure 70, allowing the standalone media player 68 to communicate with other electronic devices 10 or to connect to the Internet. Using the wireless network interfaces 26, the standalone media player 68 may obtain or exchange media content as well as gain access to the Internet.

The standalone media player 68 may also include, among other things, an indicator light and infrared (IR) port 72 and audio/video (NV) outputs 74. The indicator light and IR port 72 may receive an IR control signal from a remote control and may indicate to a user when the standalone media player 68 is on, off, receiving or exchanging content, or obtaining data in accordance with techniques described herein. The NV outputs 74 may provide a manner for connecting the standalone media player 68 to an analog or digital television or other media display devices. The standalone media player 68 may additionally include the wired I/O interface 24, which may permit the standalone media player 68 to communicate rapidly with a wired connection to another electronic device 10.

The standalone media player 68 may also include the NFC interface 34. With the NFC interface 34, the standalone media player 68 may communicate with another electronic device 10 having another NFC interface 34. Additionally, as described further below, the NFC interface 34 may also enable the standalone media player 68 to receive data from an RFID tag associated with a product or service, as described further below.

Turning to FIG. 5, an NFC enabled kiosk 74 may represent an embodiment of the electronic device 10 of FIG. 1, which may be configured to enable a user of another electronic device 10, such as the handheld device 40, to obtain or use a benefit associated with a product or service. For example, as described further below, a user may purchase or otherwise obtain benefits associated with a product or service from the kiosk 74 or the user may use a benefit associated with a product or service, such as an electronic coupon for merchandise, at the kiosk 74. Additionally, the kiosk 74 may be used to credit the account of the holder of a product or service with certain media content, as described further below.

The kiosk 74 may generally include a point of sale device 76 with a communicably attached NFC interface 34. The point of sale device 76 may include a touch screen display 78, which may serve as an operator interface, and a customer interface 80, which may include a point of sale display 82. The point of sale display 82 may display, for example, an amount owed, a product being purchased, or a quantity of change due to the customer in a transaction. The NFC interface 34 may be housed within an enclosure 84. The exterior of the enclosure 84 may include an NFC label 86 to indicate that the customer may interact with the kiosk 74 using a NFC enabled electronic device 10 or an NFC enabled card.

To provide functionality for obtaining or using a benefit associated with a product or service, the kiosk 74 may communicate with various other computers over a variety of networks using the network interfaces 26. By way of example, the kiosk 74 may communicate with a local server over a local network or a web service over the Internet. The local server or the web service may track, for example, whether a benefit associated with a product or service has been used by a particular user.

FIG. 6 illustrates an NFC enabled unmanned kiosk 88, which may represent another embodiment of the electronic device 10 configured to enable a user of another electronic device 10, such as the handheld device 40, to obtain or use a benefit associated with a product or service. The unmanned kiosk 88 may function largely in the same manner as the kiosk 74 of FIG. 5, but may operate without a human cashier. For example, as described below, a user may purchase or otherwise obtain benefits associated with a product or service from the unmanned kiosk 88 or the user may use a benefit associated with a product or service, such as an electronic coupon for merchandise, at the unmanned kiosk 88. Additionally, the unmanned kiosk 88 may be used to credit the account of the holder of benefit associated with a product or service with certain media content, as described further below.

An enclosure 90 may protect the internal components of the unmanned kiosk 88 from its particular environment. For example, the enclosure 90 may include weather resistant material and sealant if the unmanned kiosk 88 is to be located outdoors. Among the components housed within the enclosure 90 may be the NFC interface 34. The NFC interface may enable a user to interact with the unmanned kiosk 88 using an NFC enabled electronic device 10 or an NFC enabled card.

The unmanned kiosk 88 may also include other elements of the electronic device 10 described above with reference to FIG. 1, such as the display 18 having the user interface 20. As the display 18 may be a touch sensitive display, a user may interact with certain on-screen elements 92 to conduct a transaction. Such transactions may include, for example, obtaining credit for certain content associated with a user account.

As noted above with reference to the kiosk 74 of FIG. 5, the unmanned kiosk 88 may also communicate with various other computers over a variety of networks to provide functionality for obtaining or using a benefit associated with a product or service. By way of example, the unmanned kiosk 88 may communicate with a local server over a local network or a web service over the Internet using the network interfaces 26. The local server or the web service may track, for example, whether a benefit associated with a product or service has been used by a particular user.

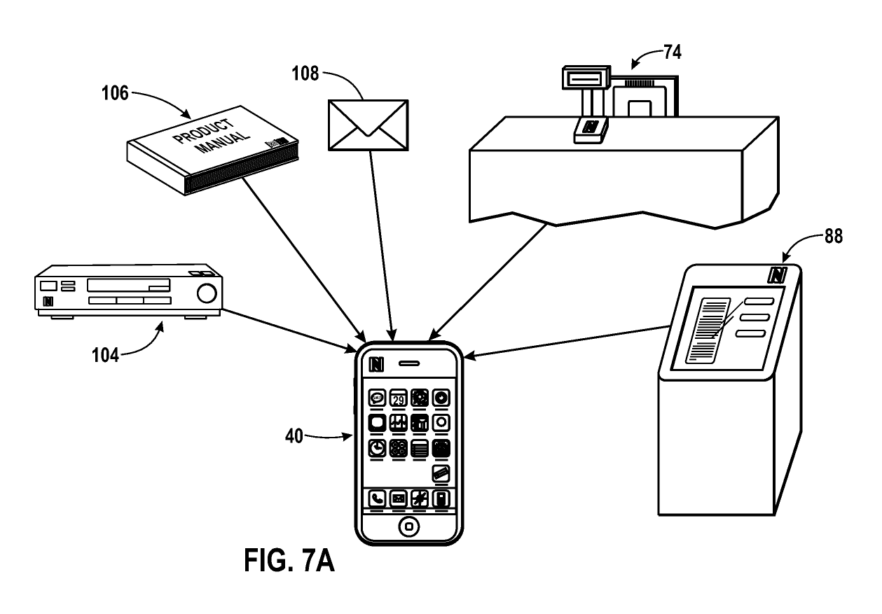

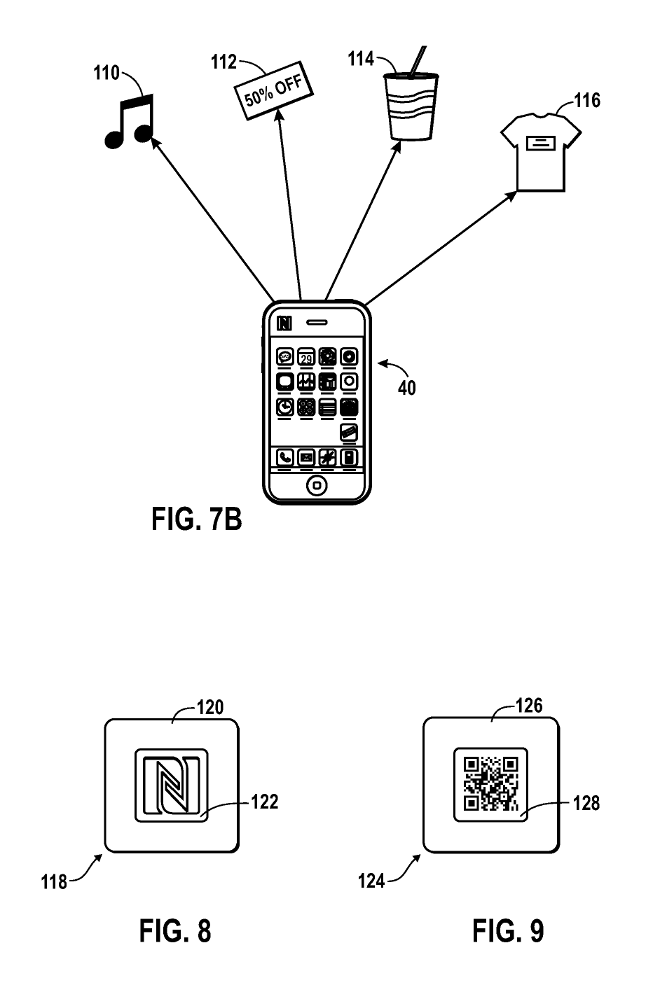

FIGS. 7A-B describe generally a benefit system 102 for obtaining, storing, accessing, and using benefits associated with a product or service with an electronic device 10 such as the handheld device 40. It should be appreciated that while the handheld device 40 may be used in the benefit system 102, the techniques described herein should be understood as applicable to any electronic device 10 and are not limited to the handheld device 40.

Turning first to FIG. 7A, benefits associated with a product or service may be stored on the handheld device 40 in a variety of ways. The benefits, as noted below, may be obtained and stored on the handheld device 40 or other electronic device 10 using a variety of techniques. Further, it should be understood that electronic benefit information that may define a benefit associated with a product or service may be any data indicating a benefit. For example, electronic benefit information may include encrypted or unencrypted XML files which may be associated with a particular device or user account. The electronic benefit information may enable a range of benefits, as discussed below, such as discount coupons, digital content, etc., which may relate to a particular product or service. As described herein, the electronic benefit information may represent, among other things, “product data,” “authenticated product data,” and/or “supplemental product data.”

By way of example, the handheld device 40 may obtain electronic benefit information by scanning an NFC interface 34, a PAN interface 28, or a LAN interface 39, of a product, such as an A/V receiver 104; by scanning a tag on a product or service manual 106; by receiving electronic benefit information via an e-mail message 108 or via the Internet; or by purchasing a product or service, or a benefit associated with such a product or service, from the kiosk 74 or from the unmanned kiosk 88. Thus, a user may purchase or otherwise obtain a product or service and thereafter receive benefits associated with the product or service using the techniques described below. It should be appreciated that the manner of obtaining electronic benefit information is not limited to those described above. Further, obtaining electronic benefit information associated with a product or service may also include communicating product benefit information to a web service, which may authenticate the associated benefit. A product benefit management application, which may run on the handheld device 40, may store and enable access to the electronic benefit information.

FIG. 7B illustrates a variety of benefits that may become accessible on the handheld device 40 once the handheld device 40 has obtained electronic benefit information in the manners described above. After receiving electronic benefit information in one of the manners depicted in FIG. 7A, benefits may be obtained by communicating information associated with the benefits to a web service. The web service may transmit certain benefits back to the electronic device 10 in the form of supplemental product data, which may include, for example, encrypted or unencrypted XML files that may be associated with a particular device or user account. The benefits may be received in a form of digital content credits that may be redeemable for digital content from a digital content service, such as iTunes® by Apple Inc.

As depicted in FIG. 7B, among the benefits that may be associated with products and services may be digital content 112, discounts 114 on merchandise related to the product or service, discounts or prepaid refreshments 116 related to the product or service, or other discounts or prepaid merchandise 118 for the event, and other related content, such as a digital map 120 to the event. As should be appreciated, the benefits described above are exemplary only, and should not be understood as exclusive. Many other benefits may be stored in the handheld device 40, as discussed further below.

To provide a brief example illustrating the benefit system 102 of FIGS. 7A-B, a user may purchase a product having an RFID tag configured to provide electronic benefit information relating to the product. The user may tap a handheld device 40 running a product benefit management application to the RFID tag, at which point the handheld device 40 may receive electronic benefit information from the RFID tag. The handheld device 40 may next authenticate the electronic benefit information with a web service such as iTunes®. Thereafter, the user may use the handheld device 40 to view various technical support videos for the product, to obtain discounted peripheral products associated with the product, or to obtain a live recording of the concert once the concert is over.

FIG. 8 illustrates an RFID tag 118 that may be associated with a product or service. Particularly, an adhesive 120 may enable an RFID microchip 122 to adhere to the product directly or to materials associated with the product or service, and may provide certain electronic benefit information to a personal electronic device that may access benefits related to the product or service. The RFID microchip 122 may passively or actively transfer electronic benefit information when the NFC interface 34 of the personal device is placed nearby (e.g., within 2-4 cm). Accordingly, the RFID microchip 122 may comply with such standards as ISO 14443 or ISO 15693 for proximity or vicinity RFID.

Electronic benefit information stored on the RFID microchip 122 may include, among other things, a serial number and/or an XML message having various information identifying the product or service. For example, the serial number may enable the personal device to search a database at a web service. Based on the serial number from the RFID microchip 122, the web service may provide information identifying the type of product or service, a location where supplemental product benefits may be obtained, and/or various data representing product benefits. The XML message may provide similar information, such as the serial number, the type of product or service, a location where data representing supplemental product benefits may be obtained, and/or the data representing the supplemental product benefits.

FIG. 9 illustrates a matrix barcode tag 124 that may be associated with the product or service. In the manner of the RFID tag 118 of FIG. 8, the matrix barcode tag 124 may be placed on the product or materials associated with the product or service to provide electronic benefit information to the personal device. The matrix barcode tag 124 may include an adhesive 126 with a printed matrix barcode 128. The matrix barcode 128 may be any 2-D matrix code capable of encoding a serial number or other data pertaining to the product or service with which it may be associated. By way of example, the matrix barcode 128 may be a QR code, an Aztec Code, or a Data Matrix code. The matrix barcode 128 may be read by a camera 36 of the personal device.

To enable the personal device to obtain benefits associated with the product or service, the matrix barcode 128 may encode certain electronic benefit information. Like the electronic benefit information of the RFID microchip 122, the electronic benefit information encoded in the matrix barcode 128 may include a serial number and/or an XML message having various information identifying the product or service. For example, the serial number may enable the personal device to search a database at the web service. Based on the serial number from the RFID microchip 122, the web service may provide information identifying the type of product or service, a location where supplemental product benefits may be obtained, and/or various data representing product benefits. The XML message may provide similar information, such as the serial number, the type of product or service, a location where data representing supplemental product benefits may be obtained, and/or the data representing the supplemental product benefits.

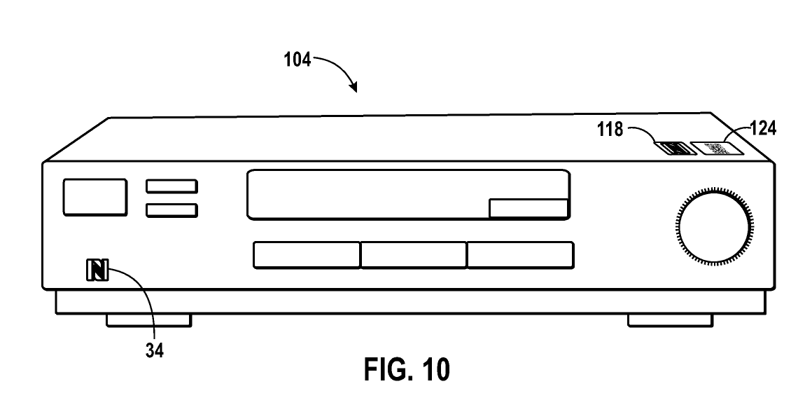

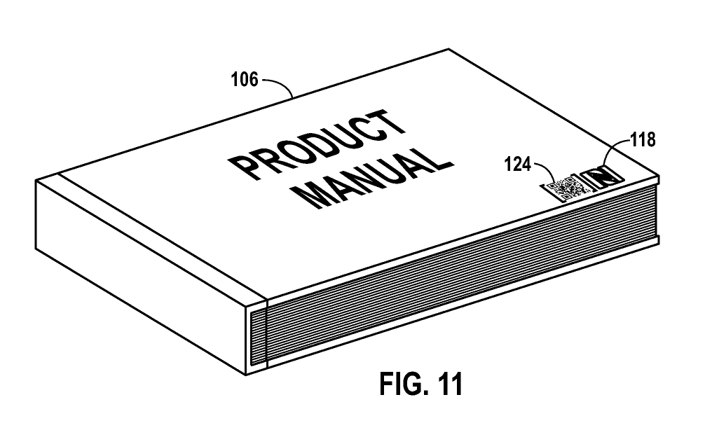

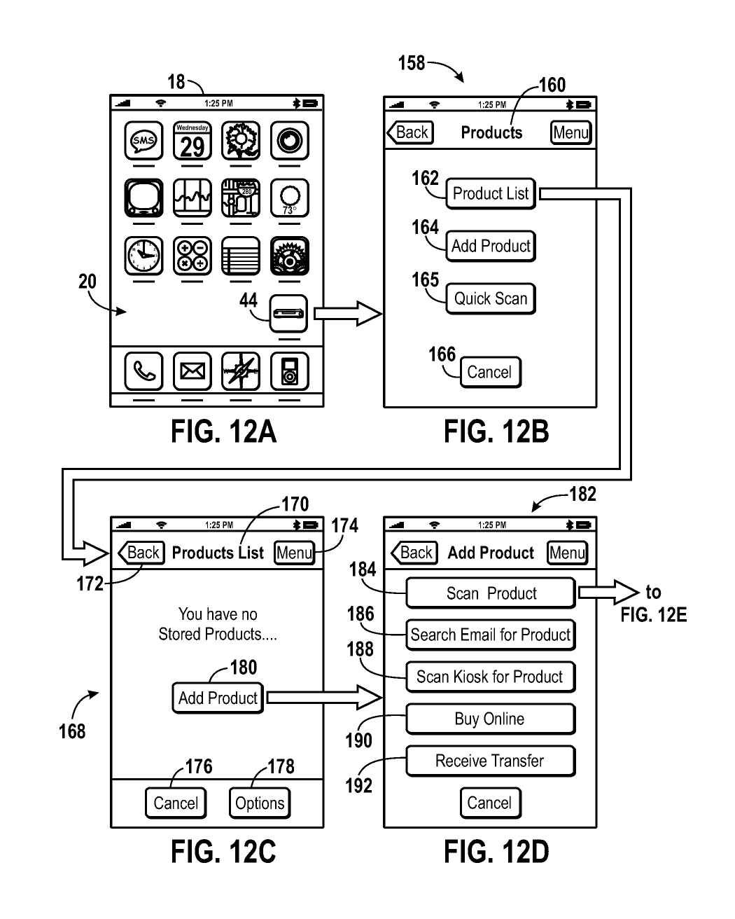

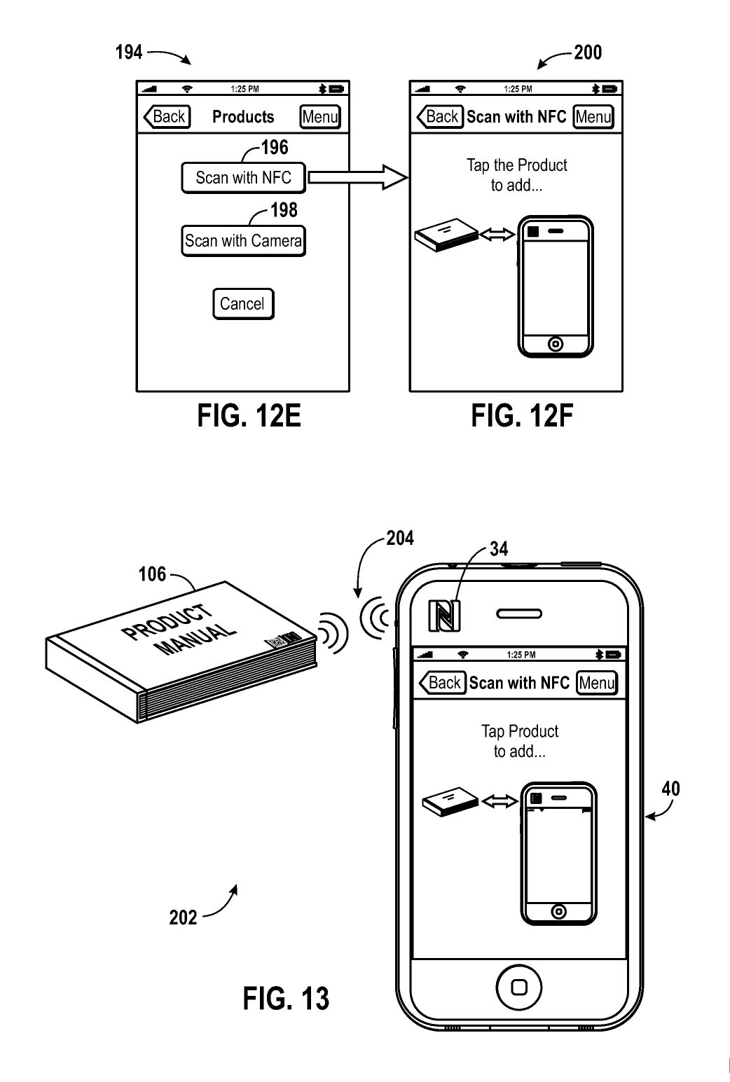

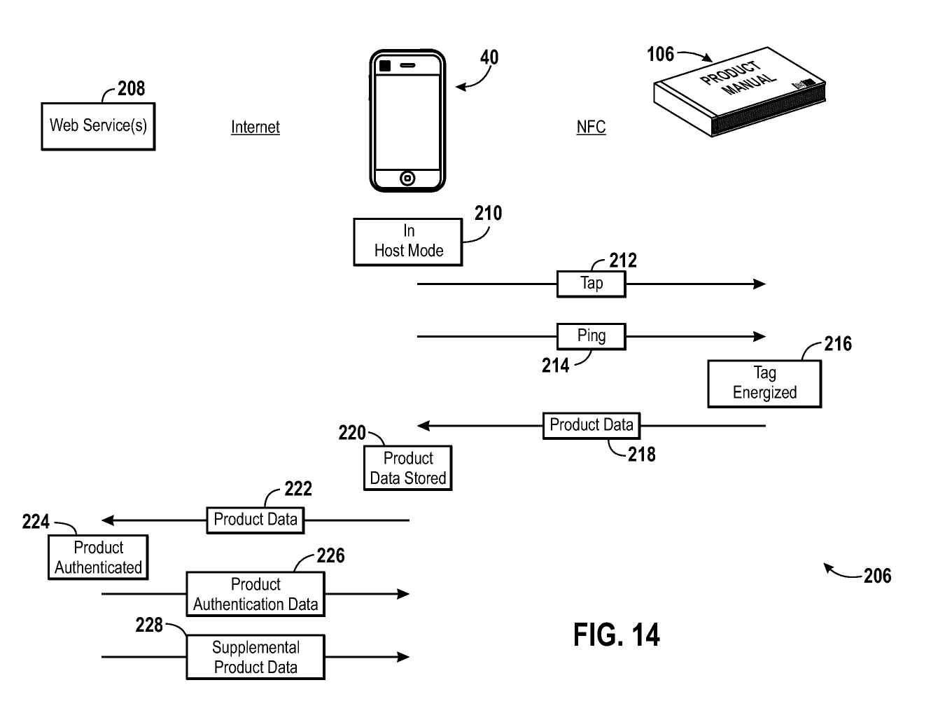

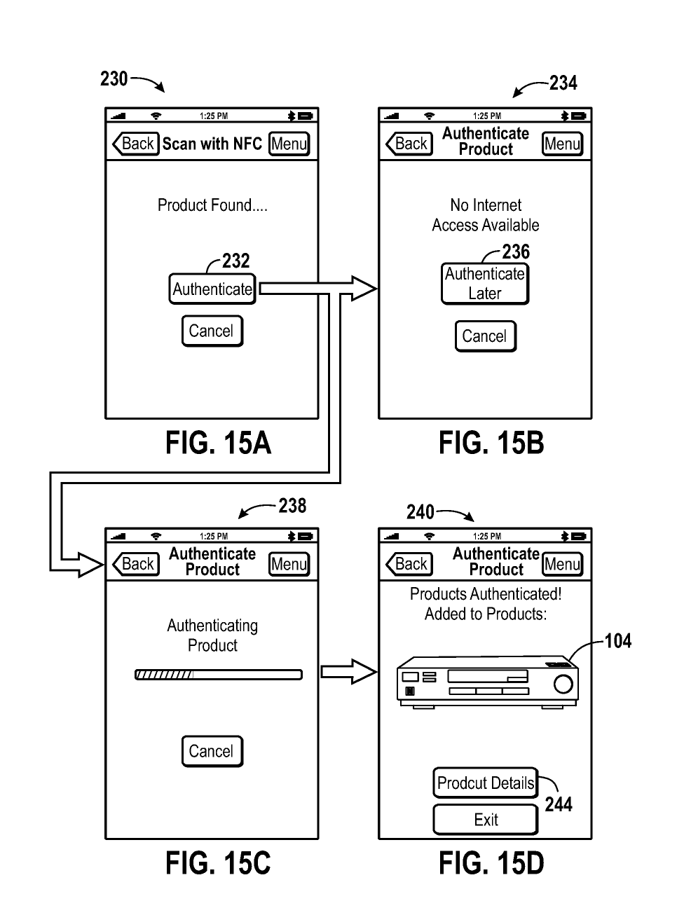

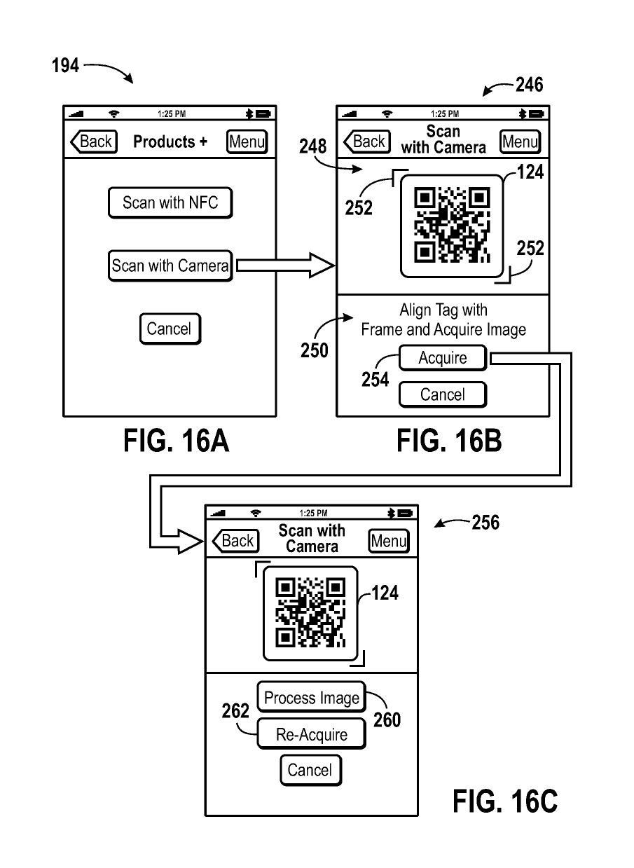

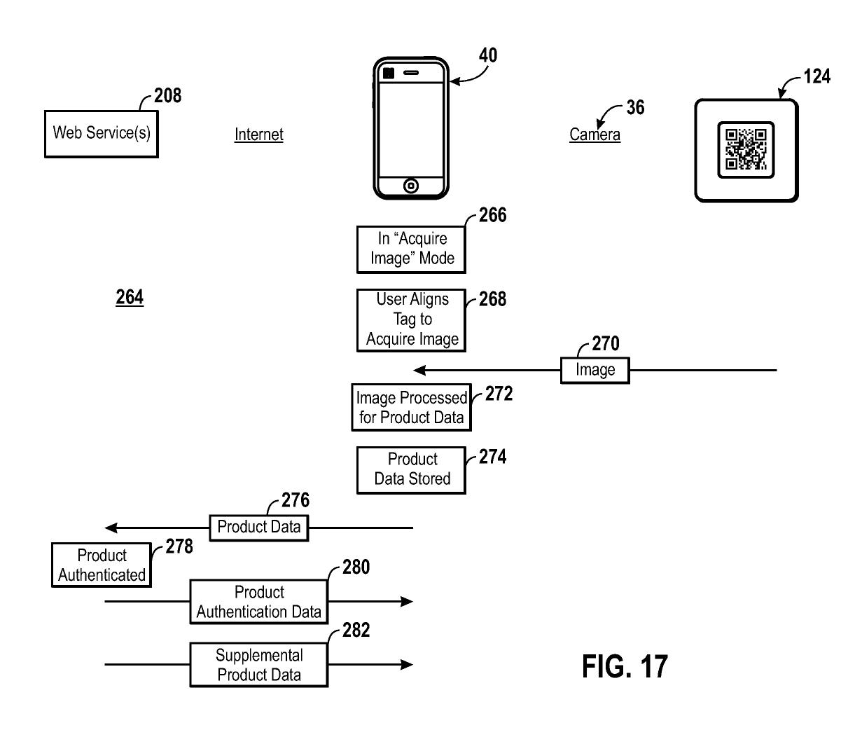

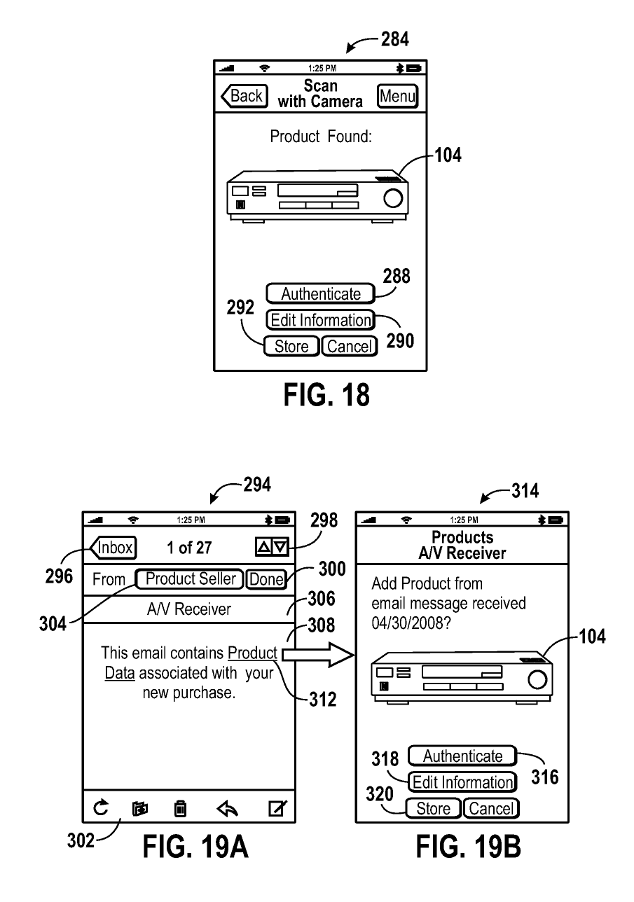

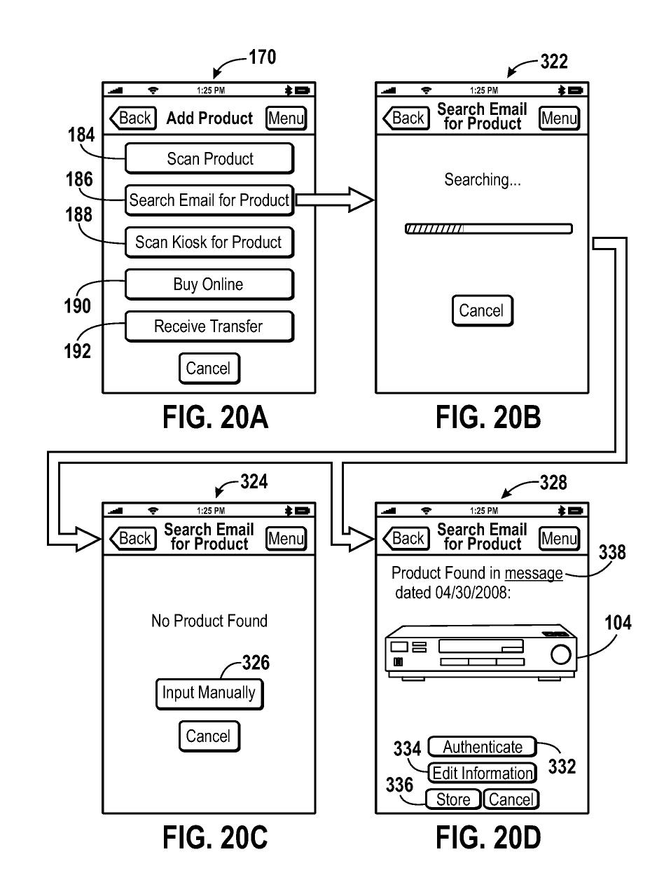

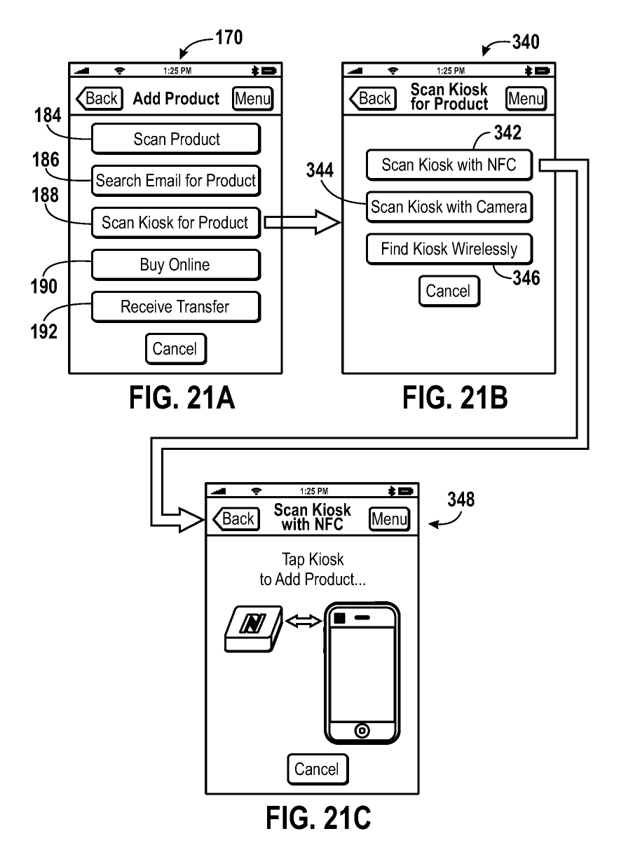

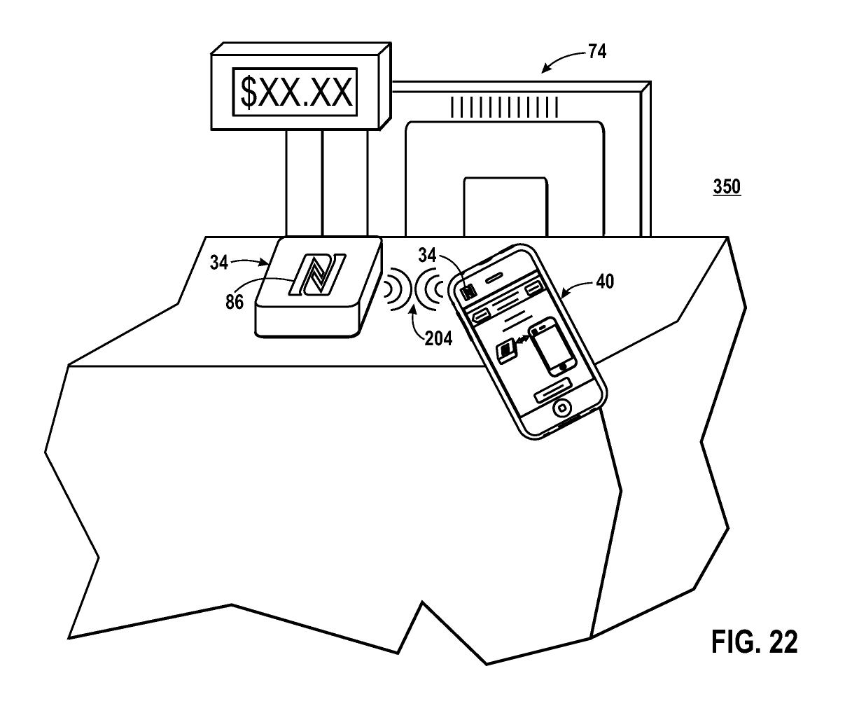

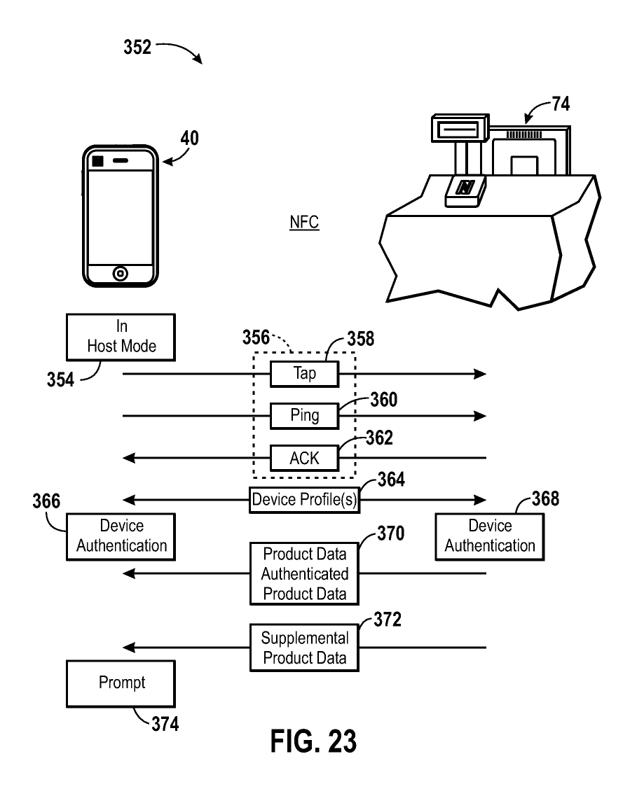

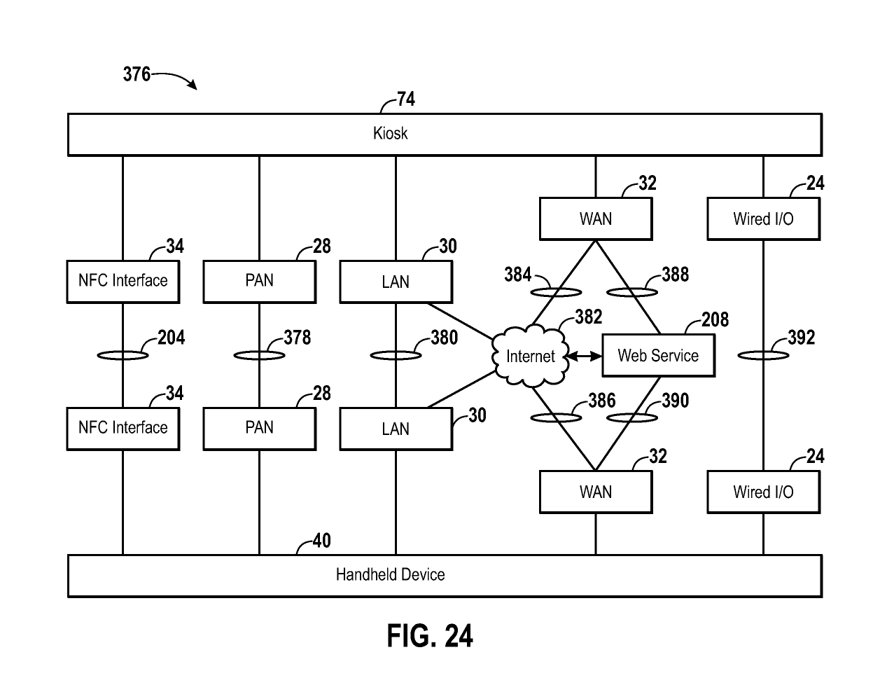

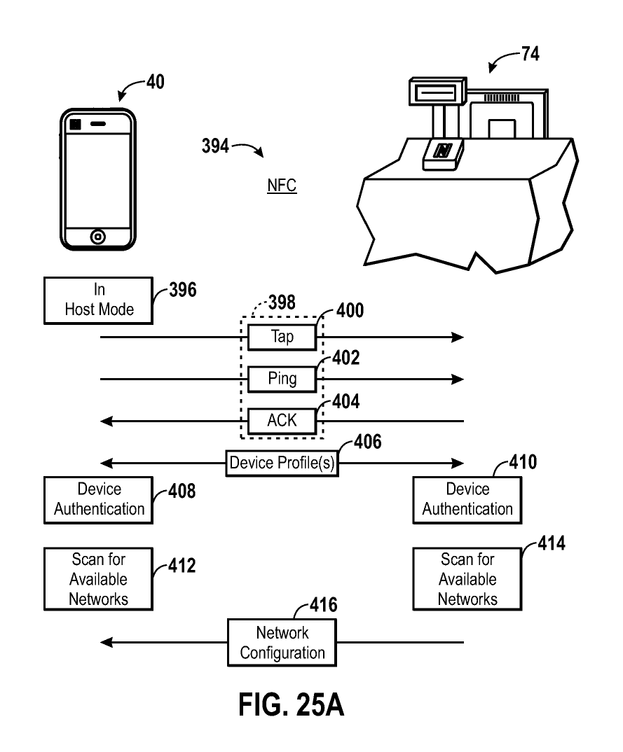

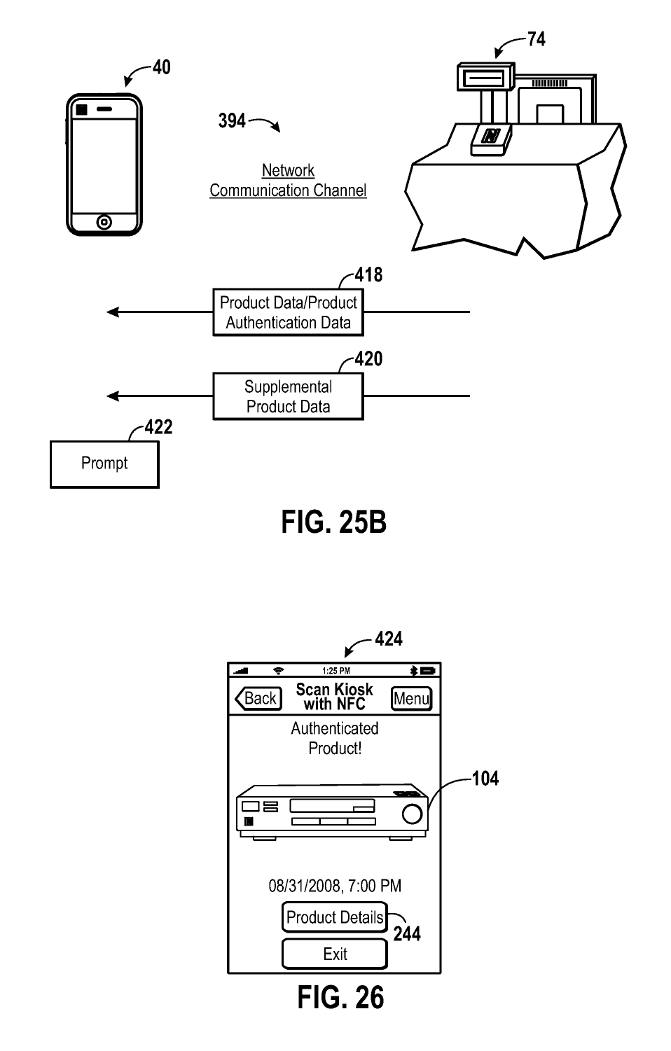

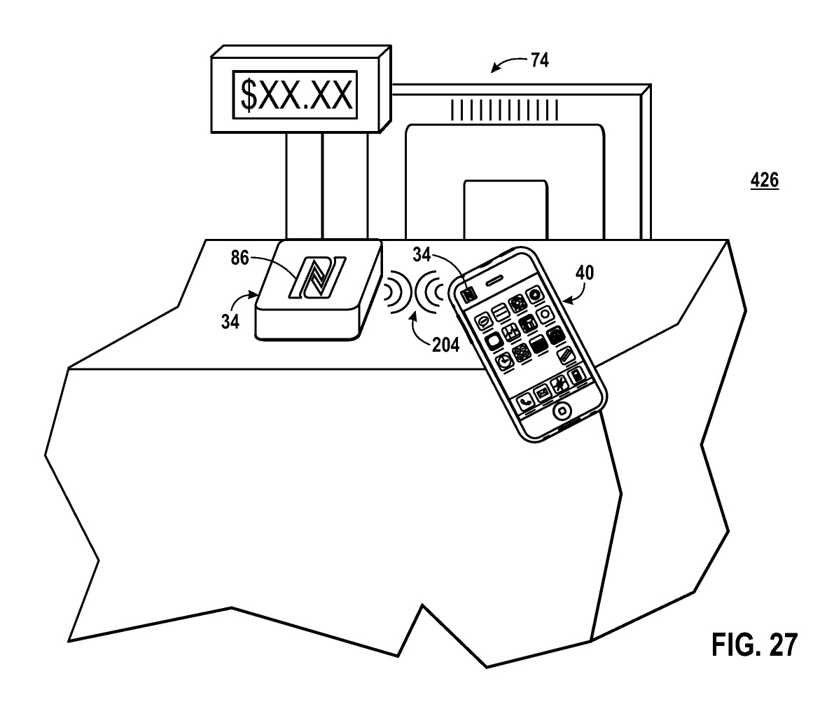

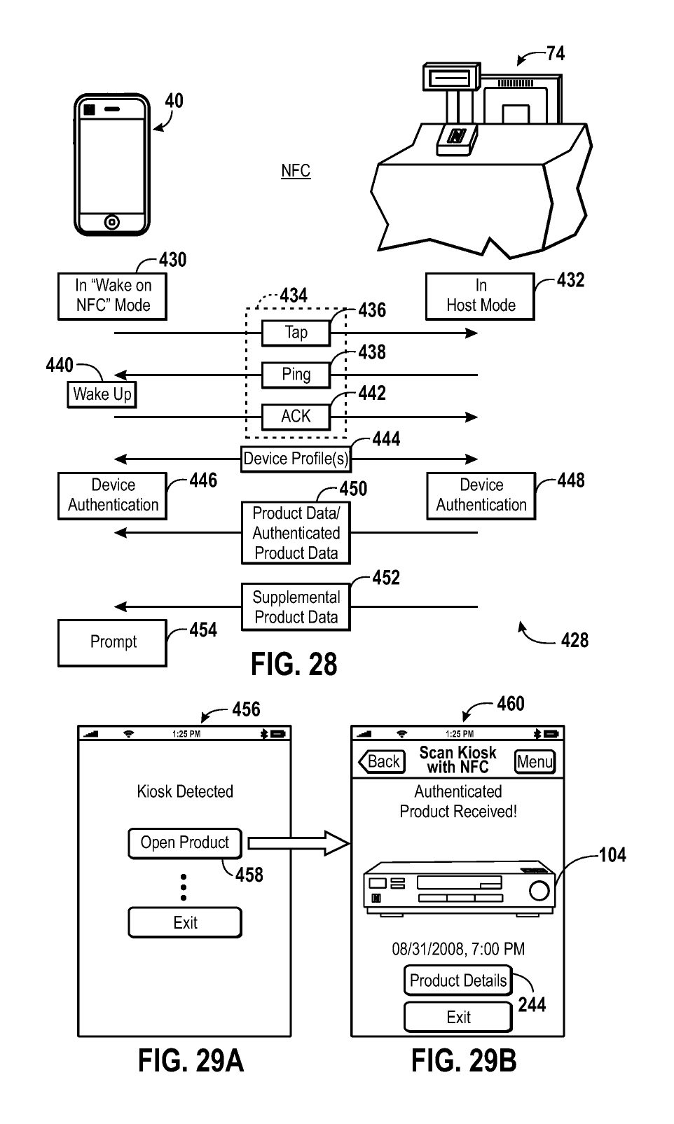

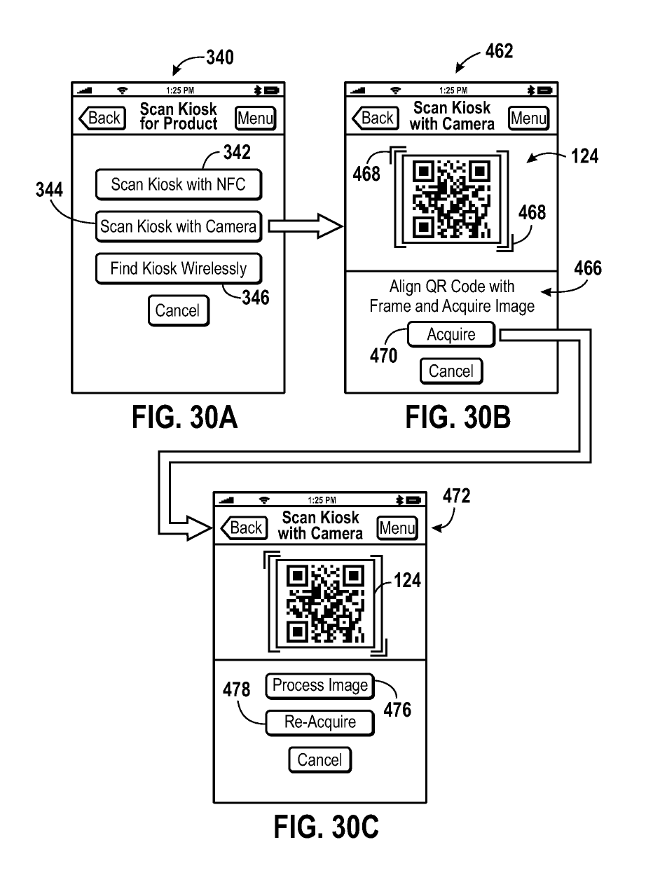

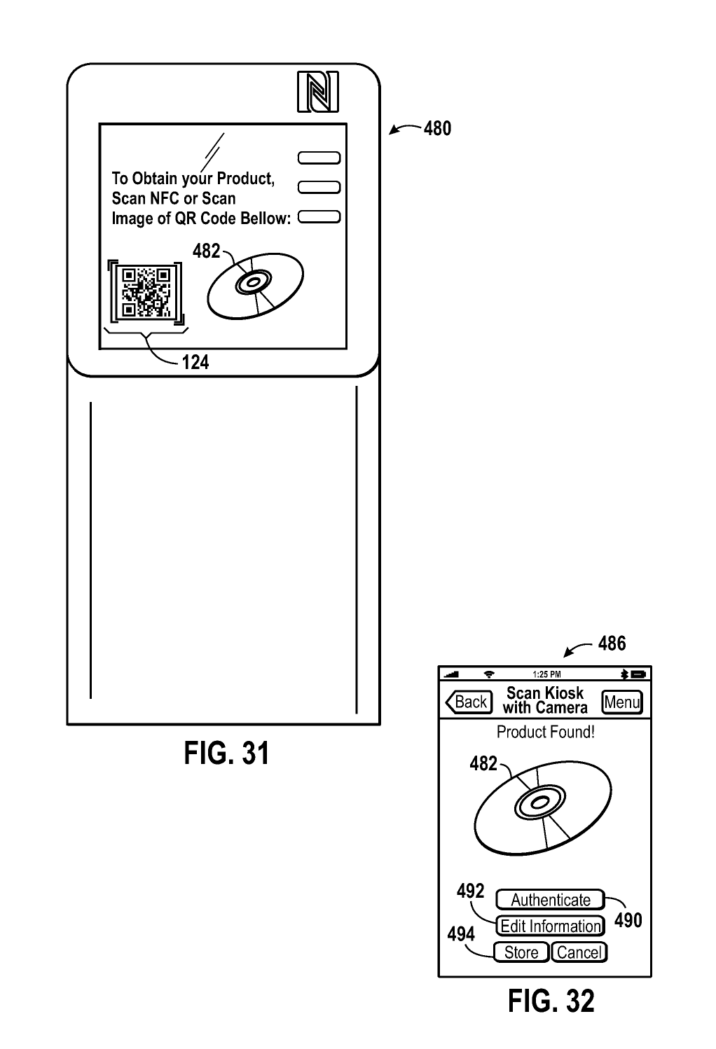

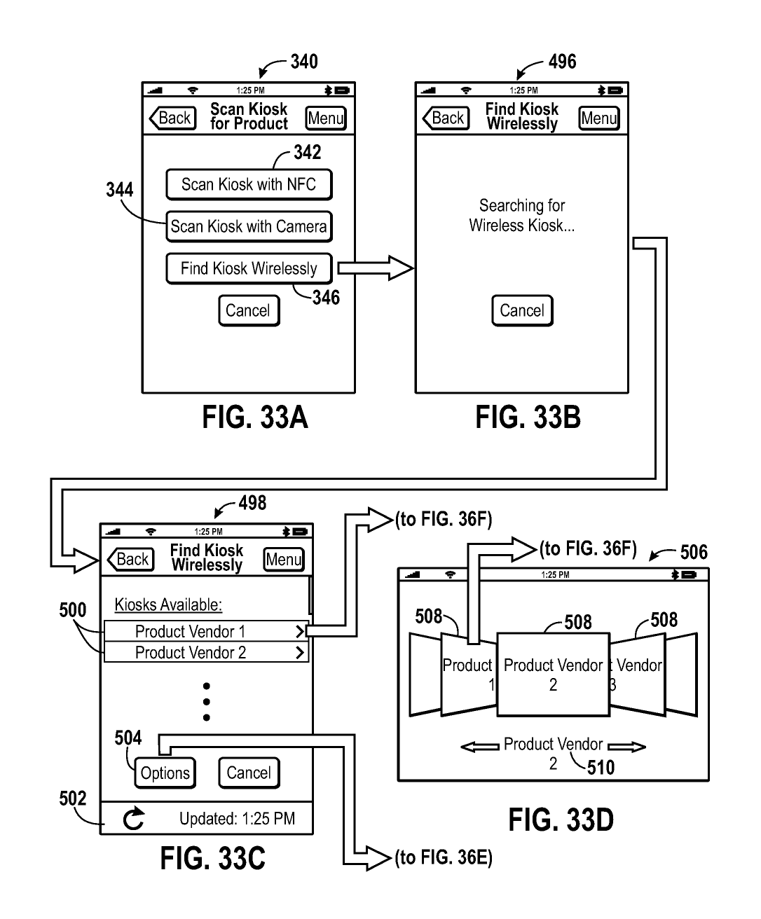

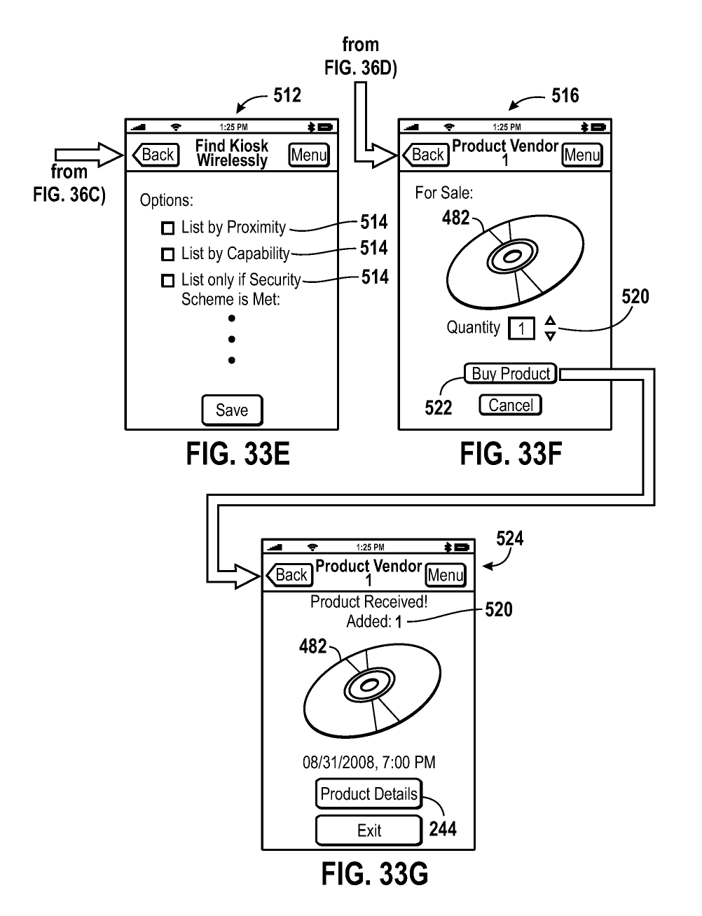

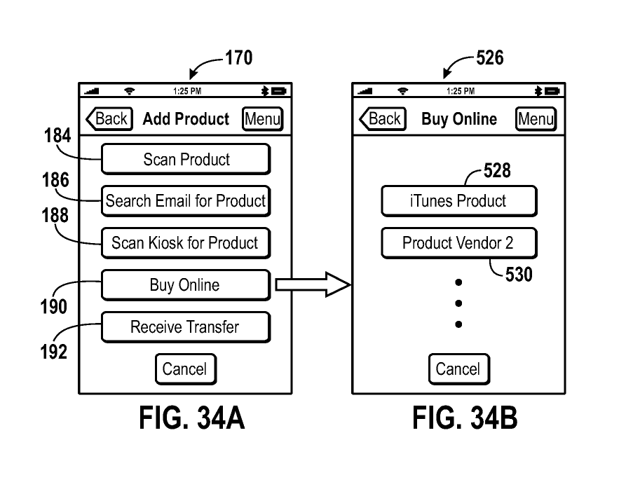

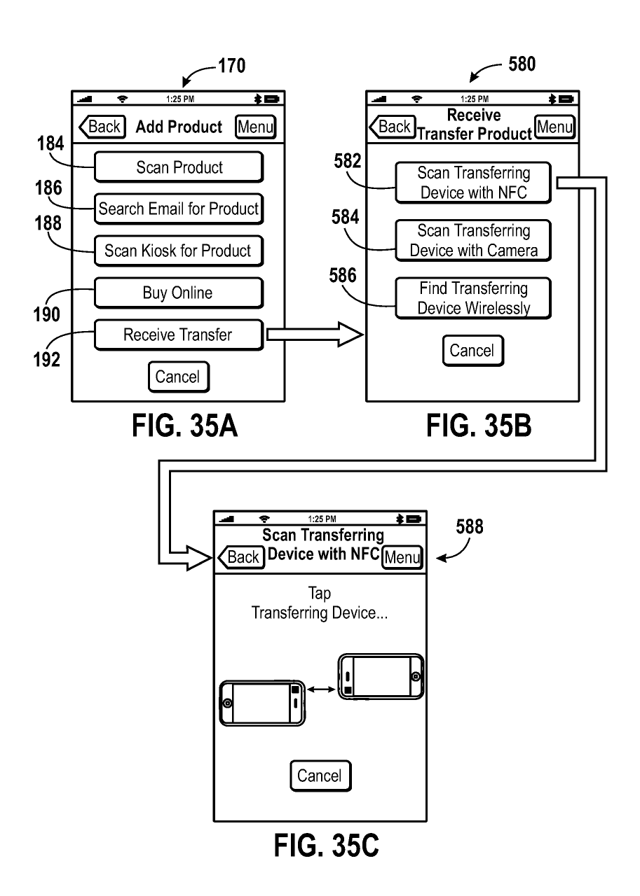

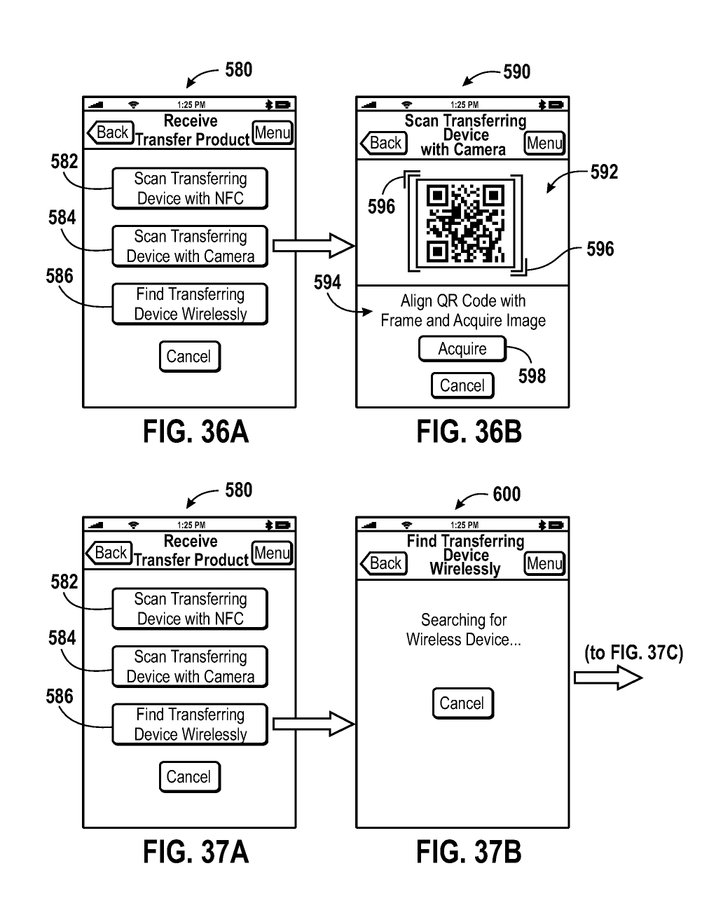

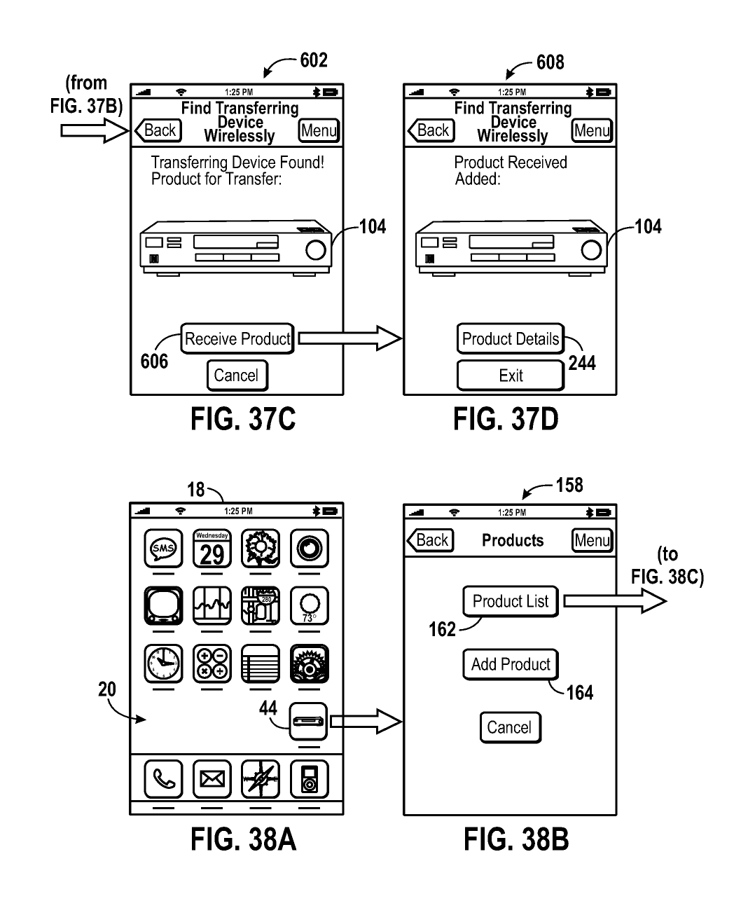

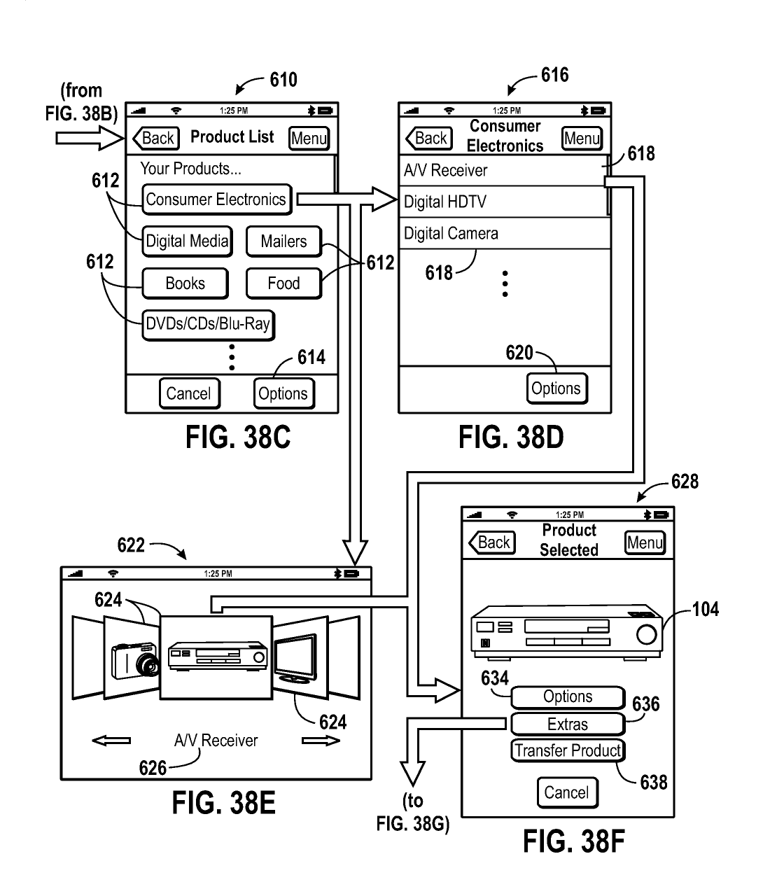

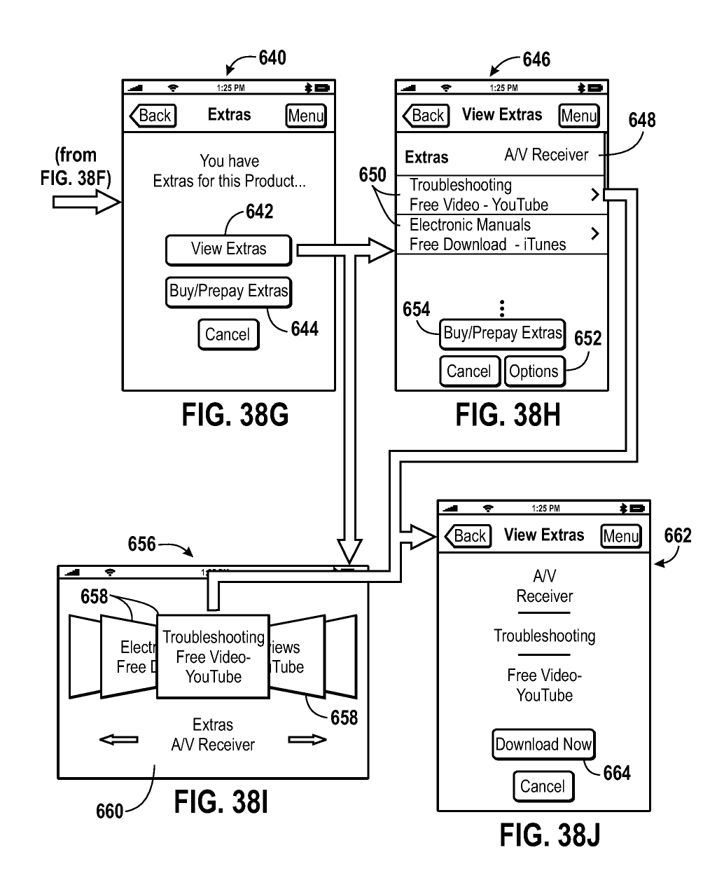

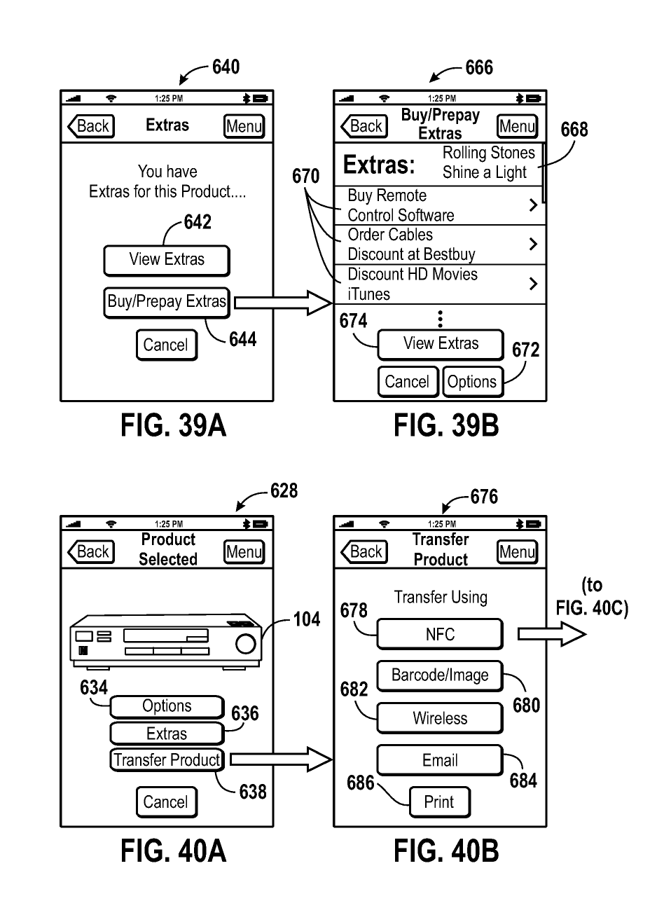

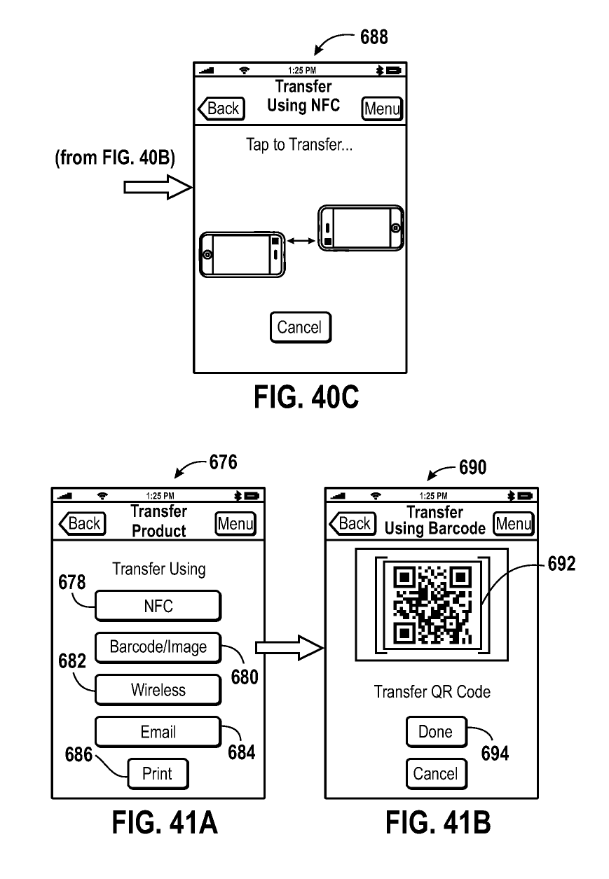

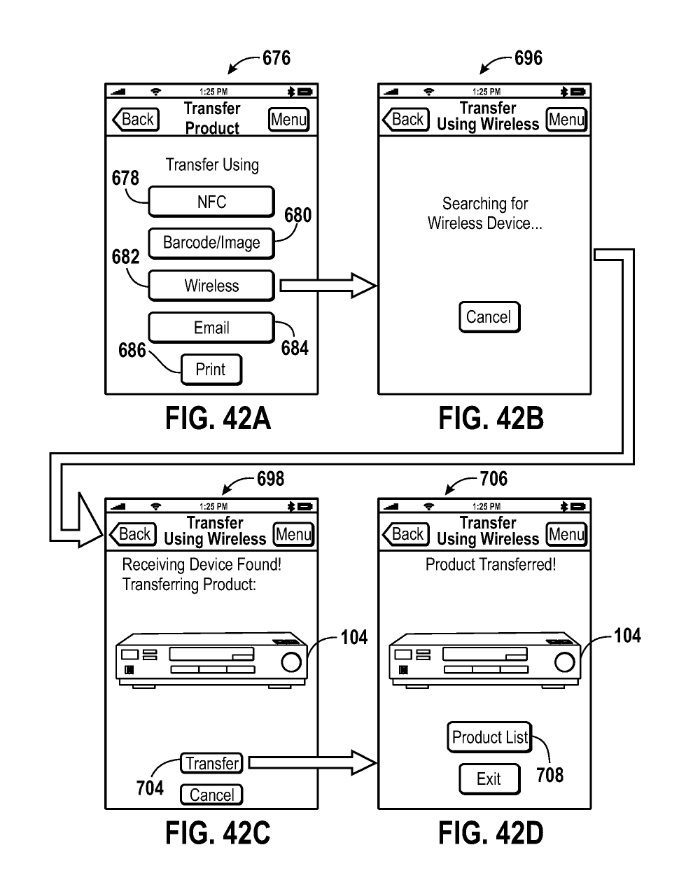

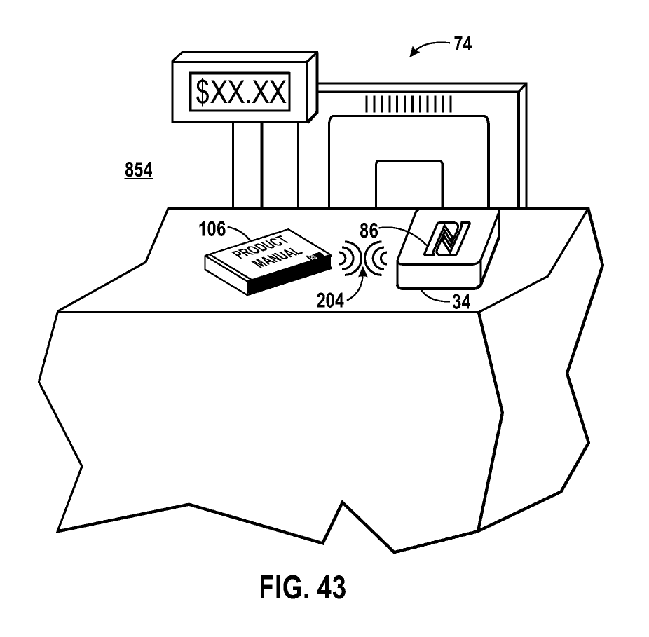

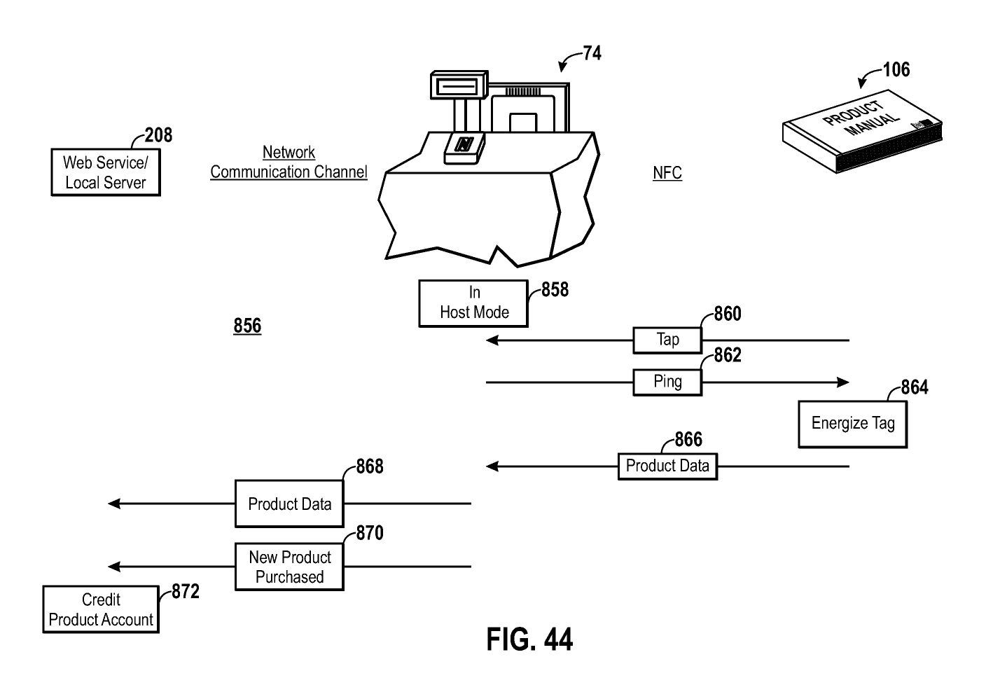

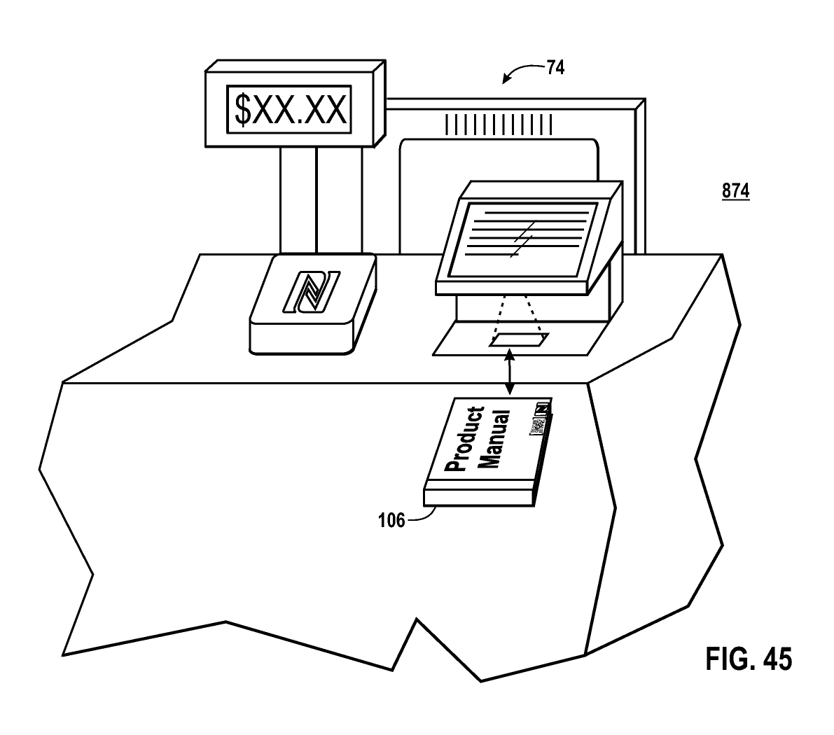

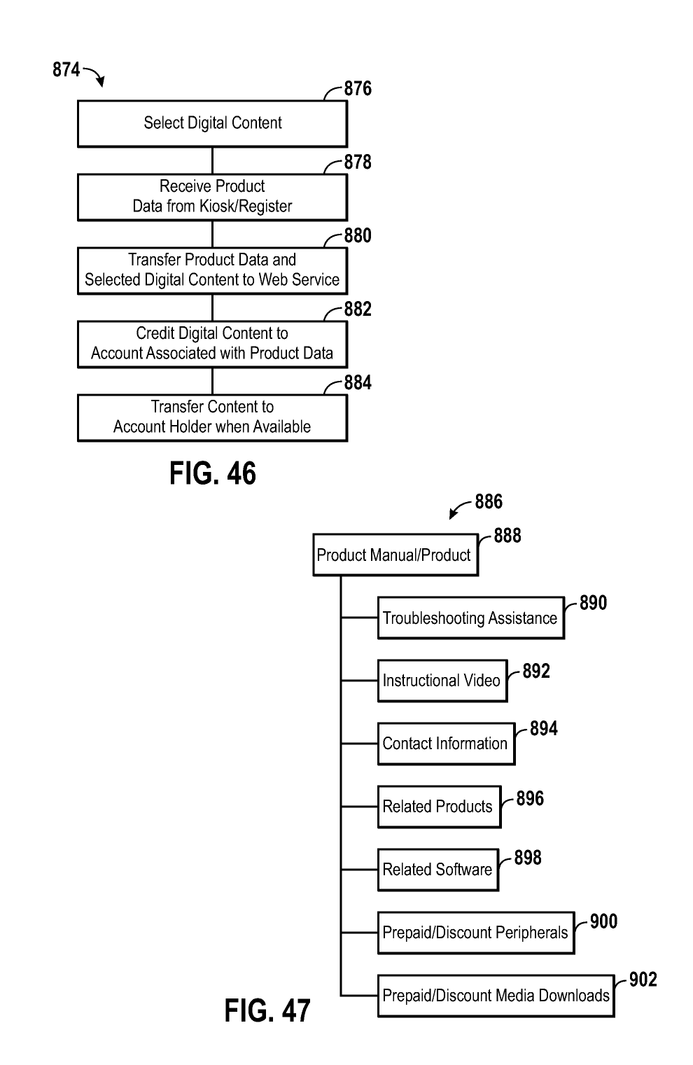

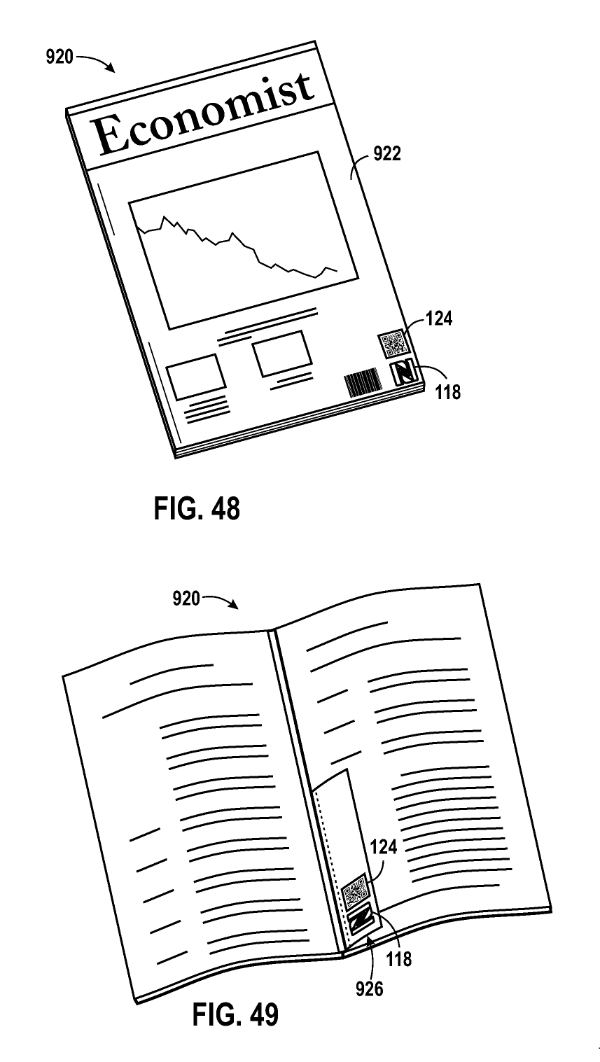

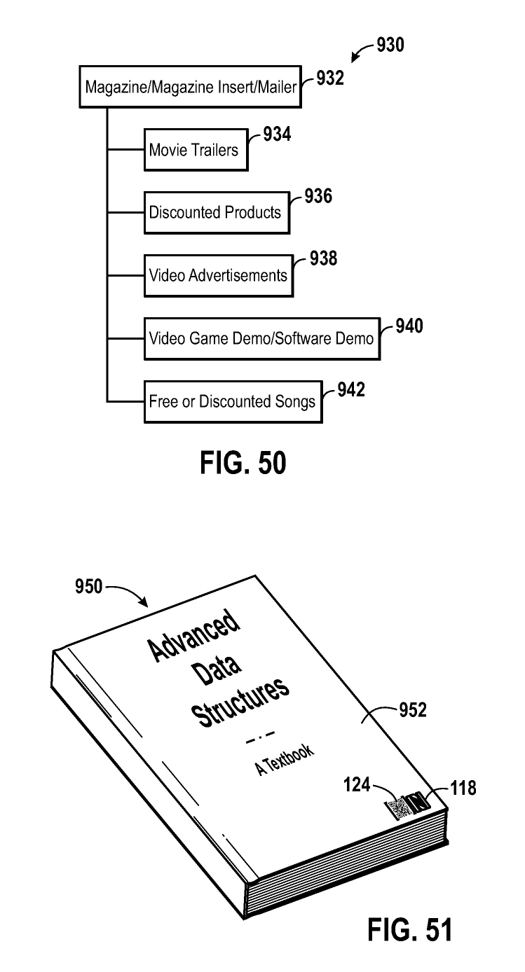

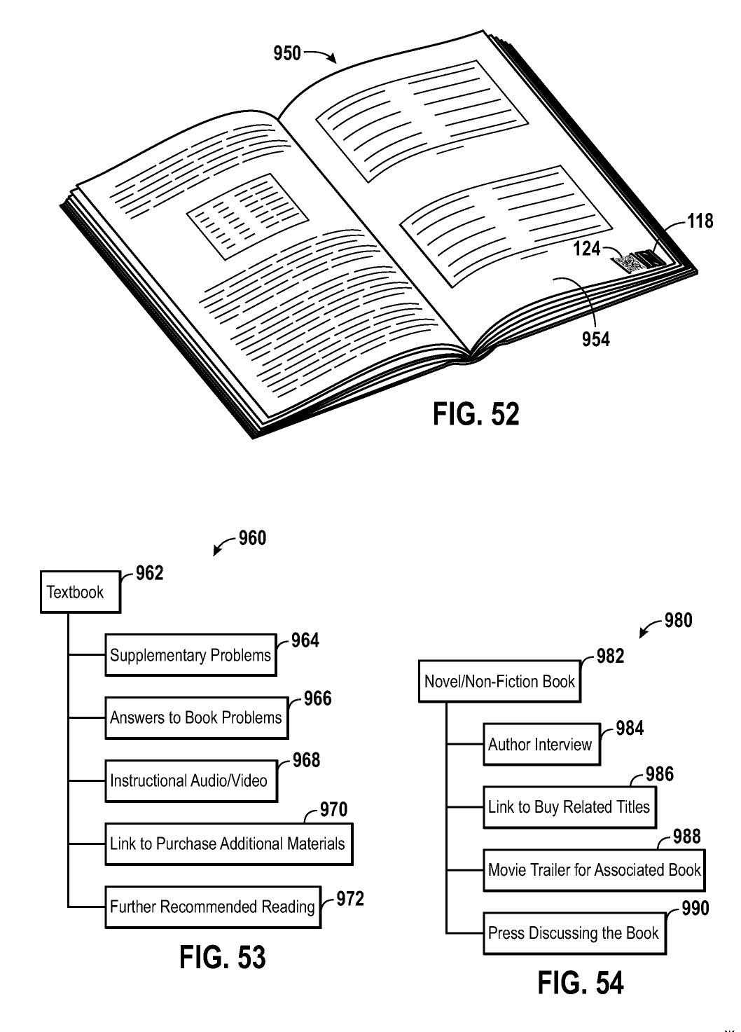

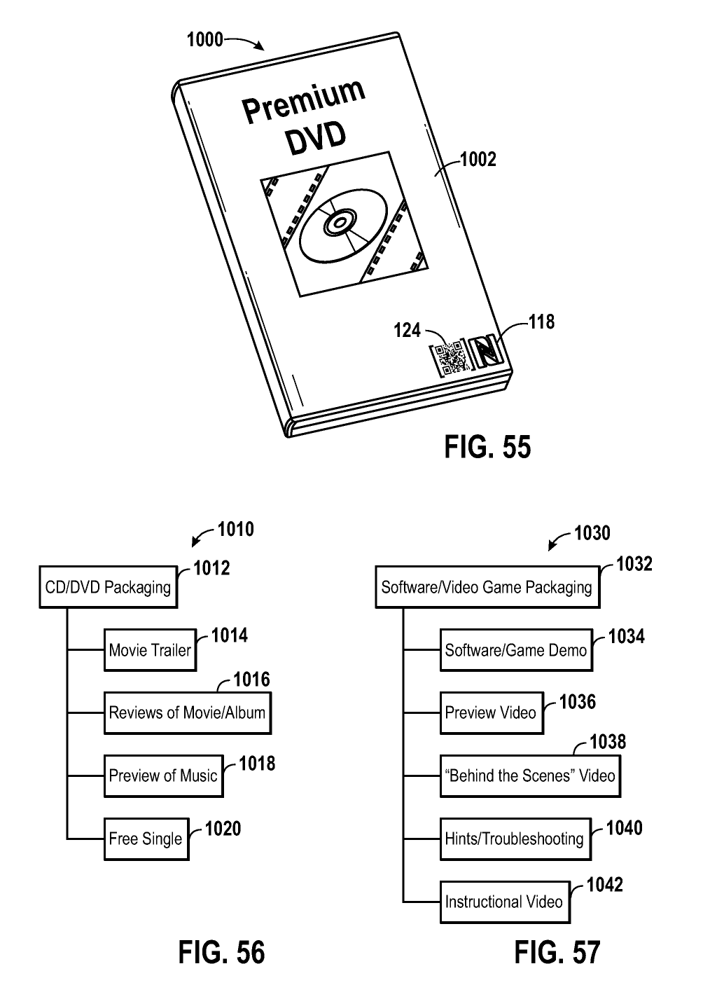

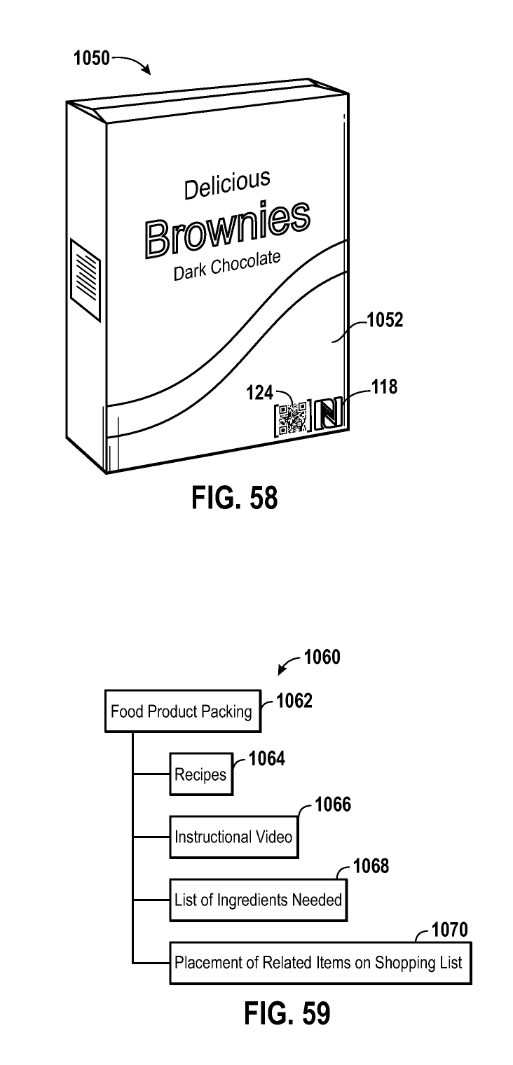

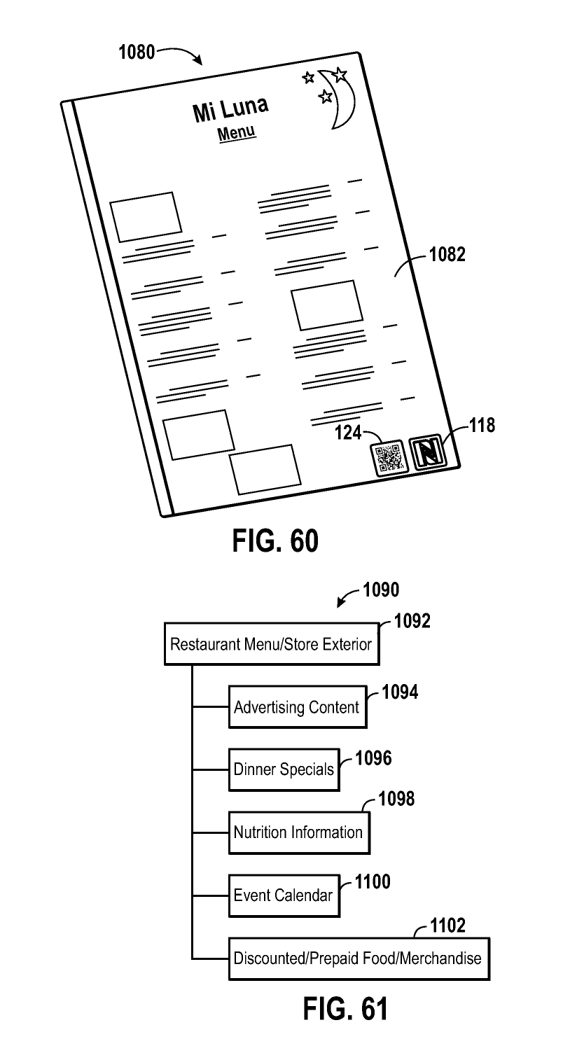

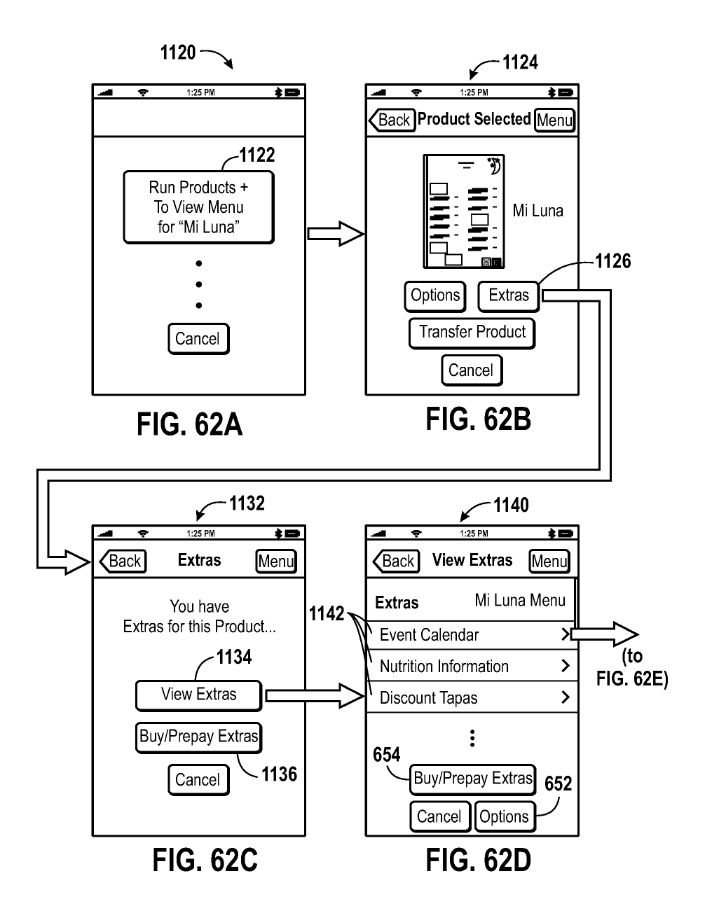

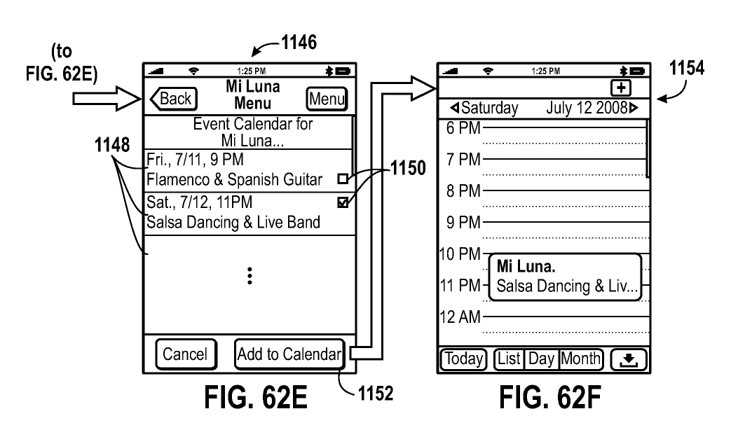

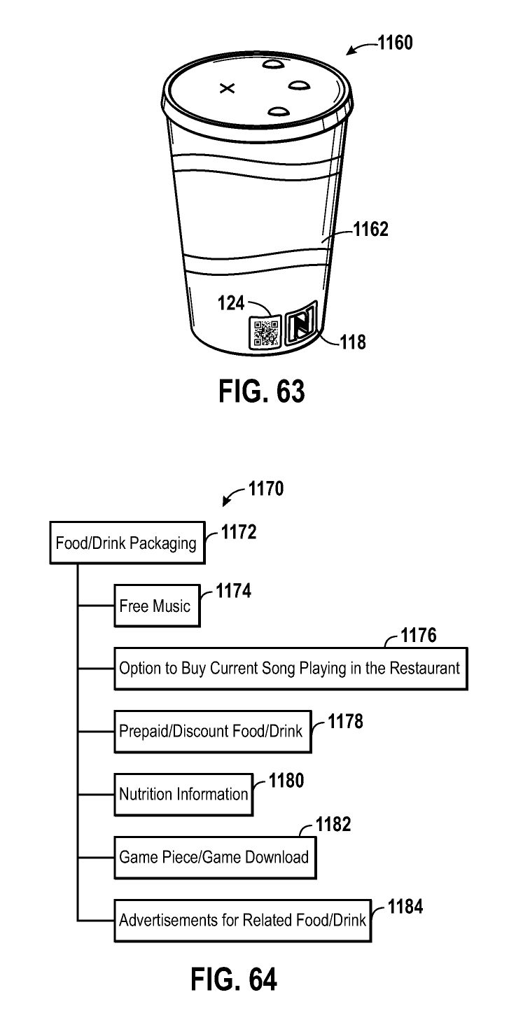

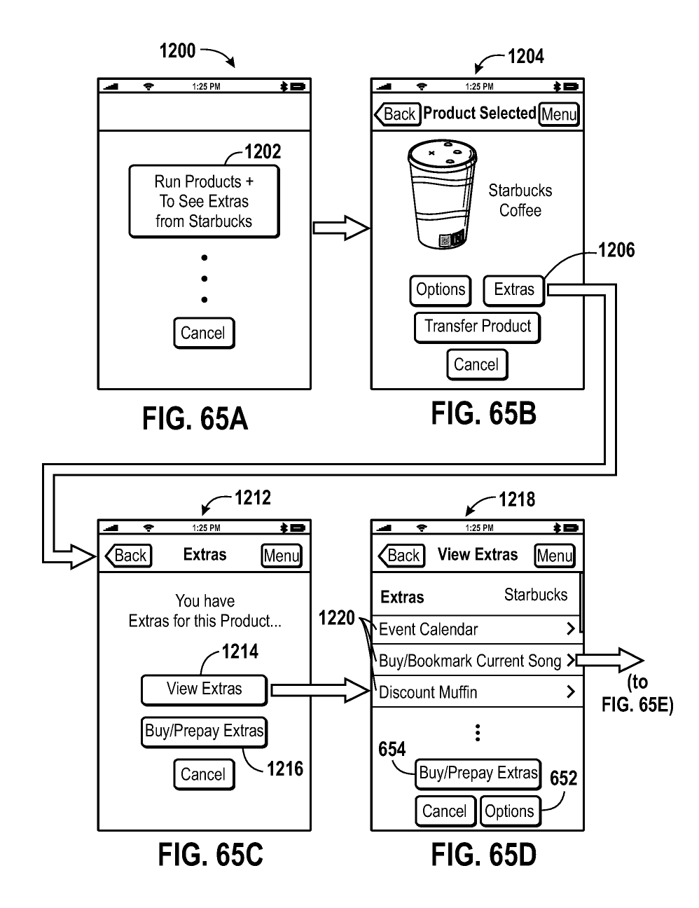

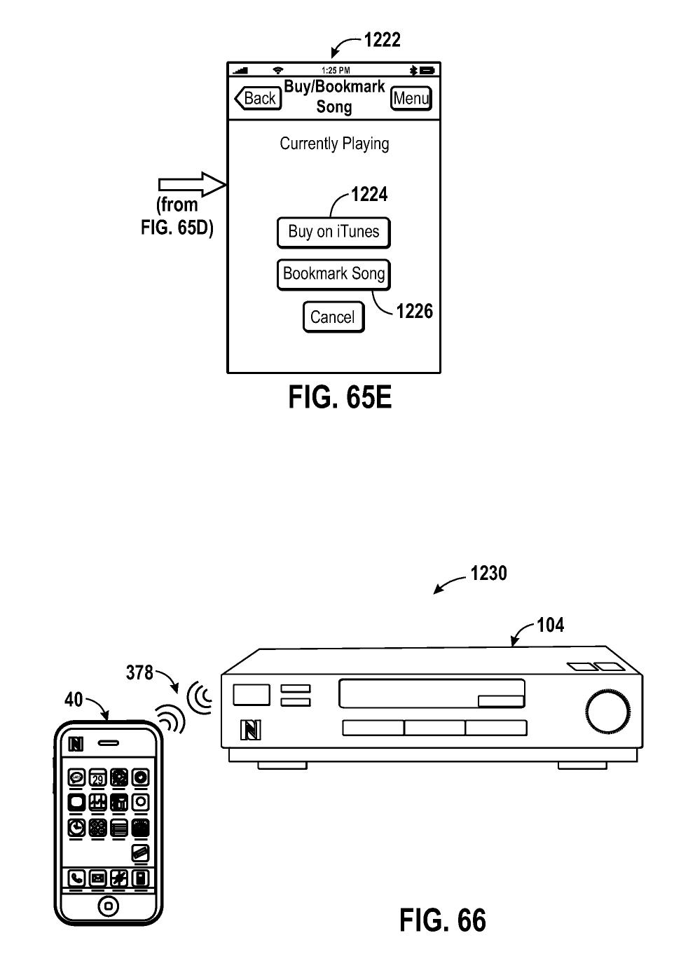

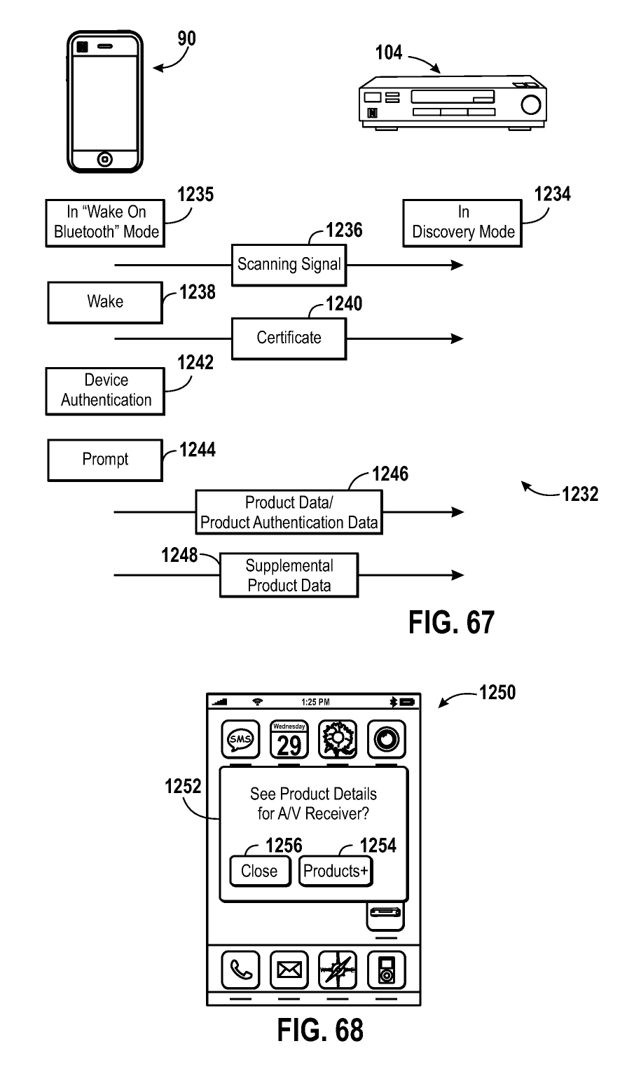

FIGS. 10 and 11 represent generally products or materials associated with products or services that may include the RFID tag 118 or the matrix barcode tag 124. Turning first to FIG. 10, the RFID tag 118 or the matrix barcode tag 124 may attach to a product, which may be, for example, the audio/video (A/V) receiver 104. Additionally or alternatively, the product may include an NFC interface 34, which may provide similar functionality to the RFID tag 118 in the manner described below with reference to FIGS. 24-28, and/or may include a PAN interface 28 or a LAN interface, which may provide functionality as described below with reference to FIGS. 66-68.

Similarly, turning next to FIG. 11, the RFID tag 118 or the matrix barcode tag 124 may attach to materials associated with a product or service, which may be, for example, a product manual 106 for the audio/video (NV) receiver 104. Because the RFID tag 118 or the matrix barcode tag 124 may be located directly on the product, a user who desires to obtain the benefits associated with the product may easily obtain a variety of benefits that may be associated with the product.

Many potential benefits that may be associated with various products or services are described in greater detail below, as are a variety of techniques that may be applied to obtain such benefits. In a brief example relating to FIG. 10 or 11, a person may purchase a product, such as the A/V receiver 104, which may involve a complicated installation. Despite the person's best efforts, the user may have difficulty installing the NV receiver 104. Rather than pore through the product manual 106 or search fruitlessly for information on the Internet for help with the installation, the person may simply tap a handheld device 40 to the RFID tag 118 on the A/V receiver 104 or the product manual 106. The handheld device 40 may thereafter display a helpful setup video, a troubleshooting information wizard, links to a website for further information for the NV receiver, and/or provide links to make online purchases of cables certified to work with the NV receiver. Techniques for carrying out the above scenario are described in greater detail below.

As noted above, the benefit system 102 described herein enables benefits associated with products or services to be obtained, stored, accessed, and/or used with an electronic device 10 such as the handheld device 40. In the disclosure that follows, FIGS. 12-46 below may generally describe techniques for obtaining and storing benefits associated with products or services, while FIGS. 47-67 may generally describe techniques for accessing and using such benefits. It should be appreciated that although the handheld device 40 may serve an exemplary role in illustrating certain techniques described below, the techniques should not be understood as limited to the handheld device 40; indeed, the techniques should be understood to encompass the use of any appropriately configured electronic device 10.

FIGS. 12A-F illustrate a manner of obtaining benefits associated with a product or service on an electronic device 10 such as the handheld device 40. Turning first to FIG. 12A, a home screen is depicted on the display 18 of the handheld device 40, as illustrated in FIG. 2 above. On the graphical user interface 20 of the handheld device 40, a product benefit management application icon 44 may be available for selection by a user. As noted above, the product benefit management application icon 44 is labeled “products +” to indicate that the product benefit management application icon 44 may represent an application for managing benefits associated with products and more. Upon selection of the product benefit management application icon 44, the product benefit management application may begin to run on the handheld device 40, as shown in FIG. 12B.

FIG. 12B represents a screen 158 that may be displayed when the product benefit management application begins to run on the handheld device 40. The opening screen 158 may include a title bar 160, which may assist with navigation through the application. The opening screen 158 may additionally include a number of user selectable buttons 162, 164, 165, and 166. The button 162 may be labeled “Product List,” and may provide access to a list of benefits associated with products or services; the button 164 may be labeled “Add Product,” and may enable a user to add benefits associated with a product or service, as described further below; the button 165 may be labeled “Quick Scan,” and may enable a user to quickly access benefits associated with a particular product or service by scanning an RFID tag 118 or matrix barcode 124; and the button 166 may be labeled “Cancel,” and may enable a user to exit the application, returning the user to the home screen depicted in FIG. 12A.

Turning to FIG. 12C, selection of the button 162 may cause the handheld device 40 to display a screen 168 with a title bar 170 labeled “Product List.” Navigation buttons 172 and 174 may enable a user to navigate back to the prior screen 158 or to a main menu of the application, respectively. User selectable buttons 176 and 178 may allow a user to cancer the current operation or to change various options and user preferences, as described in greater detail below. If any benefits associated with a product or service are stored on the handheld device 40, a list of such products or services may be displayed. However, as depicted in FIG. 12C, if no benefits associated with a product or service have been obtained and/or stored on the handheld device 40, the screen 168 may display a message noting that no such items are stored on the device. Additionally, the screen 168 may display a button 180, labeled “Add Product,” to prompt the user to add benefits associated with a product or service using the techniques described below.

Selecting the button 164 of the screen 158 of FIG. 12B or the button 180 of the screen 168 of FIG. 12C may navigate to a screen 182, as shown in FIG. 12D. The screen 182 may be entitled “Add Product,” and may enable a user to add benefits associated with a product or service into the handheld device 40 using a variety of techniques, as indicated by user selectable buttons 184-192. As depicted in FIG. 12D, the button 184 may be labeled “Scan Product,” the button 186 may be labeled “Search Email For Product,” the button 188 may be labeled “Scan Kiosk For Product,” the button 190 may be labeled “Buy Online,” and the button 192 may be labeled “Receive Transfer.”

It should be appreciated that although the “Back,” “Menu,” and “Cancel” buttons are not labeled with numerals in FIG. 12D or subsequent figures below, the buttons may function in the manners described above. As such, the “Back” button may navigate a user to a prior screen, the “Menu” button may navigate a user to the main screen 158 of the product benefit management application, and the “Cancel” button may cancel a pending transaction or return a user to a prior screen.

Turning to FIG. 12E, a screen 194 may be displayed on the handheld device 40 following the selection the button 184 of the screen 182 of FIG. 12D. As indicated by the screen 194, a product or materials associated with a product or service may be scanned in at least two different ways. Two user selectable buttons 196 and 198 may allow the user of an electronic device 10 to scan an RFID tag 118 or a matrix barcode tag 124 associated with a product or service using the NFC interface 34 or the camera 36, respectively. Techniques relating to scanning the RFID tag 118 using the NFC interface 34 may be described with reference to FIGS. 12F-15 below. Techniques relating to scanning the matrix barcode tag 124 using the camera 36 may be described with reference to FIGS. 16-21.

Selecting the button 196 may navigate the user to a screen 200 labeled “Scan with NFC,” as depicted in FIG. 12F. The screen 200 may instruct the user to tap the NFC interface 34 of the handheld device 40 to the RFID tag 118 using text and/or images.

FIG. 13 depicts a product-scanning operation 202 for obtaining electronic benefit information from an RFID tag 118 associated with a product or service via the NFC interface 34 of the handheld device 40. In the product-scanning operation 202 of FIG. 13, the RFID tag 118 is associated with a product by way of the product manual 106. By tapping the NFC interface 34 of the handheld device 40 to the RFID tag 118 of the product manual 106, electronic benefit information stored on the RFID tag 118 may be transferred to the handheld device 40 via an NFC communication channel 204. The NFC communication channel 204 may be an inductive electromagnetic communication channel that may result after the NFC interface 34 sends an electromagnetic pulse to the RFID tag 122. The RFID tag 122 may become energized and transmit certain data stored on the RFID tag 122 the NFC interface 34 of the handheld device 40.

Turning next to FIG. 14, a communication diagram 204 describes communication that may place during the product-scanning operation 202 of FIG. 13. At the start of the communication diagram 206, the NFC interface 34 of the handheld device 40 may be in a “host mode,” as indicated by block 210. The NFC interface 34 of the handheld device 40 may enter the “host mode” when the button 196 of the screen 194 of FIG. 12E is selected.

As shown by block 212 of the communication diagram 206 and illustrated in the product-scanning operation 202 of FIG. 13, a user may tap the NFC interface 34 of the handheld device 40 to the RFID tag 118. Because the NFC interface 34 of the handheld device 40 may be operating in the “host mode,” the NFC interface 34 may periodically emit an NFC ping, as illustrated by block 214. The NFC ping may energize the RFID tag 122 of the RFID tag 118, as noted by block 216. Subsequently, as shown by block 218, the RFID tag 122 of the RFID tag 118 may transfer certain stored product data to the handheld device 40.

The product data may be stored in the main memory 14 or the nonvolatile storage 16 of the handheld device 40. As noted above, the product data may include, for example, a unique identifying serial number representing a pointer to data located in an external database, or a data file, such as an XML file, describing the product or service to which the RFID tag 118 pertains. The product data may enable a range of benefits, as discussed below, such as discount coupons, digital content, etc., which may relate to the particular product or service. The product data may additionally include a hyperlink to the web service 208 or other identifying information for the handheld device 40 to locate the web service 208.

The handheld device 40 may transmit the product data via the Internet or another communication channel to a web service 208, as shown by block 222. The web service 208 may represent any online network capable of relating the product data with other information for carrying out the techniques disclosed herein. The handheld device 40 may discover the location of the web service 208 through a hyperlink embedded in the product data to the web service 208, with a predetermined web location associated with the product benefit management application that may run on the handheld device 40, or by contacting another web service that may point the handheld device 40 to the web service 208 based on information that may be stored in the product data. The web service 208 may have access to a database relating product data to certain other information, such as an account associated with the purchaser of the product or service (e.g., an iTunes® account), a device that may pertain to the purchaser, a location of the product, and/or benefits that may be associated with the product or service. With such capabilities, the web service 208 may authenticate benefits associated with the product or service for use with the handheld device 40, as shown in block 224.

The authentication procedure of block 224 may involve, for example, verifying that the purchaser of the product or service and the owner of the handheld device 40 are the same, if the benefits associated with the product or service have not been transferred to another owner. Alternatively, the authentication procedure of block 224 may involve verifying that benefits associated with the product or service are not stored on another electronic device 10 or that the benefits have not been previously used. Authentication may rely on a private key known to both the web service 208 and the handheld device 40, which may have been exchanged prior to communication or, additionally or alternatively, a combination of a public key and a private key. Under the latter scheme, the web service 208 and the handheld device 40 may each exchange public keys associated with one another prior to or during the authentication procedure of block 224, or may obtain public keys from another source. The web service 208 and the handheld device 40 may verify the public keys with a certificate authority over the Internet or via a web of trust. In certain variations, the web service 208 may represent the certificate authority. If there is any link broken in the chain of trust, the authentication procedure of block 224 may be terminated.

Following the authentication procedure of block 224, the web service 208 may respond to the handheld device 40 by transmitting product authentication data and/or supplemental product data, as illustrated by blocks 226 and 228, respectively. As described herein, the product authentication data of block 226 may represent a passcode or other data to permit a user to gain certain associated benefits. The supplemental product data of block 228 may represent data describing benefits that may be associated with the product or service, as well as providing additional information regarding the product or service. Included in the supplemental product data of block 228 may be one or more digital content credits, which may be used by the receiving handheld device 40 to obtain digital content benefits. Such benefits are described further below.

The benefits described in the supplemental product data of block 228 may be listed in a data file, such as an XML file, which may include each of the benefits as well as a local or online location where data associated with the benefits may be obtained. By way of example, the benefits may include free or discounted music downloads or discounted or prepaid related products. As such, the data file listing the benefits may also include a link to a page of an online music vendor, such as iTunes®, where music or videos may be obtained, or a link to an online coupon for discounted or prepaid merchandise. To supplement the listing of benefits, the supplemental product data of block 228 may also include certain other data, such as authentication data associated with the coupon or images associated with each benefit from the data file listing the benefits.

It should be appreciated that the supplemental product data of block 228 may additionally include information regarding the product or service to which the benefits pertain; such information may provide greater detail about the product or service than may be noted in the product data obtained from the RFID tag 118. For example, the supplemental product data may include a data file such as an XML file with details describing the product or service, etc.

Turning next to FIG. 15A, a prompt 230 may be displayed upon receipt and storage of the product data, as generally noted by the block 220 of the communication diagram 206 of FIG. 14. It should be appreciated that the handheld device 40 may or may not display the prompt 230 depending on user preferences. The prompt 230 of FIG. 15A may indicate that product data has been received by the handheld device 40, and a button 232, labeled “Authenticate,” may enable a user to authenticate the benefits associated with the product data. Selecting the button 232 may cause the communication of the communication diagram 206 to continue from the block 220.

The handheld device 40 may attempt to establish communication with the web service 208. If the Internet communication channel is not available, the user may be presented with a screen 234 of FIG. 15B, which may indicate that Internet access is unavailable. Such a situation may arise, for example, if the handheld device 40 lacks the WAN interface 32 and is outside the range of an accessible Wi-Fi network for Internet access. A button 236 labeled “Authenticate Later” on the screen 234 may permit the user to choose to authenticate the benefits at another time when Internet access is available.

If Internet access is available when the button 232 of the screen 230 of FIG. 15A is selected, or if Internet access later becomes available following the selection of the button 236 of the screen 234 of FIG. 15B, a screen 238 of FIG. 15C may be displayed. The screen 238 may be displayed while the communication illustrated by blocks 222-228 of the communication chart 206 takes place. To indicate that the benefits associated with the product or service are being authenticated, the screen 238 may include a status bar that may advance as the authentication data of block 226 and the supplemental product data of block 228 are received.

When the product authentication data and/or supplemental product data of blocks 226 and 228 have been received, a screen 240 may be displayed, as shown by FIG. 15D. The screen 240 may include an indication that the benefits associated with the product or service have been added to the handheld device 40, and a product image 242 may be displayed. It should be appreciated that the product image 242 may represent data received among the supplemental product data of block 228 of FIG. 14. A button 244 labeled “Product Details” may enable the user to view additional details about the product or service or about the benefits associated with the product or service, as described in greater detail below.

FIGS. 16 through 21 depict a technique for obtaining benefits associated with a product or service by scanning a matrix barcode tag 124 associated with the product or service. Turning first to FIG. 16A, the screen 194 may present the user with the button 198 labeled “Scan With Camera.”Selecting the user selectable button 198 may cause the handheld device 40 to display a screen 246, as illustrated in FIG. 16B.

The screen 246 may include a camera window 248 and a user selection prompt 250. The camera window 248 may present video images from the camera 36 of the handheld device 40. As noted in FIG. 16B, the user selection prompt 250 may instruct the user to align a matrix barcode tag 124, which may be located on a product such as the A/V receiver 104 or the product manual 106, within the camera screen 248 to acquire an image of the matrix barcode tag 124. Image boundaries 252 may indicate the portion of the camera window 248 that may be saved as an image; selecting a user selectable button 254 labeled “Acquire” may cause the image of the matrix barcode tag 124 currently within the image boundaries 252 to be acquired.

A screen 256, shown in FIG. 16C, may be displayed when the button 254 is selected. A still image 258 may represent the image acquired by the camera 36. Two buttons 260 and 262 may be labeled “Process Image” and “Re-Acquire,” respectively. The button 260 may allow a user to proceed with the still image 258, while the button 262 may allow the user to acquire another image of the matrix barcode tag 124 by returning to the screen 246 of FIG. 16B.

Turning next to FIG. 17, a communication diagram 264 illustrates communication that may take place during the product-scanning operation described by FIGS. 16A-C. As noted by the communication diagram 264, an initial data transfer may occur from the matrix barcode tag 124 to the handheld device 40 via the camera 36, and further communication may take place between the handheld device 40 and the one or more web services 208 via the Internet. At the outset of the communication diagram 264, the handheld device 40 may enter an “acquire image” mode, as indicated by block 266. The “acquire image” mode of the handheld device 40 may be represented by the screen 246 shown in FIG. 16B. As noted by block 268, the user may next align the matrix barcode tag 124 with the camera 36 to acquire an image.

As illustrated by block 270, the image 258 of the matrix barcode tag 124 may be acquired. The image 258 may be represented on the screen 256 of FIG. 16C. When the user selects the button 260 of the screen 256, the handheld device 40 may process the image 258 using optical character recognition, barcode-reading, or matrix-code-reading software to decode product data stored in the image. In block 274, the product data may be stored in the main memory 14 or the nonvolatile memory 16 of the handheld device 40. As noted above, the product data may include, for example, a unique identifying serial number representing a pointer to data located in an external database, or a data file, such as an XML file, describing the product or service to which the RFID tag 118 pertains. The product data may enable a range of benefits, as discussed below, such as discount coupons, digital content, etc., which may relate to the particular product or service. The product data may additionally include a hyperlink to the web service 208 or other identifying information for the handheld device 40 to locate the web service 208

After processing and storing the product data, but prior to authenticating the product data with the web service 208, the handheld device may display a prompt, as described below with reference to FIG. 18. Upon a selection by a user, the handheld device 40 may transmit the product data via the Internet or another communication channel to the web service 208, as shown by block 276. As noted above, the web service 208 may have access to a database relating product data to certain other information, such as an account associated with the purchaser (e.g., an iTunes® account), a device that may pertain to the purchaser, etc., as well as various benefits that may be associated with the product or service. With such capabilities, the web service 208 may authenticate the benefits, as shown in block 278.

The handheld device 40 may transmit the product data via the Internet or another communication channel to a web service 208, as shown by block 276. The web service 208 may represent any online network capable of relating the product data with other information for carrying out the techniques disclosed herein. The handheld device 40 may discover the location of the web service 208 through a hyperlink embedded in the product data to the web service 208, with a predetermined web location associated with the product benefit management application that may run on the handheld device 40, or by contacting another web service that may point the handheld device 40 to the web service 208 based on information that may be stored in the product data. The web service 208 may have access to a database relating product data to certain other information, such as an account associated with the purchaser of the product or service (e.g., an iTunes® account), a device which may pertain to the purchaser, a location of the product, and/or benefits that may be associated with the product or service. With such capabilities, the web service 208 may authenticate benefits associated with the product or service for use with the handheld device 40, as shown in block 278.

The authentication procedure of block 278 may involve, for example, verifying that the purchaser of the product or service and the owner of the handheld device 40 are the same, if the benefits associated with the product or service have not been transferred to another owner. Alternatively, the authentication procedure of block 278 may involve verifying that benefits associated with the product or service are not stored on another electronic device 10 or that the benefits have not been previously used. Authentication may rely on a private key known to both the web service 208 and the handheld device 40, which may have been exchanged prior to communication or, additionally or alternatively, a combination of a public key and a private key. Under the latter scheme, the web service 208 and the handheld device 40 may each exchange public keys associated with one another prior to or during the authentication procedure of block 278, or may obtain public keys from another source. The web service 208 and the handheld device 40 may verify the public keys with a certificate authority over the Internet or via a web of trust. In certain variations, the web service 208 may represent the certificate authority. If there is any link broken in the chain of trust, the authentication procedure of block 278 may be terminated.

Following the authentication procedure of block 278, the web service 208 may respond to the handheld device 40 by transmitting product authentication data and/or supplemental product data, as illustrated by blocks 280 and 282, respectively. As described herein, the product authentication data of block 280 may represent a passcode or other data to permit a user to gain certain associated benefits. The supplemental product data of block 282 may represent data describing benefits that may be associated with the product or service, as well as providing additional information regarding the product or service. Included in the supplemental product data of block 282 may be one or more digital content credits, which may be used by the receiving handheld device 40 to obtain digital content benefits. Such benefits are described further below.

The benefits described in the supplemental product data of block 282 may be listed in a data file, such as an XML file, which may include each of the benefits as well as a local or online location where data associated with the benefits may be obtained. By way of example, the benefits may include free or discounted music downloads or discounted or prepaid related products. As such, the data file listing the benefits may also include a link to a page of an online music vendor, such as iTunes®, where music or videos may be obtained, or a link to an online coupon for discounted or prepaid merchandise. To supplement the listing of benefits, the supplemental product data of block 282 may also include certain other data, such as authentication data associated with the coupon or images associated with each benefit from the data file listing the benefits.

It should be appreciated that the supplemental product data of block 282 may additionally include information regarding the product or service to which the benefits pertain; such information may provide greater detail about the product or service than may be noted in the product data obtained from the matrix barcode tag 124. For example, the supplemental product data may include a data file such as an XML file with details describing the product or service, etc.

It should further be appreciated that the communication represented by blocks 276-282 may take place while a series of authentication prompts or screens are displayed on the handheld device. Such screens may include those described above with reference to FIGS. 15A-D above.

As noted above, when the handheld device 40 has processed the image 258 for product data, as illustrated by block 272, and has stored the product data in the main memory 14 or nonvolatile storage 16, a screen 284 of FIG. 18 may be displayed. Because the OCR, barcode-reading, or matrix-code-reading software that may run on the handheld device could mistranscribe the product data, the screen 284 may list the extracted product data 286 acquired from the image 258. If the extracted product data 286 is correct, a user may choose to authenticate the product or service benefits by selecting a button 288, labeled “Authenticate.” If the button 288 is selected, the authentication procedure may take place in the manner described in the communication diagram 264 and the handheld device 40 may display the screens illustrated in FIGS. 15A-D.

If the extracted product data 286 is not correct, a user may choose to edit the product data manually by selecting a button 290, labeled “Edit Information.” If the product data 286 is correct, but authentication is not desired or necessary, a user may choose only to store the extracted product data 286 without initiating an authentication procedure by selecting a button 292, labeled “Store.”

FIGS. 19 and 20 illustrate a manner of obtaining benefits associated with a product or service received in an email message. Turning first to FIGS. 19A-B, benefits associated with a product or service may be obtained directly from a hyperlink embedded in an e-mail message. As illustrated in FIG. 19A, an e-mail message 294 may be displayed in an e-mail client on the handheld device 40. As such, the e-mail client may include buttons 296 and 298 to navigate to the inbox and to other messages, respectively, as well as a button 300 to exit the message. A refresh button 302 may cause the handheld device 40 to check for new messages.

The e-mail message 294 may be received from, for example, an online product vendor, such as iTunes®. As indicated by numeral 304, the name of the vendor may be noted in the “From” line of the e-mail message as indicated by numeral 304. A subject line 306 of the e-mail message may indicate that the message includes benefits associated with a recently purchased product, such as a Rolling Stones album. A body 308 of the e-mail message may include text 310 representing product data for use by the handheld device 40. It should be appreciated that the product data may also be transmitted in the form of an attached file, such as an image file or an XML file. Moreover, the product data transmitted in the e-mail message may or may not include authenticated product data. A hyperlink 312 may launch the product benefit management application and automatically add the product data onto the handheld device 40.

Turning next to FIG. 19B, a screen 314 may be displayed upon selection of the hyperlink 312. The screen 314 may prompt the user to choose whether to automatically add the product data from the e-mail message 294 onto the handheld device 40. Buttons 316, 318, and 320 may be labeled “Authenticate,” “Edit Information,” and “Store,” respectively. If the text 310 correctly reflects the product data, the button 316 may enable a user to authenticate the product data. The authentication procedure begun by selecting the button 316 may mirror the communication represented by the blocks 276-282 of the communication diagram 206 of FIG. 14, during which the handheld device 40 may also display the screens illustrated in FIGS. 15A-D. If the information is not correct, the user may choose to edit the information by selecting the button 318. To store the product data without authentication, the user may select the button 320.

FIGS. 20A-D illustrate an alternative manner of obtaining benefits associated with a product or service received in an e-mail message. Turning first to FIG. 20A, selecting the button 186 from the screen 182 may initiate a search for benefits associated with a product or service through the e-mail client. As shown in FIG. 20B, the initiation of the search may cause the handheld device 40 to display a screen 322. The screen 322 may indicate that the handheld device 40 is searching through an e-mail database stored in the nonvolatile storage 16 or the main memory 14 of the handheld device 40.

A subsequent screen 324, illustrated in FIG. 20C, may be displayed if no benefits are found in the e-mail database located on the handheld device 40. A button 324 may allow the user to input electronic benefit information manually. Alternatively, a screen 328, illustrated in FIG. 20D, may be displayed if benefits associated with a product or service is found in the e-mail database on the handheld device 40. The screen 328 may prompt the user to choose whether to automatically add the benefits associated with the product or service, indicated generally as text 330, found in from the e-mail database onto the handheld device 40. Buttons 332, 334, and 336 may be labeled “Authenticate,” “Edit Information,” and “Store,” respectively. If the text 330 correctly reflects the product data, the button 316 may enable a user to authenticate the product data. The authentication procedure begun by selecting the button 332 may mirror the communication represented by the blocks 276-282 of the communication diagram 206 of FIG. 14, during which the handheld device 40 may also display the screens illustrated in FIGS. 15A-D. If the information is not correct, the user may choose to edit the information by selecting the button 334. To store the product data without authentication, the user may select the button 336. A hyperlink 338 may enable a user to view the message in which the product data was obtained.

FIGS. 21-33 illustrate a manner of obtaining benefits associated with a product or service from a kiosk, such as the kiosk 74 or the unmanned kiosk 88. Turning first to FIG. 21A, selecting the button 188 labeled “Scan Kiosk For Product” may cause the handheld device 40 to display a screen 340, as illustrated in FIG. 21B. The screen 340 may present a user with a variety of options for obtaining benefits associated with a product or service from the kiosk 74 or the unmanned kiosk 88. By way of example, a user may obtain benefits associated with a product or service by scanning the kiosk using NFC, as illustrated by a button 342 labeled “Scan Kiosk With NFC;” the user may scan the kiosk using the camera 36, as illustrated by a button 344 labeled “Scan Kiosk With Camera;” or the user may obtain a benefit wirelessly as indicated by a button 346 labeled “Find Kiosk Wirelessly.” Each technique is discussed in greater detail below.

FIGS. 21C-29B relate to techniques for obtaining benefits associated with a product or service via the kiosk 74 or unmanned kiosk 88 involving NFC communication. Turning first to FIG. 21C, a screen 348 may be displayed when the button 342 is selected. The screen 348 may instruct the user, “Tap Kiosk to Add Product . . . ,” which may enable the handheld device 40 to obtain product data from the kiosk 74 or the unmanned kiosk 88 via an NFC communication channel.

FIG. 22 represents a kiosk-scanning operation 350. Though the kiosk-scanning operation 350 of FIG. 22 illustratively depicts the kiosk 74 and the handheld device 40, it should be understood that any NFC-enabled kiosk, including the unmanned kiosk 88, and any electronic device 10 may be employed. To perform the kiosk-scanning operation 350, the NFC interface 34 of the handheld device 40 may be tapped against the NFC interface 34 of the kiosk 74 after the button 342 of the screen 340 has been selected. When the handheld device 40 is tapped to the NFC interface 34 of the kiosk 74, the NFC communication channel 204 may be established and certain communication may be exchanged, as described in greater detail below.

Turning to FIG. 23, a communication diagram 352 may illustrate an embodiment of communication that may take place between the handheld device 40 and the kiosk 74. Though the communication diagram 352 of FIG. 23 illustratively depicts communication between the kiosk 74 and the handheld device 40, it should be understood that the communication diagram 352 may apply to communication between any NFC-enabled kiosk and another electronic device 10. The communication diagram 352 may begin when the NFC interface 34 of the handheld device 40 is placed in a “host mode,” as indicated by block 354. The NFC interface 34 of the handheld device 40 may enter the “host mode” when the button 342 of the screen 340 of FIG. 21B is selected by the user.

An NFC handshake 356 may next take place between the handheld device 40 and the kiosk 74 over the NFC communication channel 204. To begin the NFC handshake 356, a user may tap the NFC interfaces 34 of the handheld device 40 and the kiosk 74, as indicated by the block 358. Because the handheld device 40 may be operating in the “host mode,” as discussed above, the handheld device 40 may emit periodic NFC pings. One of the NFC pings may be transmitted to the kiosk 74, as indicated by block 360. After receiving the NFC ping of the block 360, the kiosk 74 may reply with an NFC acknowledgement packet, as indicated by block 362 labeled “ACK.”

With NFC communication established between the devices, the handheld device 40 and the kiosk 74 may exchange device profiles, as shown by the block 364. The device profiles may include a variety of information regarding the capabilities of the handheld device 40 and the kiosk 74. For example, the device profiles may include messages of any form, including extensible markup language (XML), which may denote the device name, serial number, owner name, type of device, as well as other identifying information. The other identifying information may include, for example, a hash of the user's account for a web service, such as iTunes®, or a public or private encryption key. The device profiles may additionally denote capabilities of the handheld device 40 or the kiosk 74 by indicating which applications, drivers, or services may be installed on each device.

Subsequently, the handheld device 40 and the kiosk 74 may authenticate one another based at least in part on the information from the device profiles. The authentication procedures of blocks 366 and 368 of FIG. 23 may involve, for example, verifying that the purchaser and the owner of the handheld device 40 are the same. Authentication may rely on a private key known to both the kiosk 74 and the handheld device 40, which may have been exchanged prior to communication or, additionally or alternatively, a combination of a public key and a private key. Under the latter scheme, the kiosk 74 and the handheld device 40 may each exchange public keys associated with one another prior to or during the authentication procedure of blocks 366 and 368, or may obtain public keys from another source. The kiosk 74 and the handheld device 40 may verify the public keys with a certificate authority over the Internet or via a web of trust. In certain variations, the web service 208 may represent the certificate authority. If there is any link broken in the chain of trust, the authentication procedure of blocks 366 and 368 may be terminated.

Following the device authentication procedure of blocks 366 and 368, the kiosk 74 may transmit unauthenticated product data and/or product authentication data and/or supplemental product data to the handheld device 40, as illustrated by blocks 370 and 372, respectively. As noted above, the product data may include, for example, a unique identifying serial number representing a pointer to data located in an external database, or a data file, such as an XML file, describing the product or service. The product data may enable a range of benefits, as discussed below, such as discount coupons, digital content, etc., which may relate to the particular product or service. The product data may additionally include a hyperlink to the web service 208 or other identifying information for the handheld device 40 to locate the web service 208.

As described herein, the product authentication data of block 370 may represent a passcode or other data to permit a user to gain certain associated benefits. The supplemental product data of block 372 may represent data describing benefits that may be associated with the product or service, as well as providing additional information regarding the product or service. Included in the supplemental product data of block 228 may be one or more digital content credits, which may be used by the receiving handheld device 40 to obtain digital content benefits. Such benefits are described further below.

The benefits described in the supplemental product data of block 372 may be listed in a data file, such as an XML file, which may include each of the benefits as well as a local or online location where data associated with the benefits may be obtained. By way of example, the benefits may include free or discounted music downloads or discounted or prepaid related products. As such, the data file listing the benefits may also include a link to a page of an online music vendor, such as iTunes®, where music or videos may be obtained, or a link to an online coupon for discounted or prepaid merchandise. To supplement the listing of benefits, the supplemental product data of block 372 may also include certain other data, such as authentication data associated with the coupon or images associated with each benefit from the data file listing the benefits.

It should be appreciated that the supplemental product data of block 372 may additionally include information regarding the product or service to which the benefits pertain; such information may provide greater detail about the product or service than may be noted in the product data obtained from the kiosk. For example, the supplemental product data may include a data file such as an XML file with details describing the product or service, etc.

When the handheld device 40 receives the product data and/or authenticated product data of the block 370 and the supplemental product data of the block 372, the handheld device 40 may display a prompt 374. A screen representing the prompt 374 may be described below with reference to FIG. 26. It should further be appreciated that the handheld device 40 may additionally authenticate the product data received in the block 370. Such authentication may take place in the manner described above with reference to the blocks 276-282 of FIG. 14.

In certain instances, information may be communicated between the handheld device 40 and the kiosk 74 over a communication channel other than the NFC communication channel 204. In such cases, a variety of communication channels may become available, as illustrated by FIG. 24.

FIG. 24 is a schematic view of potential communication channels 376 over which communication between the kiosk 74 and the handheld device 40. It should be appreciated that while the communication channels 376 of FIG. 24 illustratively interconnect the kiosk 74 and the handheld device 40, the communication channels 376 may be formed between any two electronic devices 10. Each communication channel 376 shared between the kiosk 74 and the handheld device 40 may be used for any data transfer that may take place between the handheld device 40 and the kiosk 74.

Discussing each of the communication channels 376 in turn, the NFC communication channel 204 may be employed for data transfer between the handheld device 40 and the kiosk 74. The NFC communication channel 204 may arise if both the kiosk 74 and the handheld device 40 have NFC interfaces 34 that are placed in close proximity, such as may occur when the devices are tapped together. It should be appreciated that the NFC communication channel 204 may generally remain open for a relatively short period of time and may operate at a lower bandwidth. As such, the NFC communication channel 204 may generally accommodate a relatively small amount of initial data transfer; a follow-up data transfer may generally take place via another of the communication channels 376 described below.

As noted above, the kiosk 74 and the handheld device 40 may additionally be connected through any of the communication channels 376 other than the NFC channel 162. Particularly, if either device lacks the NFC interface 34, data transfer instead may take place over the other of the communication channels 376, as described below with reference to FIGS. 36A-G. As noted below, such a data transfer may begin when a user initiates a transfer using the product benefit management application on the handheld device 40. In some embodiments, although the kiosk 74 and the handheld device 40 may both include the NFC interface 34, a user may elect to have the data transfer take place over another one of the communication channels 376.

Among the possible communication channels 376 other than the NFC communication channel 204 is a personal area network (PAN) communication channel 378, connected through the PAN interfaces 28 of each device. By way of example, the PAN communication channel 378 may represent a peer-to-peer Bluetooth® connection, an IEEE 802.15.4 (e.g., ZigBee) network, or an ultra wideband network (UWB) between the kiosk 74 and the handheld device 40.

The kiosk 74 and the handheld device 40 may additionally or alternatively be connected via a local area network (LAN) communication channel 380. The respective LAN interfaces 30 of the kiosk 74 and the handheld device 40 may share a peer-to-peer connection directly to one another via the LAN communication channel 380, or may connect to one another via a router or a network controller along the LAN communication channel 380. The LAN communication channel 380 may represent a wired connection, such as an Ethernet connection, but may also represent a wireless connection, such as an IEEE standard 802.11.x wireless network, or Wi-Fi.

It should be appreciated that the kiosk 74 and the handheld device 40 may establish the PAN communication channel 378 or the LAN communication channel 380 using a device identification networking protocol. By way of example, the device identification networking protocol may be Bonjour® by Apple Inc. Each of the kiosk 74 and the handheld device 40 may broadcast using internet protocol (IP) their identifications and services, programs, and/or communication capabilities that each device may have. The kiosk 74 or the handheld device 40 may receive information via the device identification networking protocol so as to open peer-to-peer connections via the PAN communication channel 378 or the LAN communication channel 380. As should be appreciated, more than one electronic device 10 may be broadcasting information using the device identification networking protocol. As such, the handheld device 40 may select based on preferences with which electronic device 10 to connect.

While the kiosk 74 or the handheld device 40 may be connected via the PAN communication channel 378 or the LAN communication channel 380, the devices may also be connected by way of the Internet 382. By connecting to one another via the Internet 382, the kiosk 74 and the handheld device 40 may remain physically remote from one another while the data transfer occurs. Connecting via the Internet 382 may also allow the kiosk 74 and the handheld device 40 to retain communicative capabilities if a local peer-to-peer connection over the communication channel 378 or 380 is disrupted or lost.

To locate one another over the Internet 382, the kiosk 74 or the handheld device 40 may first query the web service 208 to obtain an Internet protocol (IP) address of the other. The web service 208 may represent a dynamic domain name system (DNS) service, which may maintain the current IP address of each device by communicating with a plugin associated with the simplified data transfer application residing on each device. By way of example, the web service 208 may be a function of the Back to My Mac® service from Apple, Inc.

With further reference to FIG. 24, the kiosk 74 may reach the Internet 382 via its LAN interface 30 or via a wide-area network (WAN) communication channel 384, which may represent, for example, a cellular data network such as EDGE or a 3G network. Similarly, the handheld device 40 may connect to the Internet 382 via its LAN interface 30 or its WAN interface 32. If the handheld device 40 connects to the Internet via the WAN interface 32, it may do so via a wide area network (WAN) communication channel 386, which may also represent, for example, a cellular data network such as EDGE or a 3G network.

It should be appreciated that the kiosk 74 and the handheld device 40 may also establish a connection directly to the web service 168 directly via the respective WAN interfaces 32 of the devices. The kiosk 74 may connect to the web service 208 via a wide area network (WAN) communication channel 388, which may represent, for example, a cellular data network such as EDGE or a 3G network. Similarly, the handheld device 40 may connect to the web service 208 via a wide area network (WAN) communication channel 390, which may also represent, for example, a cellular data network such as EDGE or a 3G network.

The kiosk 74 and the handheld device 40 may also be connected to one another via a wired input/output (I/O) communication channel 180. The wired I/O communication channel 180 may generally permit an exceptionally rapid transfer of data between the kiosk 74 and the handheld device 40. As discussed below, any of the potential communication channels 376 may provide a manner of communicating during an initial data transfer or a subsequent data transfer involving obtaining benefits associated with a product or service.

An alternative manner of obtaining benefits associated with a product or service to the handheld device 40 from the kiosk 74 may be illustrated by FIGS. 25A-B, which represent a communication diagram 394 describing communication between the handheld device 40 and the kiosk 74 during a transfer of product data. Turning first to FIG. 25A, the communication diagram 394 may begin when the NFC interface 34 of the handheld device 40 is placed in a “host mode,” as indicated by block 396. The NFC interface 34 of the handheld device 40 may enter the “host mode” when the button 342 of the screen 340 of FIG. 21B is selected by the user.

An NFC handshake 398 may next take place between the handheld device 40 and the kiosk 74 over the NFC communication channel 204. To begin the NFC handshake 398, the user may tap the NFC interfaces 34 of the handheld device 40 and the kiosk 74, as indicated by the block 400. Because the handheld device 40 may be operating in the “host mode,” as discussed above, the handheld device 40 may emit periodic NFC pings. One of the NFC pings may be transmitted to the kiosk 74, as indicated by block 402. After receiving the NFC ping of the block 402, the kiosk 74 may reply with an NFC acknowledgement packet, as indicated by block 404 labeled “ACK.”

With NFC communication established between the devices, the handheld device 40 and the kiosk 74 may exchange device profiles, as shown by the block 406. The device profiles may include a variety of information regarding the capabilities of the handheld device 40 and the kiosk 74. For example, the device profiles may include messages of any form, including extensible markup language (XML), which may denote the device name, serial number, owner name, type of device, as well as other identifying information. The other identifying information may include, for example, a hash of the user's account for a web service, such as iTunes®, or a public or private encryption key. The device profiles may additionally denote capabilities of the handheld device 40 or the kiosk 74 by indicating which applications, drivers, or services may be installed on each device.

Subsequently, the handheld device 40 and the kiosk 74 may authenticate one another based at least in part on the information from the device profiles. The authentication procedures of blocks 408 and 410 of FIG. 25A may involve, for example, verifying that the purchaser of the product or service and the owner of the handheld device 40 are the same. Authentication may rely on a private key known to both the kiosk 74 and the handheld device 40, which may have been exchanged prior to communication or, additionally or alternatively, a combination of a public key and a private key. Under the latter scheme, the kiosk 74 and the handheld device 40 may each exchange public keys associated with one another prior to or during the authentication procedure of blocks 408 and 410, or may obtain public keys from another source. The kiosk 74 and the handheld device 40 may verify the public keys with a certificate authority over the Internet or via a web of trust. In certain variations, the web service 208 may represent the certificate authority. If there is any link broken in the chain of trust, the authentication procedure of blocks 408 and 410 may be terminated.

Following device authentication, the handheld device 40 and the kiosk 74 may scan for available network communication channels 376 for the other to join for further communication, as indicated by blocks 412 and 414. After scanning for the available network communication channels 376, the handheld device 40 and the kiosk 74 may exchange network configuration information, as shown by block 416. The network configuration information of block 416 may include, for example, XML messages denoting lists of network communication channels 376 accessible via the kiosk 74 or the handheld device 40. Among other things, the network configuration information of block 416 may include known authorization keys and service set identifier (SSID). By way of example, the network configuration information may include PAN interface 28 configuration information, such as a Bluetooth serial number, MAC address, and an associated password, as well as LAN interface 30 configuration information, such as a WiFi IP address, a WiFi MAC address, and a WiFi SSID. The network configuration information may be stored for use at a later time to permit the handheld device 40 and the kiosk 74 to ascertain a higher bandwidth connection.

Turning next to FIG. 25B, the handheld device 40 and the kiosk 74 may next initiate a subsequent data transfer via another network communication channel 376 other than the NFC communication channel 204. Over the newly established network communication channel 376, the kiosk 74 may transfer, as appropriate, product data or product authentication data, as shown in block 418, or supplemental product data, as shown by block 420. As described above, included in the supplemental product data of block 420 may be one or more digital content credits, which may be used by the receiving handheld device 40 to obtain digital content benefits. Such benefits are described further below. Upon receipt, the handheld device 40 may display a prompt as indicated in block 422. The prompt of block 422, like the prompt of block 374 of FIG. 23, may be represented by a screen illustrated by FIG. 26.

FIG. 26 depicts a screen 424, which may represent a prompt displayed upon receipt of certain product data, as shown by block 374 of FIG. 23 and block 422 of FIG. 25B. The screen 424 may indicate to the user that an authenticated benefit has been received from the kiosk 74. The screen 424 may additionally display information related to the received benefit, and may provide the button 244 for additional event details.

FIG. 27 illustrates a kiosk-scanning operation 426 for obtaining benefits associated with a product or service from the kiosk 74 onto the handheld device 40. It should be appreciated that in the kiosk-scanning operation 426, the product benefit management application may not have been activated, and the button 342 of the screen 340 of FIG. 21B may not have been selected by the user. As such, the handheld device may not be in a “host mode” and may display the home screen. When the NFC interface 34 of the handheld device 40 is tapped to the NFC interface 34 of the kiosk 74, the kiosk 74 may initiate communication with the handheld device 40, described below.

Turning to FIG. 28, a communication diagram 428 may illustrate communication that may take place during the kiosk-scanning operation 426 of FIG. 27. As indicated by the communication diagram 428, the NFC interface 34 of the handheld device 40 may initially remain in a “wake on NFC” mode as indicated by block 430. The “wake on NFC” mode may be the default mode for the NFC interface 34. By contrast, the NFC interface 34 of the kiosk 74 may operate in a “host mode,” as indicated by block 432.

Communication between the handheld device 40 and the kiosk 74 may become established in an NFC handshake 434. To begin the NFC handshake 434, the user may tap the NFC interfaces 34 of the handheld device 40 and the kiosk 74, as indicated by the block 436. Because the kiosk 74, rather than the handheld device 40, may be operating in the “host mode,” the kiosk 74 may emit periodic NFC pings. One of the NFC pings may be transmitted from the kiosk 74 to the handheld device, as indicated by block 438. Receiving the NFC ping may cause the NFC interface 34 of the handheld device 40 to awaken, as noted by block 440, and the handheld device 40 may reply with an NFC acknowledgement packet, as noted by block 442, labeled “ACK.”

With NFC communication established between the devices, the handheld device 40 and the kiosk 74 may exchange device profiles, as shown by block 444. As noted above, the device profiles may include a variety of information regarding the capabilities of the handheld device 40 and the kiosk 74. For example, the device profiles may include messages of any form, including extensible markup language (XML), which may denote the device name, serial number, owner name, type of device, as well as other identifying information. The other identifying information may include, for example, a hash of the user's account for a web service, such as iTunes®, or a public or private encryption key. The device profiles may additionally denote capabilities of the handheld device 40 or the kiosk 74 by indicating which applications, drivers, or services may be installed on each device.

Subsequently, the handheld device 40 and the kiosk 74 may authenticate one another based at least in part on the information from the device profiles. The authentication procedures of blocks 446 and 448 of FIG. 28 may involve, for example, verifying that the purchaser and the owner of the handheld device 40 are the same. Authentication may rely on a private key known to both the kiosk 74 and the handheld device 40, which may have been exchanged prior to communication or, additionally or alternatively, a combination of a public key and a private key. Under the latter scheme, the kiosk 74 and the handheld device 40 may each exchange public keys associated with one another prior to or during the authentication procedure of blocks 446 and 448, or may obtain public keys from another source. The kiosk 74 and the handheld device 40 may verify the public keys with a certificate authority over the Internet or via a web of trust. In certain variations, the web service 208 may represent the certificate authority. If there is any link broken in the chain of trust, the authentication procedure of blocks 446 and 448 may be terminated.

Following the device authentication procedure of blocks 446 and 448, the kiosk 74 may transmit unauthenticated product data and/or product authentication data as well as supplemental product data to the handheld device 40, as illustrated by blocks 450 and 452, respectively. As described above, included in the supplemental product data of block 452 may be one or more digital content credits, which may be used by the receiving handheld device 40 to obtain digital content benefits. Such benefits are described further below. When the handheld device 40 receives the data from the kiosk 74, the handheld device 40 may display a prompt, as noted by block 454, which may be represented by screens depicted in FIGS. 32A-B. It should further be appreciated that although the communication diagram 428 of FIG. 28 depicts the product data and/or authenticated product data of block 450 and the supplemental product data of block 452 as transferred via the NFC communication channel 204, other communication channels 376 may alternatively be used. For example, the handheld device 40 and the kiosk 74 may instead communicate network configuration information and establish another network communication channel 376 before transferring the data, as illustrated in the communication diagram 394 of FIGS. 25A-B.

FIGS. 29A-B illustrate screens that may represent the prompt of block 454 of FIG. 28. Turning first to FIG. 29A, the handheld device 40 may display a screen 456 following the kiosk-scanning operation 426 of FIG. 27, as generally illustrated in the communication diagram 428 of FIG. 28 as the prompt of block 454. The screen 456 may indicate to the user that the kiosk 74 has been detected and may provide a number of options to the user in the form of a button 458 labeled “Open Products +,” among others. The button 458 may enable a user to automatically open the product benefit management application and add a product or service to the list of stored product or service benefits from the kiosk 74. Selecting the button 458 may cause the handheld device 40 to display a screen 460, shown in FIG. 29B, after launching the product benefit management application.

The screen 460 of FIG. 29B may indicate to the user that product data has been received from the kiosk 74. Such information may represent the data received during the communication of blocks 450 and 452, above. Additionally, the screen 460 may include the button 244 labeled “Product Details,” which may enable the user to review details associated with the product or service for which benefits may be stored.

FIGS. 30-32 may represent a manner of obtaining benefits associated with a product or service from a kiosk having a display 18 visible to the customer, such as the unmanned kiosk 88. A user may purchase or otherwise select benefits associated with a product or service from the unmanned kiosk 88, which may display text, a barcode, or a matrix code for the handheld device 40 to scan using the camera 36. Turning first to FIG. 30A, the screen 340 may present the user with the button 344 labeled “Scan Kiosk With Camera.” Selecting the button 344 may cause the handheld device 40 to display a screen 462, as illustrated in FIG. 30B.

The screen 462 of FIG. 30B may include a camera window 464 and a user selection prompt 466. The camera window 464 may present video images from the camera 36 of the handheld device 40. As illustrated in FIG. 30B, the user selection prompt 466 may instruct the user to align an image of text, a barcode, or a matrix barcode from the display 18 of the unmanned kiosk 88, on the camera window 464 to acquire an image. Image boundaries 468 may indicate the portion of the camera window 464 that may be saved as an image; selecting a user selectable button 470, labeled “Acquire,” may cause the image currently within the image boundaries 468 to be acquired.

A screen 472, shown in FIG. 30C, may be displayed when the button 254 is selected. A still image 474 may represent the image acquired by the camera 36. Two buttons 476 and 478 may be labeled “Process Image” and “Re-Acquire,” respectively. The button 476 may allow a user to proceed with the still image 474, while the button 478 may allow the user to acquire another image by returning to the screen 462 of FIG. 30B.

The unmanned kiosk 88 may display screen 480, as shown in FIG. 31, having elements which the camera 36 of the handheld device 40 may scan. For example, the screen 480 may include text 482 and/or a matrix code 484 or, alternatively, a barcode, which may include encoded product data. The handheld device 40 may scan the text 482 and/or the matrix code 484 to obtain product data and/or authenticated product data, as shown by FIGS. 30A-C above.

Turning to FIG. 32, a screen 486 may be displayed upon receipt of the benefits associated with the product or service by optically scanning the screen 480 of FIG. 31. The handheld device 40 may process the image 474 for product data in the manner illustrated by block 272 of FIG. 17. When the extracted product data has been stored in the main memory 14 or nonvolatile storage 16 of the handheld device 40, the screen 486 of FIG. 32 may be displayed. Because optical character recognition, barcode-reading, or matrix-code-reading software that may run on the handheld device could mistranscribe the product data, the screen 486 may list the extracted product data 488 acquired from the image 474 on the screen 480 of the unmanned kiosk 88. If the extracted product data 488 is correct, a user may choose to authenticate the benefits associated with the product or service by selecting a button 490, labeled “Authenticate.” If the button 490 is selected, the authentication procedure may take place in the manner described in the communication diagram 264 of FIG. 17 and the handheld device 40 may display the screens illustrated in FIGS. 15A-D.

If the extracted product data 488 is not correct, a user may choose to edit the product data manually by selecting a button 492, labeled “Edit Information.” If the product data 488 is correct, but authentication is not desired or necessary, a user may choose only to store the extracted product data 488 without initiating an authentication procedure by selecting a button 494, labeled “Store.”

FIGS. 33A-F illustrate another manner of obtaining benefits associated with a product or service from the kiosk 74 or unmanned kiosk 88. Rather than obtain the benefits associated with the product or service via the NFC interface 34 or the camera 36 of the handheld device 40, the handheld device 40 may obtain the benefits associated with the product or service from the kiosk 74 or the unmanned kiosk 88 over a wireless communication channel 376. Turning first to FIG. 33A, a user may select the button 346, labeled “Find Kiosk Wirelessly” to begin to search for a kiosk which may be available over a wireless communication channel 376.

Upon selection of the button 346, a screen 496 may be displayed, as depicted in FIG. 33B. The handheld device 40 may employ a device identification networking protocol to search for other electronic devices 10 having wireless network access. By way of example, the device identification networking protocol may be Bonjour® by Apple Inc. Each of the kiosk 74 or unmanned kiosk 88 and the handheld device 40 may broadcast using internet protocol (IP) their identifications and services, programs, and/or communication capabilities that each device may have. The handheld device 40 may receive information via the device identification networking protocol so as to open peer-to-peer connections via the PAN communication channel 164 or the LAN communication channel 166 with an available kiosk 74 or unmanned kiosk 88. As should be appreciated, more than one electronic device 10 may be broadcasting information using the device identification networking protocol. As such, the handheld device may select the kiosk 74 or unmanned kiosk 88 based on an identification as such or based on user preferences for certain characteristics of the kiosks, which may include owner, manufacturer, etc.

Information about various kiosks obtained using the device identification networking protocol may be displayed on a screen 498, as illustrated by FIG. 33C. The screen 498 may list various local kiosks available for wireless transfer, as indicated generally by a numeral 500. A user may refresh the list 500 of vendors by pressing a refresh button 502. Selecting a button 504 labeled “Options” may enable a user to set various user preferences related to displaying the list 500 of wireless kiosks.

FIG. 33D illustrates a visually descriptive screen 506 displaying the list 500 of available wireless kiosks that may be selling a given product or service. The screen 506 of FIG. 33D may be displayed when a user turns the handheld device 40 sideways, causing the accelerometers 38 to register a change in device orientation. The screen 506 may illustrate the list 500 of vendors in a format such as the Cover Flow format by Apple Inc. The available vendors may be displayed visually with a series of descriptive images 508 and the name of a presently displayed vendor may appear in text 510. By dragging a finger across the screen, a user may easily flip between vendors. Turning the handheld device 40 upright may navigate the user back to the screen 498 of FIG. 33C.

With reference again to the screen 498 of FIG. 33C, if a user selects the button 504, labeled “Options,” a screen 512 may be displayed on the handheld device 40, as shown by FIG. 33E. Options 514 which may be available for a user to change may include to display the list 500 of vendors by proximity, by wireless capabilities, or by the type of product or service that may be for sale (e.g., digital content, DVD rental, food service, etc.), to list only those kiosks 74 or unmanned kiosk 88 which employ a threshold security scheme, as well as other preferences that may provide an enhanced purchasing experience for the user.

Referring to the screen 498 of FIG. 33C or the screen 506 of FIG. 33D, a user may select a vendor from the list 500 or the descriptive images 508 to cause the handheld device 40 to display a sales screen 516, as illustrated in FIG. 33F. The screen 516 may allow a user to purchase a product or service, which may include various associated benefits. Text 518 may provide details regarding the product or service, such as the name of the product or service, date and time of purchase, etc. A user may elect to purchase a certain number of a product or service based on a product quantity button 520. By selecting a button 522 labeled “Buy,” the user may purchase the selected quantity.

After the products or services have been purchased, the handheld device 40 may display a screen 524, as shown in FIG. 33G, indicating that benefits associated with a product or service have been received. The text 518 indicating the electronic benefit information and the quantity 520 may verify that the correct number of benefits associated with a product or service has been received. It should be appreciated that the received product data may be authenticated as sent, or may be authenticated separately by the handheld device 40 according to the techniques described above. The screen 524 may further include the button 244 labeled “Event Details” to enable the user to view the details of the event pertaining to the recently purchased benefits.

FIGS. 34A-B illustrate a manner in which benefits associated with a product or service may be obtained through an online purchase. Turning first to FIG. 34A, if a user selects the button 190 of the screen 182, the handheld device 40 may display a screen 526, as illustrated in FIG. 34B. The screen 526 may display a number of online product or service vendors, the list of which may be provided to the handheld device 40 by the web service 208. Available product or service vendors may be selectable with buttons 528 and 530, labeled “iTunes” and “Vendor 2,” respectively. When a user selects a vendor by pressing one of the buttons 528 or 530, the handheld device 40 may establish a connection with the online vendor listed on the button, from which the user may subsequently purchase a product or service having various associated benefits.

FIGS. 35-37 illustrate a manner of obtaining benefits associated with a product or service from another electronic device 10 which may be currently storing the benefits associated with the product or service. Turning first to FIG. 35A, a user may select the 192 of the screen 182. In response, the handheld device 40 may display a screen 580, as shown in FIG. 35B. The screen 580 may list a series of ways in which the benefits may be received from the other electronic device 10, with a button 582 labeled “Scan Transferring Device With NFC,” a button 584 labeled “Scan Transferring Device With Camera,” and a button 586 labeled “Scan Transferring Device Wirelessly.”

FIG. 35C represents a screen 588 which may be displayed when the user selects the button 582 of the screen 580. The screen 588 may include text stating, “Tap Transferring Device . . . ” and may instruct the user to tap the NFC interface 34 of the handheld device 40 with the NFC interface 34 of a transferring handheld device 40. It should be appreciated, however, that the transferring electronic device 10 may be another handheld device 40, but may alternatively be any electronic device 10, such as the computer 62 or the standalone media player 68.

Receiving the benefits associated with the product or service from the other handheld device 40 via NFC may occur in a similar manner as receiving benefits from the kiosk 74. As such, the kiosk scanning operation 350 illustrated by FIG. 22, as well as the communication diagram 352 of FIG. 23 and the communication diagram of FIGS. 25A-B may effectively describe the communication which may take place in such a transfer. Moreover, as discussed further below, the NFC interface 34 transferring handheld device 40 may be operating in a “host mode.” Accordingly, the techniques described above with reference to FIGS. 27-29, in which the receiving handheld device 40 may remain in a “wake on NFC,” mode may also apply.

Turning next to FIG. 36A, the user may select the button 584 of the prompt 580, labeled “Scan Transferring Device With Camera,” to cause the handheld device 40 to display a screen 590, as shown in FIG. 36B. The screen 590 may include a camera window 592 and a user selection prompt 594. The camera window 592 may present video images from the camera 36 of the handheld device 40. As illustrated in FIG. 36B, the user selection prompt 594 may instruct the user to align an image of text, a barcode, or a matrix code from the display 18 of the transferring handheld device 40 in the camera window 592 to acquire an image. Image boundaries 596 may indicate the portion of the camera window 592 that may be saved as an image; selecting a user selectable button 598, labeled “Acquire,” may cause the image currently within the image boundaries 468 to be acquired.

In the same manner described above with reference to FIGS. 16B and 30B above, the acquired image may be processed to obtain certain product data. It should be appreciated that the product data from the transferring handheld device 40 may include additional information noting that the benefit has been transferred. Further, the product data may be authenticated in the manner described above with reference to the communication diagram 264 of FIG. 17.

Turning to FIG. 37A, the user may alternatively select the button 586 of the prompt 580. Upon selection of the button 586, a screen 600 may be displayed, as depicted in FIG. 37B. The handheld device 40 may employ a device identification networking protocol to search for other electronic devices 10 having wireless network access. By way of example, the device identification networking protocol may be Bonjour® by Apple Inc. Each of the handheld device 40 and the transferring handheld device 40 may broadcast using internet protocol (IP) their identifications and services, programs, and/or communication capabilities that each device may have. The receiving handheld device 40 may receive information via the device identification networking protocol so as to open peer-to-peer connections via the PAN communication channel 164 or the LAN communication channel 166 with the transferring handheld device 40.

FIG. 37C depicts a screen 602 that may be displayed when the receiving handheld device 40 successfully establishes a wireless connection with the transferring handheld device 40. The benefits to be transferred may be generally illustrated as an image 604, which may refer to a product or service to which the benefits pertain. A button 606, labeled “Receive Product,” may enable the user to download the benefits from the transferring handheld device 40.

Turning to FIG. 37D, a screen 608 may represent a prompt displayed upon receipt of the benefits associated with the product or service from the transferring handheld device 40. The screen 608 may indicate with the image 604 to the user that benefits have been received from the transferring handheld device 40. The screen 608 may additionally display information related to the received benefits, and may provide the button 244 to enable the user to view additional details relating to the product or service to which the benefits pertain. It should be appreciated that the benefits associated with the product or service received from the transferring handheld device 40 may represent product data or authenticated product data, as well as supplemental data from the transferring electronic device 10. Thus, the receiving handheld device 40 may or may not communicate with the web service 208 to authenticate the benefits. Further, it should be understood that the wireless transfer described with reference to FIGS. 37A-D may take place over any of the wireless communication channels 376.

It should be noted that the discussion above described a variety of techniques of obtaining benefits associated with a product or service using an electronic device 10. The discussion that follows may describe a variety of techniques for using the benefits associated with the product or service once the benefits have been obtained. More particularly, FIGS. 38-39 may illustrate techniques for accessing and displaying benefits associated with a product or service; FIGS. 40-42 may illustrate techniques for transferring a stored electronic benefit to another electronic device 10; FIGS. 43-46 may illustrate additional techniques for obtaining benefits without necessarily using a personal electronic device 10; and FIGS. 47-67 may illustrate benefits that may be associated with various products or services such as a generic product or product manual; a magazine, magazine insert, or mailer; a textbook, novel, or nonfiction book; an audio or video disc package; software or game packaging; a food product from a grocery store; a restaurant menu; or food or drink packaging.

With at least one product or service benefit stored on the handheld device 40, FIGS. 38A-J may illustrate a manner in which benefits associated with a product or service may be accessed or used. Turning first to FIG. 38A, the display 18 of the handheld device 40 may include the graphical user interface 20. Among the icons which may be present on the home screen of the handheld device 40 may be the product benefit management application icon 44. Selecting the product benefit management application icon 44 may cause the handheld device 40 to display the screen 158. As described above, the screen 158 may include a variety of user selectable buttons 162 and 164, which may enable the user to view a list of stored product or service benefits, or to add product or service benefits, respectively.

Turning next to FIG. 38C, when a user selects the button 162 of screen 158, benefits associated certain types of products or services stored on the handheld device 40 may be displayed on a screen 610. By way of example, the products or services may be listed based on a variety of categories, as indicated by a series of buttons 612. Moreover, a button 614 may enable a user to vary the manner in which the stored benefits are displayed. For example, the products or services may be listed in order of quantity, in order of current popularity, in order of most recently selected, in order of newly available benefits (e.g., a free music download), etc.

If the user selects, for example, the button 612 labeled “Consumer Electronics,” the handheld device 40 may display a screen 616, as illustrated in FIG. 38D. The screen 616 may display list items 618 having text and images related to any electronic benefits that may be stored on the handheld device 40. For example, the list items 618 may list various products for which benefits may be stored on the handheld device 40. The screen 616 may additionally include a button 620, labeled “Options,” which may vary the manner in which the list items 618 are displayed. By way of example, a user may vary the list items 618 such that the products or services are listed in order of quantity, by popularity, by most recently selected, by newly available benefits (e.g., a free music download), etc. It should be appreciated that the options available by way of the button 620 may be the same or different from those available by way of the button 614.

FIG. 38E illustrates a visually descriptive screen 622 displaying the list items 618 of products or services. The screen 622 may be displayed when a user turns the handheld device 40 sideways, causing the accelerometers 38 to register a change in device orientation. The screen 622 may illustrate the list items 618 of products or services in a format such as the Cover Flow format by Apple Inc. The products or services may be displayed visually with a series of descriptive images 624 and the name of a presently displayed product or service, as shown by text 626. By dragging a finger across the screen, a user may easily flip between the products or services. Turning the handheld device 40 upright may navigate the user back to the screen 616 of FIG. 38D.

By selecting one of the list items 618 or images 624, the user may select a product or service, causing the handheld device 40 to display a screen 628. The screen 628 may provide, for example, electronic benefit information 630 and various options for accessing features associated with the product or service via user-selectable buttons 634-638. The user may, for example, select certain options associated with the product or service, as indicated by the button 634 labeled “Options.” The user may view and make use of benefits that may be associated with the product or service, as indicated by the button 636 labeled “Extras.” The user may further transfer the benefits to another electronic device 10, as indicated by the button 638 labeled “Transfer Product.”

By selecting the button 634 labeled “Options,” a user may change a variety of options which may be available with the associated product or service. Such options may include, for example, an option to set a calendar reminder for an event associated with the product or service, to set a particular ringtone or to silence the ringtone on the handheld device 40 upon the use of a given product or service, to periodically check for changes in the product or service, etc. It should be appreciated that many options may become available based on information received in the supplemental product data, as described above with reference to the communication diagrams 206 of FIG. 14 or 264 of FIG. 17. Such information may include, for example, the name and type of the product or service, a location associated with the product or service (e.g., an IP address for a device or a store in which a product is being sold), etc. If not included in the product data obtained from the RFID tag 118, the matrix barcode tag 124, or another source, the supplemental product data may additionally include various other details regarding the category of product or service and/or a hash pertaining to an account, such as an iTunes® account, associated with the user, etc.

The selection of the button 636, labeled “Extras,” may cause the handheld device 40 to display a screen 640, as illustrated in FIG. 38G. The screen 640 may indicate that the user has or does not have “extras,” or additional benefits associated with the product or service. The screen 640 may include a button 642, labeled “View Extras,” and a button 644, labeled “Buy/Prepay Extras.” The buttons 642 and 644 may cause the handheld device 40 to display a list of complimentary benefits or benefits which may be purchased, respectively.

Selecting the user selectable button 642 may introduce a variety of “extras” associated with the selected product or service on a screen 646, as illustrated by FIG. 38H. The screen 646 may indicate a title of the product or service 648 and may include a variety of selectable benefits as list items 650. As described further below with particular reference to FIG. 47, additional benefits associated with a generic product may include, for example, an instructional digital video or related content. Such content may be displayable, for example, in a web browser, such as Safari®, a digital content management application, such as iPod® or iTunes®, or a video application on the handheld device 40, such as a YouTube application. Before receiving the digital content, the handheld device 40 may first receive one or more digital content credits, which may be redeemed for specific digital content from an online digital content service, such as the iTunes service by Apple Inc. A button 652, labeled “Options,” may enable a user to set a variety of options related to the screen 646. Such options may include displaying “extras” in order of expiration, popularity, type (e.g., type of digital content, coupon for merchandise, etc.), whether the benefit is currently available or will not become available until a given date or time, etc. A button 654, labeled “Buy/Prepay Extras” may enable a user to toggle to another screen to prepay for certain benefits associated with the product or service.

FIG. 38I illustrates a visually descriptive screen 656 displaying the list items 650 of “extras,” representing benefits associated with the product or service. The screen 656 of FIG. 38I may be displayed when a user turns the handheld device 40 sideways, causing the accelerometers 38 to register a change in device orientation. The screen 656 may illustrate the list items 650 of “extras” in a format such as the Cover Flow format by Apple Inc. The benefits may be displayed visually with a series of descriptive images 658 and the name of a presently displayed product or service benefit may appear in text 660. By dragging a finger across the screen, a user may easily flip between benefits. Turning the handheld device 40 upright may navigate the user back to the screen 646 of FIG. 38H.

A user may select from the list items 650 of FIG. 38H or the images 658 of FIG. 38I to select one of the benefits associated with the benefits associated with the product or service. It should be appreciated, however, that certain benefits associated with benefits associated with a product or service stored in the handheld device 40 may become available without first selecting the benefits in this manner. For example, a benefit of a free digital download may be credited automatically to a user account, such as an iTunes® account, when the benefits associated with the product or service are initially obtained. From among the list items 650 or the images 658, if a user selects the first list item 650, providing a free song download, the handheld device 40 may display a screen 662, as illustrated in FIG. 38J, which may represent a complimentary song download associated with the product or service. The screen 662 may state, for example, that the handheld device 40 has received credit to purchase online music. In the present example, the screen 662 indicates that iTunes credit has been received to download “Jumping Jack Flash” by the Rolling Stones, which corresponds to the benefits associated with the product or service selected. The credit may be associated with a user account for an online music vendor, such as iTunes®, and thus the user may or may not choose to download the song immediately; the user may instead download the song at any time via the online music vendor. To accommodate a user who may desire to download the song immediately, the screen 662 may additionally include a button 664, labeled “Download Now,” which may allow the user to download the song from the product benefit management application.

As noted above, certain benefits or “extras” associated with benefits associated with a product or service may be available to purchase or prepay. FIGS. 39A-B illustrate a manner of purchasing or prepaying for additional benefits associated with the benefits associated with the product or service stored on the handheld device 40. Turning first to FIG. 39A, a user may select the button 644 on the screen 640. In response, the handheld device 40 may display a screen 666, as illustrated in FIG. 39B. The screen 666 may display a title of the event 648 and may include a variety of selectable benefits as list items 650. As described further below with particular reference to FIG. 47, additional benefits associated with a generic product may include, for example, an option to purchase remote control software to run on the handheld device to control the presently selected product and/or to order related products. In the case of the A/V receiver 104, such benefits for purchase may include cables or movies from a particular vendor.

With continued reference to FIG. 39B, a button 672, labeled “Options,” may enable a user to set a variety of options related to the screen 666. Such options may include displaying “extras” in order of expiration, popularity, type (e.g., digital content, coupon for merchandise, etc.), whether the benefit is currently available or will not become available until a predetermined date or time, etc. A button 674, labeled “View Extras,” may enable a user to toggle to the screen 646 to view the other benefits associated with the product or service. It should further be appreciated that tilting the handheld device sideways may cause the list items 670 to be displayed in a visual manner, as described above with reference to FIG. 38I.

The discussion associated with FIGS. 32-34 above may describe techniques for receiving benefits associated with a product or service from another electronic device 10. Similarly, FIGS. 40-42 may describe techniques for transferring benefits associated with a product or service to another electronic device 10. More particularly, FIGS. 40A-C may illustrate transferring benefits associated with a product or service to another electronic device 10 via NFC, FIGS. 41A-B may illustrate transferring benefits associated with a product or service to another electronic device 10 via imagery to be scanned by the camera 36, and FIGS. 42A-B may illustrate transferring benefits associated with a product or service to another electronic device 10 via wireless network communication.

Turning first to FIG. 40A, a user may choose to transfer benefits associated with a product or service stored on the handheld device 40 by selecting the button 638, labeled “Transfer Product,” of the screen 628. Selecting the button 638 may cause the handheld device 40 to display a screen 676, as illustrated in FIG. 40B. The screen 676 may include a variety of user-selectable buttons 678-686 to provide such benefit transfer options as “NFC,” “Barcode/Image,” “Wireless,” “Email,” or “Print,” respectively. For example, selecting the button 684 may allow the user to send the benefits associated with the product or service to another electronic device 10 via email, while selecting the button 686 may allow the user to print a matrix barcode encoding the benefits associated with the product or service such that the printed matrix barcode may be scanned into another electronic device 10.

If the user selects the button 678 labeled “NFC,” the handheld device 40 may display a screen 688, as illustrated by FIG. 40C. The screen 688 may instruct the user to tap the NFC interfaces 34 of the handheld devices 40 together to initiate the transfer. It should be appreciated that transferring the benefits associated with the product or service to the other handheld device 40 via NFC may occur in a manner similar to that for obtaining benefits associated with a product or service from the kiosk 74. As such, the kiosk scanning operation 350 illustrated by FIG. 22, as well as the communication diagram 352 of FIG. 23 and the communication diagram of FIGS. 25A-B may effectively describe the communication which may take place in such a transfer. Moreover, as discussed further below, the NFC interface 34 transferring handheld device 40 may be operating in a “host mode.” Accordingly, the techniques described above with reference to FIGS. 27-29, in which the receiving handheld device 40 may remain in a “wake on NFC,” mode may also apply

Turning to FIG. 41A, if the user selects the button 680 labeled “Barcode/Image,” the handheld device 40 may display a screen 690, as illustrated in FIG. 44B. The handheld device 40 may display the screen 690 by generating a barcode or matrix code 692 encoding electronic benefit information representing the benefits associated with the product or service to be transferred. As described above with reference to FIGS. 39A-B, the receiving handheld device 40 may scan the barcode or matrix code 692 to obtain the benefits associated with the product or service from the transferring handheld device 40 displaying the screen 690. When the transfer has completed, the user may select a button 694, labeled “Done,” to return to the main menu of the product benefit management application.

FIGS. 42A-D illustrate a manner of transferring the benefits to another electronic device 10 wirelessly. Turning first to FIG. 42A, by selecting the button 682, labeled “Wireless,” the handheld device 40 may begin to broadcast information relating to transferring the benefits associated with the product or service using the device identification networking protocol, which may be described above with reference to FIG. 24. Simultaneously, the handheld device 40 may begin searching for the receiving electronic device 10.

Accordingly, the handheld device 40 may subsequently display a screen 696, as illustrated in FIG. 42B, which may indicate that the handheld device 40 is announcing wirelessly that a benefit is available for transfer or that the handheld device 40 is searching for the receiving electronic device 10. When the receiving electronic device 10 is discovered wirelessly and a wireless connection to the electronic device 10 is established, the handheld device 40 may display a screen 698, as illustrated by FIG. 42C. The screen 698 may denote with an image 700 the product or service to which the benefits to be transferred pertain. Selecting a button 704 may enable the user to complete the transaction and the benefits associated with the product or service may be transferred wirelessly to the receiving electronic device 10. Accordingly, when the button 704 is selected, the handheld device 40 may display a screen 706, as illustrated by FIG. 42D. The screen 706 may restate the recently-transferred benefits by displaying the image 700, and may further state in text that the benefits have been transferred from the handheld device 40 to the receiving electronic device 10. A button 708, labeled “Product List,” may allow the user to return to the screen 610.

FIGS. 43-46 may describe techniques for obtaining content credited to a user's account using the RFID tag 118 or the matrix barcode 124 associated with a product or service, which may be purchased from a kiosk or from a cash register at the event. In particular, the techniques described with reference to FIGS. 43-46 may be performed with the RFID tag 118 or the matrix barcode 124 associated with a product or service, regardless of whether the benefits associated with the product or service have been stored on the handheld device 40. By way of example, after purchasing a given product, the purchaser may choose to purchase digital content relating to the new product. Such new content may be, for example, digital music of any format. By tapping the RFID tag 118 or scanning the matrix barcode tag 124 to the kiosk 74 or unmanned kiosk 88, digital content purchased at the kiosk may be automatically credited to the user's account or to an account associated with the product with an online music vendor, such as iTunes®, as described below with reference to FIGS. 43-46.

FIG. 43 illustrates a product-scanning operation 854. The operation 854 may allow a user to provide a vendor, such as the kiosk 74 or the unmanned kiosk 88, with proper information, to automatically credit the user's account with an online music vendor, such as iTunes®, through which such digital content may be delivered. After purchasing or selecting digital content at the kiosk 74, a user may, for example, tap the RFID tag 118 to the NFC interface 34 of the kiosk 74. As the RFID tag 122 of the RFID tag 118 approaches the NFC interface 34 of the kiosk 74, the RFID tag 122 may transmit certain product data associated with the product, which may include a serial number associated with the product. As depicted, the information may be transferred over the NFC communication channel 204.

FIG. 44 is a communication diagram 856, which may represent a manner of crediting digital content to a user account via the operation 854 depicted in FIG. 43. Initially, the NFC interface 34 of the kiosk 74 may be in a “host mode,” as indicated by block 858. As such, when the RFID tag 118 approaches the NFC interface 34 of the kiosk 74, as occurs when the RFID tag 118 is tapped according to block 860, the NFC interface 34 of the kiosk 74 may emit a ping, as shown in block 862. When the RFID tag 122 receives the ping of block 862, the RFID tag 122 may become energized, as shown in block 864. Subsequently, the RFID tag 122 may respond by sending stored product data, as indicated by block 866, to the kiosk 74. As noted above, the product data from the RFID tag 118 may include, for example, a serial number associated with the product. The kiosk 74 may subsequently communicate with the web service 208, which may be, for example, an online digital content vendor such as iTunes®. The kiosk 74 may transmit the product data to the web service 208 with an indication of the digital content product purchased, as shown in blocks 868 and 870, respectfully.

When the web service 208 receives the product data, the web service 208 may link the received product data to an associated user account. Thereafter, the web service 208 may credit the account for the digital content product purchased, as illustrated by block 872. Alternatively, the web service 208 may save digital content credits for the product purchased without associating the content with an account. Particularly, such action may be taken if the product or service is not associated with a user account with the web service 208. The product owner may later log onto the web service 208 from an electronic device 10 and activate the benefits associated with the product or service by providing the product data to the web service using the techniques described above. Thereafter, the web service 208 may transfer the credits associated with the product data of the RFID tag 118 to the account of the user. Thus, a person may purchase digital content for use with a particular product before having stored the benefits associated with the product on the handheld device 40.

FIG. 45 displays an alternative manner of obtaining digital content to an account using the matrix barcode tag 124. A product-scanning operation 874 may allow a user to provide a vendor, such as the kiosk 74 or the unmanned kiosk 88, with proper information to automatically credit the user's account with an online music vendor, such as iTunes, through which the digital content may be delivered. After purchasing or selecting digital content at the kiosk 74, a user may, for example, scan the matrix barcode tag 124 with the barcode or matrix code reader 105 of the kiosk 74. The kiosk 74 may decode from the matrix barcode tag 124 certain product data associated therewith, such as a serial number. Having obtained the product data from the matrix barcode tag 124, the kiosk 74 may, in the manner illustrated with reference to blocks 868-872 of FIG. 44, credit a user account associated with the product or service to which the matrix barcode tag 124 is associated.

FIG. 46 is a flow chart 874 that may describe the techniques discussed above with reference to FIGS. 43-45. In a first step 876, a user may select digital content to be purchased or given away free at a cash register, a kiosk 74, or unmanned kiosk 88. The content may include, for example, digital music or videos that may or may not be related to a product owned by the user. The selection may be made on the kiosk 74 or the unmanned kiosk 88, for example, but may also be made on any electronic device 10, and may be input by an attendant, such as a cashier. In certain cases the user may be required to pay prior to continuing.

In a next step 878, the user may offer the RFID tag 118 or the matrix barcode 124 associated with a product or service, to a cashier or the kiosk 74 or unmanned kiosk 88. For example, the user may tap the RFID tag 118 to the kiosk 74 or unmanned kiosk 88, as illustrated in the operation 854 of FIG. 43, or the user may scan the matrix barcode tag 124 in the kiosk 74 or unmanned kiosk 88, as illustrated in the operation 874 of FIG. 45. Alternatively, the matrix barcode tag 124 may be handed to an attendant for manual entry into a cash register or computer 62.

In step 880, the kiosk 74, the unmanned kiosk 88, the cash register, or the computer 62 may transmit the product data and an indication of the selected digital content to the web service 208. This step may be illustrated with reference to blocks 868 and 870 of the communication diagram 856 of FIG. 44. In a next step 882, the web service 208 may credit the account associated with the product data with the selected digital content or may associate the product data with credits for the selected digital content. By way of example, if the user had elected to purchase a particular album, the user's account may be credited with the album for download at a later time. Alternatively, the album may be associated with product data, such as a serial number, associated with the RFID tag 118 or the matrix barcode 124.

As indicated by step 884, the user may later download the selected content to the user's electronic device 10 when the content is made available. If the selected digital content had been credited to the user account of the web service 208, which may be, for example, an online digital content vendor such as iTunes®, the user may simply log into the web service 208 to obtain the content. If, alternatively, the selected digital content had been credited to product data of the RFID tag 118 or the matrix barcode 124 associated with a product or service, such as the serial number of the product or service, the user may activate the benefits associated with the product or service via the web service 208 to obtain digital content. Activating the product or service benefits may involve providing the web service 208 with the product data associated with the RFID tag 118 or the matrix barcode 124 associated with a product or service using the techniques described above.

As should be appreciated, a broad variety of benefits may be associated with a given product or service stored in the handheld device 40. Certain types of products or services may be particularly suited to certain benefits. Accordingly, the following discussion may describe benefits that may be associated with certain products or services. However, benefits described as associated with one type of product or service should not be understood as limited to the product or service discussed. Indeed, any benefit described below as associated with one product or service may also be associated with any other product or service.

It should further be appreciated that a marketing firm may desire to market the benefit system 102 described above to a manufacturers or distributors that may make or sell the product or service. The promoter or manager in the marketing firm may prepare a product benefit package to market to the manufacturer, supplier, distributor, or retailer of a product or service, which may include a suite of various benefits. As described herein, the benefits may include a range of digital content that may be received by an electronic device directly or in the form of one or more digital content credits redeemable for specific related content. Moreover, the product benefit package may vary depending on the type of product or service, capabilities or facilities of the manufacturer, supplier, distributor, or retailer, target demographic for the product or service, etc. For example, if the product is a generic product, the product benefit package may include any number of the benefits described below with reference to FIG. 47, such as an instructional video download or discounts on related products.

Turning to FIG. 47, a benefit diagram 886 illustrates various benefits that may be associated with a product or product manual 888, such as the A/V receiver 104 or the product manual 106 of FIGS. 10-11. It should be appreciated that the benefits associated with the product or product manual 888 may be obtained, stored, and used in any electronic device 10 according to the techniques described above. Thus, the electronic device 10 may first obtain digital content credits that may be redeemable for specific digital content from an online digital content service, such as the iTunes service by Apple Inc. Moreover, it should be understood that the benefits described in the benefit diagram 886 are intended to be exemplary and not exclusive.

Among the benefits that may be associated with the product or product manual 888 may be troubleshooting assistance 890. The troubleshooting assistance 890 may represent any digital download to assist a user that may need assistance with the product or product manual 890. For example, the troubleshooting assistance 890 may include a digital document listing frequently asked questions or a link to a troubleshooting website. An instructional video 892 may further aid a user seeking assistance for product installation or use. For further assistance, contact information 894 may enable the user to contact the manufacturer of the product or the provider of the service directly via email or phone.

Beyond offering assistance in installing or using the product or product manual 888, additional benefits may be calculated to create sales of related merchandise. For example, related products 896 may be offered to the user of the product or product manual 888 at a discount or for marketing purposes. The related products 896 may include products that may be likely to be purchased by the user based on their ownership of the product or product manual 888. Another available benefit may be offers of free, discounted, or otherwise advertised related software 898. The related software 898 may represent, for example, software that may run on the product or product manual 888 if the product is a digital device, or software that may prove particularly useful to an owner of the product or product manual 888. Both the offers of related products 896 or of the free, discounted, or otherwise advertised related software 898 may be obtained by applying certain digital content credits received by the electronic device 10 toward a purchase of the related products or software or toward a download of marketing materials from the online digital content service. It should be understood that all benefits disclosed herein may be obtained in the above-described manner.

Because the product or product manual 888 may employ peripheral devices or other products, offers of prepaid or discount peripherals 900 may enhance the experience of the user of the product or product manual 888. Similarly, prepaid or discount media downloads 902 may be offered based on the product or product manual 888. By way of example, the digital download described above with reference to FIGS. 38H and 38J may represent examples of prepaid or discount media downloads 902 that may be associated with the product or product manual 888.

To use the A/V receiver 104 as an example, the related products 896 may include, for example, advertisements or offers of discounts on televisions and/or media players by the same manufacturer or designed for use with the A/V receiver 104. The related software 898 may include, for example, surround sound firmware that may enable the A/V receiver 104 to process sound in a unique way. The prepaid or discount peripherals 900 may include, for example, special-purpose cables by the same manufacturer or designed for use with the A/V receiver 104. Prepaid or discount media downloads may include, for example, songs or movies designed to showcase the capabilities of the A/V receiver 104.

FIGS. 48-50 generally describe benefits that may be associated with magazines, magazine inserts, or mailed advertisements. Turning first to FIG. 48, a magazine 920 may include the RFID tag 118 or the matrix barcode tag 124 located on an outer cover 922. It should be appreciated that the RFID tag 118 or the matrix barcode tag 124 may alternatively be manufactured into or printed directly onto the outer cover 922. FIG. 49 illustrates a magazine insert 926 that may be located within the magazine 920. The magazine insert may represent, for example, an advertisement including the RFID tag 118 or the matrix barcode tag 124. To gain a variety of benefits that may be associated with the magazine 920 or the magazine insert 926, the user may scan the RFID tag 118 or the matrix barcode 124 using the handheld device 40.

FIG. 50 is a benefit diagram 930 listing various benefits that may be associated with a magazine, magazine insert, or mailer 932, such as the magazine 920 or the magazine insert 926. It should be appreciated that the benefits associated with the magazine, magazine insert, or mailer 932 may be obtained, stored, and used in any electronic device 10 according to the techniques described above. Moreover, it should be understood that the benefits described in the benefit diagram 930 are intended to be exemplary and not exclusive.

Among the benefits that may be associated with the magazine, magazine insert, or mailer 932 may be links to or downloads of various movie trailers 934 that may be advertised in the magazine, magazine insert, or mailer 932. Discounted products 936 may be offered in the form of digital coupons, as generally described in U.S. patent application Ser. No. 12/286,446, “System and Method for Providing Electronic Event Tickets,” which is incorporated herein by reference in its entirety. To supplement or replace print advertisements, video advertisements 938 or video game demonstrations or software demonstrations 940 may be made available as a benefit associated with the magazine, magazine insert, or mailer 932. Free or discounted songs may encourage users to buy a copy of the magazine 920 or to discover a band being described in the magazine, magazine insert, or mailer 932.

FIGS. 51-54 generally describe benefits that may be associated with books having the RFID tag 118 or the matrix barcode tag 124. Turning first to FIG. 51, a textbook 950 may include the RFID tag 118 or the matrix barcode tag 124 located on an outer cover 952. Additionally or alternatively, the RFID tag 118 may be manufactured into the outer cover 952 or the matrix barcode tag 124 may be printed directly onto the outer cover 952. As illustrated by FIG. 52, certain pages 954 of the textbook 950 may include RFID tag 118 or the matrix barcode 124. Benefits associated with particular pages 954 of the textbook 950 may be particularly directed to the content appearing on such pages 954.

Turning to FIG. 53, a benefit diagram 960 illustrates various benefits that may be associated with a textbook 962, such as the textbook 950. It should be appreciated that the benefits associated with the textbook 962 may be obtained, stored, and used in any electronic device 10 according to the techniques described above. Moreover, it should be understood that the benefits described in the benefit diagram 960 are intended to be exemplary and not exclusive.

Benefits that may be associated with the textbook 962 may include, for example, supplementary problems 964 and answers to book problems 966. By way of example, a student may turn to a given page in the textbook 962 with a series of math problems or chapter questions that may additionally include the RFID tag 118 or the matrix barcode tag 124. After answering the printed questions, the student may scan the RFID tag 118 or the matrix barcode tag 124 using the handheld device 40. Subsequently, the handheld device 40 may display supplementary problems 964 or answers to the book problems 966 from the current page of the textbook 962.

If a student is struggling with a particular concept, a download of instructional audio or video 968 may provide assistance. Similarly, another benefit that may be associated with the textbook 962 may be a link to purchase additional materials 970, such as textbook supplements or tutoring courses. Additionally, further recommended reading 972 may be offered for those interested in learning more about a particular concept discussed in the textbook 962.

Turning to FIG. 54, a benefit diagram 980 illustrates various benefits that may be associated with a novel or non-fiction book 982 other than the textbook 962. It should be appreciated that the benefits associated with the novel or non-fiction book 982 may be obtained, stored, and used in any electronic device 10 according to the techniques described above. Moreover, it should be understood that the benefits described in the benefit diagram 980 are intended to be exemplary and not exclusive.

Benefits associated with the novel or non-fiction book 982 may include content that may be of particular interest to the reader of the novel or non-fiction book 982. For example, author interviews 984 conducted by print sources or on video may available for download on the handheld device 40. Similarly, a link to purchase related titles 986, such as books by the same author or books of the same genre, may represent an associated benefit. If the novel or non-fiction book 982 is made into a movie or shown on television, a movie trailer for a movie associated with the book 988 may be included. Various press discussing the book 990 may be included as a benefit associated with the product to assist potential buyers, who may scan the associated RFID tag 118 or the matrix barcode 124 prior to purchasing the novel or non-fiction book 982.

FIGS. 55-57 generally describe benefits that may be associated with sales of music, movies, or software, whose cases may include the RFID tag 118 or the matrix barcode tag 124. Turning first to FIG. 55, a DVD case 1000 may include the RFID tag 118 or the matrix barcode tag 124, which may be located on the front 1002 of the DVD case 1000. The RFID tag 118 or the matrix barcode tag 124 may be displayed prominently on the front 1002 of the DVD case 1000 to encourage users of the handheld device 40 to scan the RFID tag 118 or the matrix barcode tag 124 prior to purchase. Benefits associated with the DVD case 1000 may include, among other things, advertisements directed to marketing the DVD within to potential buyers.

Turning to FIG. 56, a benefit diagram 1010 illustrates various benefits that may be associated with optical disc packaging 1012. It should be appreciated that the benefits associated with the optical disc packaging 1012 may be obtained, stored, and used in any electronic device 10 according to the techniques described above. Moreover, it should be understood that the benefits described in the benefit diagram 1010 are intended to be exemplary and not exclusive.

Benefits that may be associated with the optical disc packaging 1012 include, for example, a movie trailer 1014 or music samples. The movie trailer 1014 may advertise a movie on the optical disc in the optical disc packaging 1012, but may additionally or alternatively advertise related movies. Similarly, the music samples may advertise music on the optical disc in the optical disc packaging 1012, but may additionally or alternatively advertise related music. Reviews of the movie 1016 or reviews of the music 1018 of the optical disc in the optical disc packaging 1012 may further assist buyers in whether to make a purchase. A free single 1020 may additionally or alternatively be offered as a way to market music on the optical disc in the optical disc packaging 1012.

Turning to FIG. 57, a benefit diagram 1030 illustrates various benefits that may be associated with software or video game packaging 1032. It should be appreciated that the benefits associated with the software or video game packaging 1032 may be obtained, stored, and used in any electronic device 10 according to the techniques described above. Moreover, it should be understood that the benefits described in the benefit diagram 1030 are intended to be exemplary and not exclusive.

Among various benefits that may be associated with the software or video game packaging 1032 may be a software or game demo 1034 or a preview video 1036. A potential buyer of software in the software or video game packaging 1032 may, for example, tap an RFID tag 118 located on the software or video game packaging 1032 to the potential buyer's handheld device 40 obtain the benefits associated therewith. The potential buyer may thereafter test the software with the software or game demo 1034 on the handheld device 40 or may watch the preview video 1036 to ascertain whether to purchase the software.

Similarly, the software or video game packaging 1032 may include as a benefit a “behind the scenes” video 1038, game hints or software troubleshooting 1040, or an instructional video 1042. The “behind the scenes” video 1038 may particularly be of note when paired with a video game, as a user of the video game may be especially interested in learning how the game was developed. The game hints or software troubleshooting 1040 may assist game players or users having trouble with the software from the software or video game packaging 1032. In addition to or in lieu of the game hints or software troubleshooting 1040, the instructional video 1042 may assist users new to the software in the software or video game packaging 1032.

FIGS. 58-59 generally describe benefits that may be associated with products found in a grocery store. For example, FIG. 58 illustrates a box of brownie mix 1050 configured to provide various associated benefits in accordance with the techniques described above. Thus, the box of brownie mix 1050 may include on a package exterior 1052 an RFID tag 118 or a matrix barcode tag 124. Additionally or alternatively, the RFID tag 118 may be manufactured into or the matrix barcode tag 124 may be printed directly onto the package exterior 1052 of the box of brownie mix 1050.

Turning to FIG. 59, a benefit diagram 1060 illustrates various benefits that may be associated with food product packaging 1062. It should be appreciated that the benefits associated with the food product packaging 1062 may be obtained, stored, and used in any electronic device 10 according to the techniques described above. Moreover, it should be understood that the benefits described in the benefit diagram 1060 are intended to be exemplary and not exclusive.

Benefits associated with the food product packaging 1062 may include, for example, recipes 1064, an instructional video 1066, a list of ingredients needed, and/or placement of related items into an electronic shopping list 1070. To use the box of brownie mix 1050 as an example of the food product packaging 1062, when a user taps a handheld device 40 to the RFID tag 118 of the box of brownie mix 1050 while shopping, various recipes 1064 may be listed on the handheld device 40. Similarly, a user seeking step by step instructions for using making the brownies from the box of brownie mix 1050 may find assistance with an instructional video 1066, which may be downloaded automatically in the supplemental product data. Additionally or alternatively, the supplemental product data may include a link to a web location for viewing the instructional video 1066.

Because it may not be entirely clear whether the box of brownie mix 1050 may require additional ingredients, the handheld device 40 may list the ingredients needed 1068. Further, the list of ingredients needed 1068 may be placed into an electronic shopping list 1070 on the handheld device 40. Such techniques may be described in U.S. application Ser. No. 12/286,361, “On-the-go Shopping List,” which is incorporated herein by reference in its entirety.

FIGS. 60-62 generally describe benefits that may be associated with a restaurant menu or an exterior wall or door of a store. For example, FIG. 60 illustrates a restaurant menu 1080, which may include an RFID tag 118 or a matrix barcode tag 124 on an exterior cover 1082 configured to provide associated benefits. Additionally or alternatively, the RFID tag 118 may be manufactured into or the matrix barcode tag 124 may be printed directly onto the exterior 1082 of the restaurant menu 1080.

Turning to FIG. 61, a benefit diagram 1090 illustrates various benefits that may be associated with a restaurant menu or store exterior 1092, such as the restaurant menu 1080. It should be appreciated that the benefits associated with the restaurant menu or store exterior 1092 may be obtained, stored, and used in any electronic device 10 according to the techniques described above. Moreover, it should be understood that the benefits described in the benefit diagram 1090 are intended to be exemplary and not exclusive.

Benefits that may be associated with the restaurant menu or store exterior 1092 may include, among other things, various advertising content 1094 to encourage potential entrant to choose to enter the restaurant or store. Certain advertising content 1094 may include, for example, digital video advertisements or dinner specials 1096. The dinner specials may represent certain special prices available to users of the handheld device 40 or a special coupon that may be displayed on the handheld device 40.

Nutrition information 1098 may be viewable as a benefit on the handheld device 40, as well as an event calendar 1100. As illustrated below with reference to FIG. 62, events on the event calendar 1100 may be stored onto a calendar application that may run on the handheld device 40. Another benefit that may be associated with the restaurant menu or store exterior 1092 may be offers of discounted or prepaid food or merchandise 1102. The offers of discounted or prepaid food or merchandise 1102 may represent electronic coupons that may be redeemable at the restaurant or store having the restaurant menu or store exterior 1092, but may also represent offers of discounts on food or merchandise from other locations.

FIGS. 62A-F illustrate screens that may be displayed on the handheld device 40 to receive certain benefits that may be associated with the restaurant menu or store exterior 1092. Turning first to FIG. 62A, when a user taps the handheld device 40 to the RFID tag 118 of the restaurant menu or store exterior 1092 according to the techniques described above, the handheld device 40 may display a screen 1120. The screen 1120 may include a button 1122, which may be labeled “Run Products + to view menu for ‘Mi Luna.’” Selecting the button 1122 may launch the product benefits management application and the handheld device 40 may display a screen 1124, as illustrated in FIG. 62B.

The screen 1124 may indicate that benefits associated with the restaurant menu or store exterior 1092 have been obtained onto the handheld device 40. Among various buttons on the screen 1124 may be a button 1126, which may be labeled “Extras.” Selecting the button labeled “Extras” may cause the handheld device 40 to display a screen 1132, as shown in FIG. 62C. The screen 1132 may include buttons 1134 and 1136, which may be labeled “View Extras” and “Buy/Prepay Extras,” respectively. Selecting the button 1134, labeled “View Extras,” may cause the handheld device 40 to display various complimentary benefits associated with the restaurant menu or store exterior 1092, as illustrated by a screen 1140 of FIG. 62D.

Various complimentary benefits that may be associated with the restaurant menu or store exterior 1092 may be displayed on the screen 1140 of FIG. 62D as list items 1142. Such list items 1142 may include, for example, an “Event Calendar,” selectable “Nutrition Information,” or offers for “Discount Tapas.” Selecting the first list item 1142, labeled “Event Calendar,” may cause the handheld device 40 to display a screen 1146, as illustrated by FIG. 62E. The screen 1146 may include a series of list items 1148 that may represent the various events that may be scheduled at the restaurant or store, such as a “Flamenco & Spanish Guitar” or “Salsa Dancing & Live Band.” The screen 1146 may include check boxes 1150 associated with the list items 1148 to enable a user to select whether or not the user plans to attend each of the events. A button 1152, labeled “Add to Calendar,” may be selected by the user to add all list items 1148 for which the associated check boxes 1150 have been selected into a calendar application on the electronic device 10. As illustrated by a screen 1154 of FIG. 62F, the selected events associated may be then be recorded in the calendar application that may run on the electronic device 10.

FIGS. 63-65 generally describe benefits that may be associated with food product packaging in a restaurant. For example, FIG. 63 illustrates a paper coffee cup 1160 configured to provide various benefits in accordance with the techniques described above. An RFID tag 118 and/or a matrix barcode tag 124 may be located on an exterior 1162 of the paper coffee cup 1160. Additionally or alternatively, the RFID tag 118 may be manufactured into or the matrix barcode tag 124 may be printed directly onto the exterior 1162 of the paper coffee cup 1160.

Turning to FIG. 64, a benefit diagram 1170 illustrates various benefits that may be associated with food product packaging 1172. It should be appreciated that the benefits associated with the food product packaging 1172 may be obtained, stored, and used in any electronic device 10 according to the techniques described above. Moreover, it should be understood that the benefits described in the benefit diagram 1170 are intended to be exemplary and not exclusive.

Benefits that may be associated with the food product packaging 1172 may include, for example, offers of free or discounted music 1174. Such music 1174 may be obtained in the manner described above with reference to FIGS. 38H-J. For food product packaging 1172 at certain restaurants, an associated benefit may include an option to buy music currently playing in the restaurant 1176, as described below with reference to FIGS. 65A-E. Other benefits that may be associated with the food product packaging 1172 may include offers for prepaid food or drink 1178, nutrition information 1180, an electronic game piece or game download 1182 for a restaurant promotion, or advertisements for related food or drink 1184 that may be of particular interest to the consumer of the food or drink in the food product packaging 1172.

FIGS. 65A-E illustrate screens that may be displayed on the handheld device 40 to obtain the various benefits described above that may be associated with the food product packaging 1172. Turning first to FIG. 65A, when a user taps the handheld device 40 to the RFID tag 118 of the food product packaging 1172 according to the techniques described above, the handheld device 40 may display a screen 1200. The screen 1200 may include a button 1202, which may be labeled “Run Products + to see Extras from Starbucks.” Selecting the button 1202 may launch the product benefits management application and the handheld device 40 may display a screen 1204, as illustrated in FIG. 65B.

The screen 1204 may indicate that benefits associated with the food product packaging 1172 have been obtained onto the handheld device 40. Among various buttons on the screen 1204 may be a button 1206, which may be labeled “Extras.” Selecting the button labeled “Extras” may cause the handheld device 40 to display a screen 1212, as shown in FIG. 65C. The screen 1212 may include buttons 1214 and 1216, which may be labeled “View Extras” and “Buy/Prepay Extras,” respectively. Selecting the button 1214, labeled “View Extras,” may cause the handheld device 40 to display various complimentary benefits associated with the food product packaging 1172, as illustrated by a screen 1218 of FIG. 65D.

Various complimentary benefits that may be associated with the restaurant menu or store exterior 1092 may be displayed on the screen 1218 of FIG. 65D as list items 1220. Such list items 1220 may include, for example, an “Event Calendar,” an option to “Buy/Bookmark Current Song,” or offers for a “Discount Muffin.” Selecting the second list item 1220, labeled “Buy/Bookmark Current Song,” may cause the handheld device 40 to display a screen 1222, as illustrated by FIG. 65E. The screen 1222 may include buttons 1224 and 1226 labeled “Buy on iTunes,” and “Bookmark Song,” respectively. Simultaneously, the handheld device 40 may, based on the product data or supplementary product data and the current time, contact the web service 204, which may have information indicating which song is playing at the restaurant having the particular food product packaging 1172 scanned by the user. With such information, selecting the button 1224 may launch an application for purchasing online music to purchase the currently-playing song. Selecting the button 1226 may “bookmark” the song by creating a record for the user of the currently-playing song, which the user may purchase at a later time.

It should be appreciated that the techniques provided by the present disclosure may be susceptible to a variety of variations and modifications. One such variation or modification may be described by FIGS. 66-68, which may provide an additional or alternative manner of providing benefits associated with a product or service having a PAN interface 28 or a LAN interface 30. For exemplary purposes, FIGS. 66-68 illustrate the handheld device 40 receiving benefits from the A/V receiver 104. It should be understood, however, that any electronic device 10 may receive benefits from any product having a PAN interface 28 or a LAN interface 30 using the techniques discussed with reference to FIGS. 66-68.

As shown in FIG. 66, a user of an electronic device 10 may approach a product or service having a PAN interface 28 or LAN interface 30 to initiate a product-scanning operation 1230. While the product-scanning operation 1230 depicts communication between the PAN interfaces 28 of the handheld device 40 and the A/V receiver 104, it should be understood that the communication may also take place between LAN interfaces 30 of the handheld device 40 and the A/V receiver 104. Moreover, though the present example describes communication using Bluetooth® protocols, communication may additionally or alternatively involve any other protocol for peer-to-peer communication and/or device discovery, including the Nike+ protocol or Bonjour® by Apple Inc.

In the product-scanning operation 1230, an electronic device 10, such as the handheld device 40, may be placed within range of a PAN associated with a product or service, such as the A/V receiver 104. The PAN interface 28 of the A/V receiver 104 may be operating in a discoverable mode. As such, when the handheld device 40 is within range of the A/V receiver 104, a PAN communication channel 378 may open between the handheld device 40 and the A/V receiver 104. Subsequently, the A/V receiver 104 may transmit various benefits to the handheld device 40, as described below.

Turning to FIG. 67, a communication diagram 1232 illustrates communication that may take place during the product-scanning operation 1230 of FIG. 66. As indicated by blocks 1234 and 1235, the PAN interface 28 of the A/V receiver 104 may operate in a discoverable mode, while the PAN interface 28 of the handheld device 40 may operate in a “wake on Bluetooth” mode to conserve power. Operating in the discoverable mode, the A/V receiver 104 may periodically emit a scanning signal compliant with a device or service discovery protocol, such as the Bluetooth Service Discovery Protocol (SDP), as shown by block 1236. As illustrated in block 1238, the PAN interface 28 of the handheld device 40 may “awaken” and become active upon receiving the scanning signal. Once active, the PAN interface 28 of the handheld device 40 may identify the A/V receiver 104 through an exchange of digital identification certificates, as shown in block 1240, followed by a device authentication procedure, as shown in block 1242. It should be understood that the authentication procedure of block 1242 may take place in the manner described above with reference to FIG. 23.

Having identified the A/V receiver 104 as a product or service, the handheld device 40 may next display a prompt to launch the product benefit management application, as noted by block 1244 and illustrated in FIG. 68. If the user of the handheld device 40 elects to launch the application, the handheld device 40 may receive product data or product authentication data and/or supplemental product data, as shown by blocks 1246 and 1248, respectively. The data received in blocks 1246 and 1248 may be employed by the handheld device 40 according to the techniques described above.

FIG. 68 depicts a screen 1250 having a prompt 1252 that may be displayed on the handheld device 40 in the product-scanning operation 1230, which may be displayed when the handheld device 40 is within range of a PAN-enabled product or service. As such, the prompt 1252 may illustrate the prompt of the block 1244 of FIG. 67. Text appearing in the prompt 1252 may indicate that various benefits may be accessible from a nearby product or service, and two buttons 1254 and 1256 may enable the user of the handheld device 40 to launch the product benefit management application or to ignore the prompt, respectively. If the user elects to launch the product benefit management application, the handheld device 40 may receive benefits from the nearby product or service. Thereafter, the handheld device 40 may enable the user to access the benefits associated with the product or service using the techniques described above.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
establishing, via a processor, a near field communication session with an electronic device, the electronic device including a product or service;
receiving a device profile from the electronic device;
authenticating, via the processor, the electronic device based on the received device profile;
after authentication, providing a benefit related to the product or service.

2. The method of claim 1, wherein establishing the near field communication comprises receiving a near field communication ping from the electronic device and transmitting an acknowledgment packet to the electronic device.

3. The method of claim 1, wherein establishing the near field communication comprises emitting periodic near field communication pings and receiving an acknowledgment packet from the electronic device.

4. The method of claim 1, wherein the processor belongs to a kiosk.

5. The method of claim 4, wherein the kiosk is unmanned.

6. The method of claim 1, wherein the device profile includes information identifying the electronic device and the user account associated with the electronic device.

7. The method of claim 6, wherein authenticating comprises verifying that an owner of the electronic device and the user account are the same.

8. The method of claim 1, wherein the benefit is digital content related to the product or service.

9. The method of claim 1, wherein the benefit is a credit which can be applied to receive digital content that is related to the product or service.

10. The method of claim 1, wherein providing the benefit includes transmitting the benefit to the electronic device.

11. A non-transitory computer readable medium implemented method which, when executed by a computing device, causes the computing device to perform steps comprising:
establishing, via a processor, a near field communication session with an electronic device, the electronic device including a product or service;
receiving a device profile from the electronic device;
authenticating, via the processor, the electronic device based on the received device profile;
after authentication, providing a benefit related to the product or service.

12. The method of claim 11, wherein establishing the near field communication comprises receiving a near field communication ping from the electronic device and transmitting an acknowledgment packet to the electronic device.

13. The method of claim 11, wherein establishing the near field communication comprises emitting periodic near field communication pings and receiving an acknowledgment packet from the electronic device.

14. The method of claim 11, wherein the processor belongs to a kiosk.

15. The method of claim 11, wherein the device profile includes information identifying the electronic device and the user account associated with the electronic device.

16. The method of claim 15, wherein authenticating comprises verifying that an owner of the electronic device and the user account are the same.

17. The method of claim 11, wherein the benefit is digital content related to the product or service.

18. A system comprising:
a processor;
a memory coupled to said processor, said memory storing instructions to perform the following:
establishing a near field communication session with an electronic device, the electronic device including a product or service;
receiving a device profile from the electronic device;
authenticating, via the processor, the electronic device based on the received device profile;
after authentication, providing a benefit related to the product or service.

19. The system of claim 18, wherein the device profile includes information identifying the electronic device and the user account associated with the electronic device.

20. The system of claim 19, wherein authenticating comprises verifying that an owner of the electronic device and the user account are the same.
